(19) United States
(12) Patent Application Publication
(10) Pub. No.: US 2015/0049844 A1
(43) Pub. Date: Feb. 19, 2015

(54) Method And Apparatus For Improved QAM Constellations

(71) Applicant: British Broadcasting Corporation, London (GB)

(72) Inventor: Jonathan Stott, Horley Surrey (GB)

(73) Assignee: British Broadcasting Corporation, London (GB)

(21) Appl. No.: 14/376,762

(22) PCT Filed: Feb. 6, 2013
(86) PCT No.: PCT/GB2013/000046

§ 371 Date: Aug. 5, 2014

(30) Foreign Application Priority Data
Feb. 6, 2012 (GB) 1202075.6

(51) Int. Cl. H04L 27/36; H04L 1/00; H04L 27/38

(52) U.S. Cl. CPC H04L 27/36; H04L 27/38; H04L 1/0042; H04L 1/0045
USPC 375/298; 375/320

(57) ABSTRACT

A method and transmitter and receiver for determining and transmitting or receiving a non-uniform QAM signal comprises selecting a signal to noise ratio for a channel and forward error corrector and then determining positions of constellation points that maximise a measure of channel capacity at the selected signal to noise ratio. The position of one constellation point and another constellation point within the constellation are constrained to be equal to one another prior to determining the positions of the constellation points. In doing so, a so called condensed QAM constellation arrangement may be derived having fewer than conventional number of constellation points for a given QAM scheme. The condensed QAM arrangement has improved performance at certain signal to noise ratios.

### BACKGROUND OF THE INVENTION

This invention relates to encoding and decoding transmissions encoded according to QAM modulation schemes, and to methods for determining constellations for such schemes. The invention is particularly suited, but not limited, to digital television standards such as DVB-T and DVB-T2.

Reference should be made to the following documents by way of background:

[1] ETSI Standard ETS 300 744, Digital Broadcasting Systems for Television, Sound and Data Services; framing structure, channel coding and modulation for digital terrestrial television, 1997, the DVB-T Standard.

[2] European Patent Application 1221793 which describes the basic structure of a DVB-T receiver.

[3] FRAGOULI, C, WESEL, R D, SOMMER, D, and FETTWEIS, G P, 2001. Turbo codes with nonuniform constellations. IEEE International Conference on Communications, ICC 2001.

Quadrature amplitude modulation (QAM) is a modulation scheme that operates by modulating the amplitudes of two carrier waves, using the amplitude-shift keying (ASK) digital modulation scheme or amplitude modulation (AM) analog modulation scheme. The two carrier waves, usually sinusoids, are out of phase with each other by 90° and are thus called quadrature carriers or quadrature components—hence the name of the scheme. The modulated waves are summed, and the resulting waveform is a combination of both phase-shift keying (PSK) and amplitude-shift keying (ASK), or (in the analog case) of phase modulation (PM) and amplitude modulation.

By representing a transmitted symbol (a number of bits also referred to as a word) as a complex number and modulating a cosine and sine carrier signal with the real and imaginary parts (respectively), the symbol can be sent with two carriers on the same frequency. As the symbols are represented as complex numbers, they can be visualized as points on the complex plane. The real and imaginary axes are often called the in phase, or I-axis and the quadrature, or Q-axis. Plotting several symbols in a scatter diagram produces the constellation diagram. The points on a constellation diagram are called constellation points, each point representing a symbol. The number of bits conveyed by a symbol depends upon the nature of the QAM scheme. The number of points in the constellation grid is a power of 2 and this defines how many bits may be represented by each symbol. For example, 16-QAM has 16 points, this being 2⁴ giving 4 bits per symbol. 64-QAM has 64 points, this being 2⁶ giving 6 bits per symbol or word. 256-QAM has 256 point, this being 2⁸ giving 8 bits per symbol or word.

Upon reception of the signal, a demodulator examines the signal at points in time, determines the vector represented by the signal and attempts to select the point on the constellation diagram which is closest (in a Euclidean distance sense) to that of the received vector. Thus it will demodulate incorrectly if the corruption has caused the received vector to move closer to another constellation point than the one transmitted. The process of determining the likely bit sequences represented by the QAM signal may be referred to as demodulation or decoding.

An example digital terrestrial television transmitter is shown in FIG. 1, as will be described in greater detail later, and a corresponding receiver is shown in FIG. 2. The coding arrangement within the transmitter includes a QAM mapper 46 arranged to map symbols to QAM constellation points. The system uses Orthogonal Frequency Division Multiplex (OFDM) transmission. All data carriers in one OFDM frame are modulated using either QPSK, 16-QAM or 64-QAM constellations. The constellations used are shown in FIGS. 9a to 9c of the standard.

It is known to use QAM constellations that are non-uniform in spacing. This may be referred to as non-uniform QAM (abbreviated to NUQAM herein). In the paper by FRAGOULI, C, WESEL, R D, SOMMER, D, and FETTWEIS, G P, referred to above, a non-uniform QAM scheme is discussed. An example non-uniform QAM constellation is shown in FIG. 3.

### SUMMARY OF THE INVENTION

The improvements of the present invention are defined in the independent claims below, to which reference may now be made. Advantageous features are set forth in the dependent claims.

The present invention provides an encoding/decoding method, an encoder/decoder and transmitter or receiver for use in the method. In addition, the invention provides a method for determining QAM constellations.

We have appreciated that the prior methods for determining QAM constellations to use in transmission schemes do not appropriately consider the actual channel conditions of a broadcast system. In particular, we have appreciated that known non-uniform QAM constellations of prior systems are not optimised and that the basis for selecting QAM parameters can be improved.

In broad terms, the invention provides a method for determining QAM constellation parameters, in particular the constellation point positions, for a broadcast system by adjusting the QAM parameters so as to maximise a capacity measure at one or more selected signal to noise ratios (SNR). The method may include determining the parameters for a QAM scheme of a selected order by constraining the positions of some constellation points to be the same as one another. Using such an approximation may reduce the calculations required to determine constellation positions. A preferred embodiment is described below with reference to the drawings. The preferred embodiment takes the form of a transmitter and receiver (for example for DVB-T or DVB-T2) in which the QAM constellation is determined by a method that includes adjusting the QAM parameters so as to maximise capacity at one or more selected signal to noise ratios (SNR).

### BRIEF DESCRIPTION OF THE DRAWINGS

The invention will be described in more detail by way of example with reference to the accompanying drawings, in which:

FIG. 1 is a schematic diagram of a known DVB transmitter to which the invention may be applied;

FIG. 2 is a schematic diagram of a known DVB receiver to which the invention may be applied;

FIG. 3 shows a non-uniform 16-QAM constellation as described in the DVB-T standard;

FIG. 4 is a diagram showing the Shannon capacity of a channel;

FIG. 5 is a diagram showing the CM capacity of a channel in comparison to Shannon capacity assuming the use of various uniform QAM constellations;

FIG. 6 is a diagram showing the BICM capacity of a channel in comparison to Shannon capacity assuming the use of various uniform QAM constellations;

FIG. 7 shows the shortfall in BICM capacity from Shannon capacity for various uniform QAM constellations;

FIG. 8 is a plot of calculated BICM capacity against QAM outer-point distance for a selected SNR showing a maximum capacity at a specific outer-point distance;

FIG. 9 is a plot of BICM capacity gain for non-uniform 16-QAM constellations optimised at each SNR;

FIG. 10 is a plot of 16-QAM outer-point position against the SNR for which such outer-point positions optimise the BICM capacity;

FIG. 11 is a plot of BICM capacity shortfall from Shannon capacity against selected SNR for various QAM orders for both uniform and optimised non-uniform cases;

FIG. 12 is a plot of constellation-point positions against the SNR for which the positions are optimised for 64 NUQAM;

FIG. 13 is a plot of constellation-point positions against the SNR for which the positions are optimised for 256 NUQAM;

FIG. 14 is a plot of BICM shortfall from Shannon limit showing uniform QAM and NUQAM at selected SNRs;

FIG. 15 is a plot of constellation-point positions against the SNR for which the positions are optimised for 1024 NUQAM;

FIG. 16 is a plot of constellation-point positions for 256 QAM for which the BICM capacity is optimised;

FIG. 17 is a plot of BICM shortfall from Shannon limit showing uniform QAM, 256-NUQAM and condensed 256 QAM at selected SNRs;

FIG. 18 is a plot of BICM shortfall from Shannon limit showing uniform QAM, 1024-NUQAM and condensed 1024 QAM at selected SNRs;

FIG. 19 is a plot of BICM shortfall from Shannon limit showing uniform QAM, 4096-NUQAM and condensed 4096 QAM at selected SNRs;

FIG. 20 is a plot of BICM shortfall from Shannon limit showing uniform QAM and condensed 16384 QAM at selected SNRs;

FIG. 21 is a plot of receiver metrics for bits within QAM words;

FIG. 22 is a plot of BICM shortfall from Shannon limit for a range of NUQAM and ConQAM constellations optimised for the AWGN channel;

FIG. 23 (upper plot) shows the shortfall of BICM capacity from the unconstrained Shannon limit, for a range of reference plus xxx-100A-ConQAM 100-spot constellations (square plot markers). The lower plot adds xxx-144A-ConQAM 144-spot constellations (diamond plot markers, matching colours); and

FIG. 24. shows the shortfall of BICM capacity from the unconstrained Shannon limit, in the medium-SNR range, for a range of reference NUQAM/ConQAM cases, plus xxx-100A-ConQAM 100-spot constellations (square plot markers) and xxx-144A-ConQAM 144-spot constellations (diamond plot markers, matching colours).

### DETAILED DESCRIPTION OF A PREFERRED EMBODIMENT OF THE INVENTION

### DVB Transmitter

A known transmitter will first be described to which the invention may be applied to provide context. Such transmitters are known to the skilled person. Within the following description the embodiment of the present invention provides a new method for deriving the constellations to be used in the mapper described below and a new transmitter using such constellations.

The transmitter receives video (V), audio (A), and data (D) signals from appropriate signal sources via inputs 12 and these are applied to an MPEG-2 coder 14. The MPEG-2 coder includes a separate video coder 16, audio coder 18 and data coder 20, which provide packetised elementary streams which are multiplexed in a programme multiplexer 22. Signals are obtained in this way for different programmes, that is to say broadcast channels, and these are multiplexed into a transport stream in a transport stream multiplexer 24. The output of the transport stream multiplexer 24 consists of packets of 188 bytes and is applied to a randomiser 26 for energy dispersal, where the signal is combined with the output of a pseudo-random binary sequence (PRBS) generator received at a terminal 28. The randomiser more evenly distributes the energy within the RF (radio frequency) channel. The signal is now applied to a channel coding section 30 which is generally known as the forward error corrector (FEC) and which comprises four main components, namely:

an outer coder 32, an outer interleaver 34,

an inner coder 36, and an inner interleaver 38.

The two coding stages 32, 36 provide a degree of redundancy to enable error correction at the receiver. The two interleaving stages 34, 38 are necessary precursors for corresponding de-interleavers at a receiver so as to break up bursts of errors so as to allow the error correction to be more effective.

The outer coder 32 is a Reed-Solomon (RS) coder, which processes the signal in packets of 188 bytes and adds to each packet 16 error protection bytes. This allows the correction of up to 8 random erroneous bytes in a received word of 204 bytes. This is known as a (204, 188, t=8) Reed-Solomon code. This is achieved as a shortened code using an RS (255, 239, t=8) encoder but with the first 51 bytes being set to zero.

The outer interleaver 34 effects a Forney convolutional interleaving operation on a byte-wise basis within the packet structure, and spreads burst errors introduced by the transmission channel over a longer time so they are less likely to exceed the capacity of the RS coding. After the interleaver, the nth byte of a packet remains in the nth byte position, but it will usually be in a different packet. The bytes are spread successively over 12 packets, so the first byte of an input packet goes into the first output packet, the second byte of the input packet is transmitted in the second output packet, and so on up to the twelfth. The next byte goes into the first packet again, and every twelfth byte after that. As a packet contains 204 bytes, and 204=12×17, after the outer interleaving a packet contains 17 bytes that come from the same original packet.

The inner coder 36 is a punctured convolutional coder (PCC). The system allows for a range of punctured convolutional codes, based on a mother convolutional code of rate ½ with 64 states. The data input is applied to a series of six one-bit delays 40 and the seven resultant bits which are available are combined in different ways by two modulo-2 adders 42,44, as shown. These adders provide the output of the inner coder in the form of an X or G1 output and a Y or G2 output, the letter G here standing for the generator sum. The X and Y outputs are combined into a single bit stream by a serialiser 45.

The puncturing is achieved by discarding selected ones of the X and Y outputs in accordance with one of several possible puncturing patterns. Without puncturing, each input bit gives rise to two output bits. With puncturing one of the following is achieved:
Every 2 input bits give 3 output bits
Every 3 input bits give 4 output bits
Every 5 input bits give 6 output bits
Every 7 input bits give 8 output bits

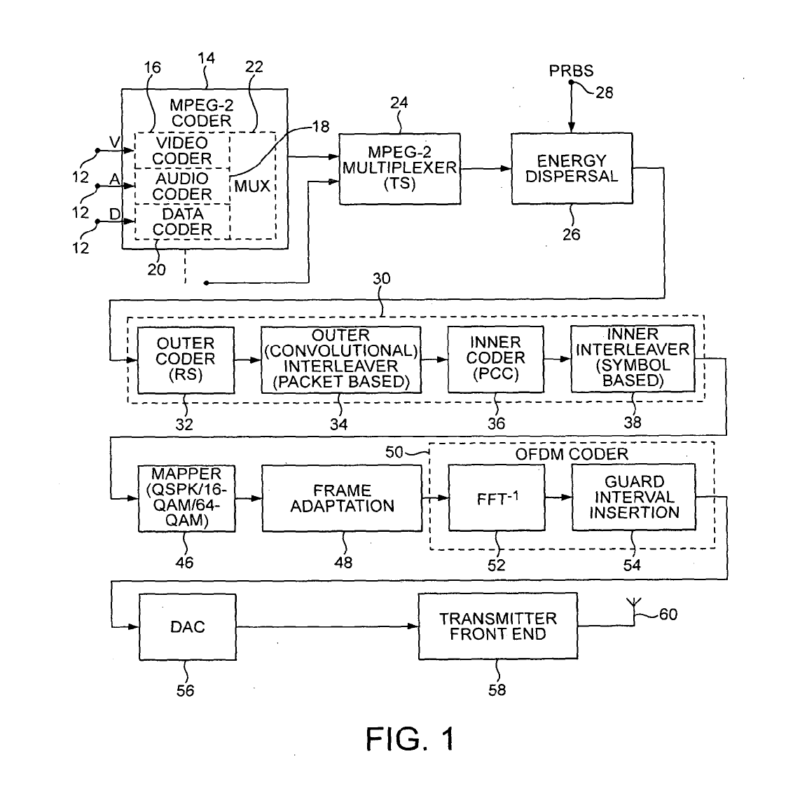

Returning to FIG. 1, the inner interleaver 38 in accordance with the standard is implemented as a two-stage process, namely bit-wise interleaving followed by symbol interleaving. Both are block based. First, however, the incoming bit stream is divided into 2, 4 or 6 sub-streams, depending on whether QPSK (quadrature phase shift keying), 16-QAM (quadrature amplitude modulation), or 64-QAM is to be used, as described below. Each sub-stream is separately bit interleaved and all the streams are then symbol interleaved.

The bit interleaver uses a bit interleaving block size which corresponds to one-twelfth of an OFDM symbol of useful data in the 2k mode and 1/48 of an OFDM symbol in the 8k mode.

The symbol interleaver maps the 2, 4 or 6-bit words onto 1512 or 6048 active carriers, depending on whether the 2k or 8k mode is in use. The symbol interleaver acts so as to shuffle groups of 2, 4 or 6 bits around within the symbol. This it does by writing the symbol into memory and reading out the groups of 2, 4 or 6 bits in a different and permuted order compared with the order in which they were written into the memory.

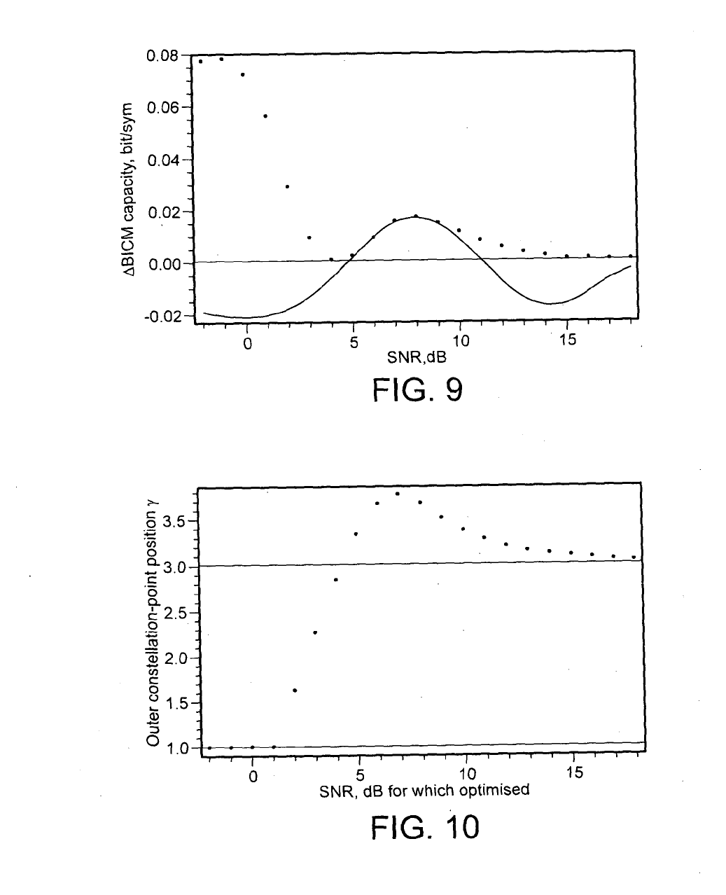

The groups of 2, 4 or 6 bits (referred to as coded bits, symbols or words) are applied to a mapper 46 which quadrature modulates the bits according to QPSK, 16-QAM or 64-QAM modulation, depending on the mode in use. (QPSK may also be represented as 4-QAM.) The constellations are shown in FIG. 9 of the standard. It will be appreciated that this requires 1, 2 or 3 bits on the X axis and 1, 2 or 3 bits on the Y axis. Thus while reference has been made to 2, 4 or 6 bits in the shuffling process, in fact the shuffling is applied to 1, 2 or 3 bits in the real part and 1, 2 or 3 bits in the imaginary part.

The signal is now organized into frames in a frame adapter 48 and applied to an OFDM (orthogonal frequency-division multiplexer) coder 50. Each frame consists of 68 OFDM symbols. Each symbol is constituted by 1705 carriers in 2k mode or 6817 carriers in Bk mode. Using the 2k mode as an example, instead of transmitting 1705 bits sequentially on a single carrier, they are assembled and transmitted simultaneously on 1705 carriers. This means that each bit can be transmitted for much longer, which, together with the use of a guard interval, avoids the effect of multipath interference and, at least in 8k mode, allows the creation of a single-frequency network.

The duration of each symbol, the symbol period, is made up of an active or useful symbol period, and the guard interval. The spacing between adjacent carriers is the reciprocal of the active symbol period, thus satisfying the condition for orthogonality between the carriers. The guard interval is a predefined fraction of the active symbol period, and contains a cyclic continuation of the active symbol.

The frame adapter 48 also operates to insert into the signal pilots, some of which can be used at the receiver to determine reference amplitudes and phases for the received signals. The pilots include scattered pilots scattered amongst the 1705 or 6817 transmitted carriers as well as continual fixed pilots. The pilots are modulated in accordance with a PRBS sequence. Some other carriers are used to signal parameters indicating the channel coding and modulation schemes that are being used, to provide synchronization, and so on.

The OFDM coder 50 consists essentially of an inverse fast Fourier transform (FFT) circuit 52, and a guard interval inserter circuit 54. The construction of the OFDM coder will be known to those skilled in the art.

Finally, the signal is applied to a digital to analogue converter 56 and thence to a transmitter ‘front end’ 58, including the transmitter power amplifier, and is radiated at radio frequency from an antenna 60.

### DVB Receiver

A known receiver will also be described for completeness. The embodiment of the invention modifies the demapping so as to allow the constellation scheme according to the invention to be correctly decoded.

In the receiver 100 an analogue RF signal is received by an antenna 102 and applied to a tuner or down-converter 104, constituting the receiver front end, where it is reduced to baseband. The signal from the tuner is applied to an analogue-to-digital converter 106, the output of which forms the input to an OFDM decoder 108. The main constituent of the OFDM decoder is a fast Fourier transform (FFT) circuit, to which the FFT in the transmitter is the inverse. The FFT receives the many-carrier transmitted signal with one bit per symbol period on each carrier and converts this back into a single signal with many bits per symbol period. The existence of the guard interval, coupled with the relatively low symbol rate compared with the total bit rate being transmitted, renders the decoder highly resistant to multipath distortion or interference.

Appropriate synchronisation is provided, as is well-known to those skilled in the art. In particular, a synchronising circuit will receive inputs from the ADC 106 and the FFT 108, and will provide outputs to the FFT and, for automatic frequency control, to the tuner 104.

The output of the OFDM decoder 108 is then applied to a channel equalizer 110. This estimates the channel frequency response, then divides the input signal by the estimated response, to output an equalised constellation.

Now the signal is applied to a circuit 112 which combines the functions of measurement of channel state, and demodulation or demapping of the quadrature modulated constellations. The demodulation converts the signal back from QPSK, 16-QAM, or 64-QAM to a simple data stream, by selecting the nominal constellation points which are nearest to the actual constellation points received; these may have suffered some distortion in the transmission channel. At the same time the circuit 112 estimates the likelihood or level of certainty that the decoded constellation points do in fact represent the points they have been interpreted as. As a result a likelihood or confidence value is assigned to each of the decoded bits. The output of the metric assignment and demapping circuit 112 is now applied to an error corrector block 120 which makes use of the redundancy which was introduced in the forward error corrector 30 in the transmitter. The error corrector block 120 comprises:

an inner deinterleaver 122,

an inner decoder 124, in the form of a soft-decision Viterbi decoder,

an outer deinterleaver 126, and

an outer decoder 128.

The inner deinterleaver 122 provides symbol-based deinterleaving which simply reverses that which was introduced in the inner interleaver 38 in the transmitter. This tends to spread bursts of errors so that they are better corrected by the Viterbi decoder 124. The inner deinterleaver first shuffles the groups of 2, 4 or 6 real and imaginary bits within a symbol (that is, 1, 2 or 3 of each), and then provides bit-wise deinterleaving on a block-based basis. The bit deinterleaving is applied separately to the 2, 4 or 6 sub-streams.

Now the signal is applied to the Viterbi decoder 124. The Viterbi decoder acts as a decoder for the coding introduced by the punctured convolutional coder 36 at the transmitter. The puncturing (when used) has caused the elimination of certain of the transmitted bits, and these are replaced by codes indicating a mid-value between zero and one at the input to the Viterbi decoder. This will be done by giving the bit a minimum likelihood value. If there is no minimum likelihood code exactly between zero and one, then the added bits are alternately given the minimum values for zero and for one. The Viterbi decoder makes use of the soft-decision inputs, that is inputs which represent a likelihood of a zero or of a one, and uses them together with historical information to determine whether the input to the convolutional encoder is more likely to have been a zero or a one.

The signal from the Viterbi decoder is now applied to the outer deinterleaver 126 which is a convolutional deinterleaver operating byte-wise within each packet. The deinterleaver 126 reverses the operation of the outer interleaver 34 at the transmitter. Again this serves to spread any burst errors so that the outer coder 128 can better cope with them.

The outer decoder 128 is a Reed-Solomon decoder, itself well-known, which generates 188-byte packets from the 204-byte packets received. Up to eight random errors per packet can be corrected.

From the Reed-Solomon outer decoder 128 which forms the final element of the error corrector block 120, the signal is applied to an energy dispersal removal stage 130. This receives a pseudo-random binary sequence at an input 132 and uses this to reverse the action of the energy dispersal randomiser 26 at the transmitter. From here the signal passes to an MPEG-2 transport stream demultiplexer 134. A given programme is applied to an MPEG-2 decoder 136; other programmes are separated out as at 138. The MPEG-2 decoder 136 separately decodes the video, audio and data to provide elementary streams at an output 140 corresponding to those at the inputs 12 on FIG. 1.

### Modulation Orders

Conventional uniform rectangular modulation such as in DVB-T and DVB-T2 uses Gray coded bit mapping to represent every symbol in the constellation. As already mentioned, the DVB-T2 specifies a particular constellation.

The number of coded bits required to represent each constellation point depends on the constellation size as shown in Table 1.

TABLE 1
Bit ordering and required bits for different constellation size

| Constellation | Number of bits, | Bit ordering |
|---|---|---|
| QPSK | 2 | {bit0 bit1} |
| 16-QAM | 4 | {bit0 bit1 bit2 bit3} |
| 64-QAM | 6 | {bit0 bit1 bit2 bit3 bit4 bit5} |
| 256-QAM | 8 | {bit0 bit1 bit2 bit3 bit4 bit5 bit6 bit7} |
| 1024-QAM | 10 | {bit0 bit1 bit2 bit3 bit4 bit5 bit6 bit7 bit8 |
| 4096-QAM | 12 | {bit0 bit1 bit2 bit3 bit4 bit5 bit6 bit7 bit8 |

### Proposed Improvement

The new technique derives the degree of non-uniformity or ratio of outer point to inner point positions by considering the SNR of the channel. In order to understand the improvement, some background theory will first be described.

As is known to the skilled person, the theoretical “maximum capacity” (the maximum possible data throughput) is defined in a paper by Shannon in 1948 as the capacity C (in bit/s) of a channel of band W (Hz) perturbed by added white thermal noise whose average power is N when the transmitted signals have an average power P is given by (equation 1):

$$C = W {log}_{2} \frac{P + N}{N}$$

The above capacity formula defines the maximum capacity of a single band-limited channel with added white Gaussian noise (AWGN). We have appreciated that there are assumptions: that the performance of the channel is limited solely by the AWGN, there is no other degradation and that the noise is AWGN. Furthermore, there is an assumption regarding the random Gaussian-distributed nature of the signals themselves. However, the DVB signals use constellations and not theoretical random signals. In the context of DVB, we have more specific practical circumstances we have to apply. The fact that QAM uses a sequence of constellations means that the signal sent now has some discrete distribution. Even after adding channel noise, the resulting received-signal distribution will not, and cannot, be Gaussian, so the optimum capacity of the classic formula cannot be attained, whatever the coding we choose to apply. We have appreciated that a better approach to optimisation is needed.

We can make use of the more general mutual information formula; the mutual information I(X, Y) between the transmitted signal x and the received signal y to give a definition of the capacity we seek (equation 2):

$$I ( X , Y ) = \int \int ( p ( x , y ) {log}_{2} \frac{p ( x , y )}{p ( x ) p ( y )} ) d x d y$$

Using the above formula allows alternative measures of actual channel capacity to be derived, such as:

(i) the Coded Modulation (CM) capacity in which we assume a particular constellation alphabet is used but place no restraint on ‘cleverness’ in using it;

(ii) Bit-Interleaved Coded Modulation (BICM) capacity in which we assume coded data bits (from some FEC code) are suitably interleaved and mapped in a particular way to the points of a particular constellation.

Coded Modulation (CM) Capacity

We suppose that we transmit constellation symbols selected from an alphabet of possibilities. Thus there will be specific discrete values xᵢ of x to be transmitted. We therefore have to modify the mutual information formula so that it contains an integral over y (the received signal, made continuous by the added noise) and summations over the discrete xᵢ. Things are easiest for the classical rectangular QAM constellations, since these can be treated as two orthogonal 1-dimensional constellations, each having one-half the total capacity. Suitable care must of course be taken when relating the noise variance on each axis to the SNR and the total signal ‘power’.

If one constellation axis has n positions (e.g. 8 in 64-QAM), the coded modulation capacity may be derived as (equation 3):

$$I ( X ; Y ) = {\int }_{Y} {\sum }_{i = 1}^{n} \frac{p ( y \vert {x}_{i} )}{n} {log}_{2} ( p ( y \vert {x}_{i} ) ) d y - {\int }_{Y} {\sum }_{i = 1}^{n} \frac{p ( y \vert {x}_{i} )}{n} {log}_{2} ( {\sum }_{k = 1}^{n} \frac{p ( y \vert {x}_{k} )}{n} ) d y$$

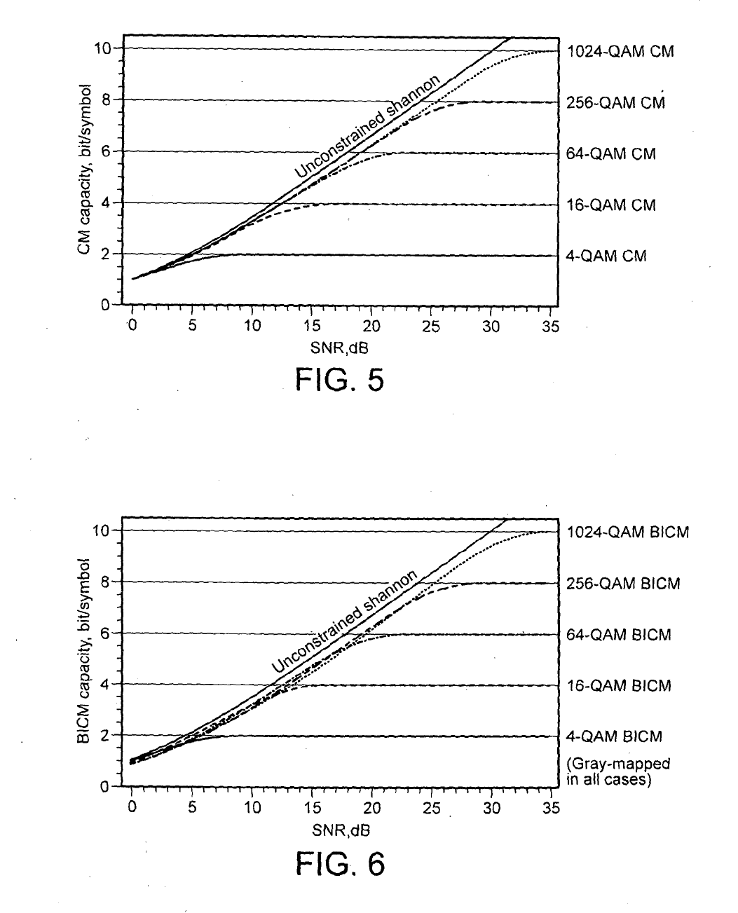

A graph showing the calculated CM capacity for various uniform QAM orders with SNR is shown in FIG. 5. As can be seen, each larger constellation has greater CM capacity but the gulf from unconstrained Shannon capacity increases with SNR.

Bit-Interleaved Coded Modulation (BICM) Capacity

We suppose that we transmit constellation symbols, just as in CM above. However, we are to a degree now specific about how we come to transmit these symbols. We assume that coded bits (the form of forward error coding generating them being unspecified, except that a binary code is assumed) are mapped to the constellation points in one of the many familiar ways. For a simple example, we can assume that 16-QAM with Gray coding is in use. Each constellation has 4 coded bits mapped to it, 2 to each of the independent axes. We may suppose that the constellation positions (on one axis) are {−3, −1, +1, +3}, mapped as follows:

| position | −3 | −1 | +1 | +3 |
|---|---|---|---|---|
| MSB | 0 | 0 | 1 | 1 |
| LSB | 1 | 0 | 0 | 1 |

Suppose the MSB is a 1. That means the point transmitted will be either +1 or +3, depending on the state of the LSB. What we have to assume is that the bits mapped to a particular constellation point are independent, and that each bit is as likely to be a 0 or a 1. So now, if the MSB is transmitted as a 1, then the PDF of the received signal p(y|transmitted MSB is 1) will have two equal-height peaks at y=+1 and y=+3. (This compares with the single peak in p(y|xi) that arose in the CM calculation). We can then work out the capacity of each bit level separately by applying the mutual-information formula to each one (noting that levers mapping), and finally take the total capacity to be the sum of these bit-level capacities.

The capacity of a bit b may be expressed as (equation 4):

$$capacity of bit b = {\int }_{Y} p ( b is 0 , y ) {log}_{2} \frac{p ( b is 0 , y )}{P ( b is 0 ) p ( y )} d y + {\int }_{Y} p ( b is 1 , y ) {log}_{2} \frac{p ( b is 1 , y )}{P ( b is 1 ) p ( y )} d y$$

We assume equiprobable 0s and 1s are transmitted, so that P (b is 1)=P (b is 0)=1/2. Then p (b is 0, y)=p (y|b is 0) P (b is 0)=p (y|b is 0)/2, and similarly for p (b is 1, y). Putting these in, writing the log of the fraction as the difference of two logs, expanding and regrouping we get the following form, convenient for numerical integration, for the capacity of bit b (equation 5):

$${\int }_{Y} ( \frac{( p ( y \vert b is 0 ) {log}_{2} p ( y \vert b is 0 ) + p ( y \vert b is 1 ) {log}_{2} p ( y \vert b is 1 ) )}{2} - p ( y ) {log}_{2} p ( y ) ) d y$$

Now, assuming the channel adds AWGN having variance α²to each axis, we can substitute expressions for the conditional probabilities, this time assuming the other constellation bits are equiprobable (equation 6):

$$p ( y \vert b is 0 ) = \frac{2}{n} {\sum }_{{x}_{i} ∈ {C}_{b}^{0}} p ( y \vert {x}_{i} ) = \frac{2}{n} {\sum }_{{x}_{i} ∈ {C}_{b}^{0}} \frac{{e}^{- \frac{{( y - {x}_{i} )}^{2}}{2 {σ}^{2}}}}{\sqrt{2 π} σ}$$

and similarly for p (y|b is 1). Finally, as before, but expressed using the alphabet concept, we also substitute (equation 7):

$$p ( y ) = {\sum }_{{x}_{i} ∈ C} \frac{p ( y \vert {x}_{i} )}{n} = \frac{1}{n} {\sum }_{{x}_{i} ∈ C} \frac{{e}^{- \frac{{( y - {x}_{i} )}^{2}}{2 {σ}^{2}}}}{\sqrt{2 π} σ}$$

To get the BICM capacity for the QAM constellation we do this calculation for each of the bits and sum their capacities. In practice this means calculating the capacity of one axis and doubling it. The BICM capacity we calculate in this way is certainly a valid upper limit for the use of a bit interleaved single code.

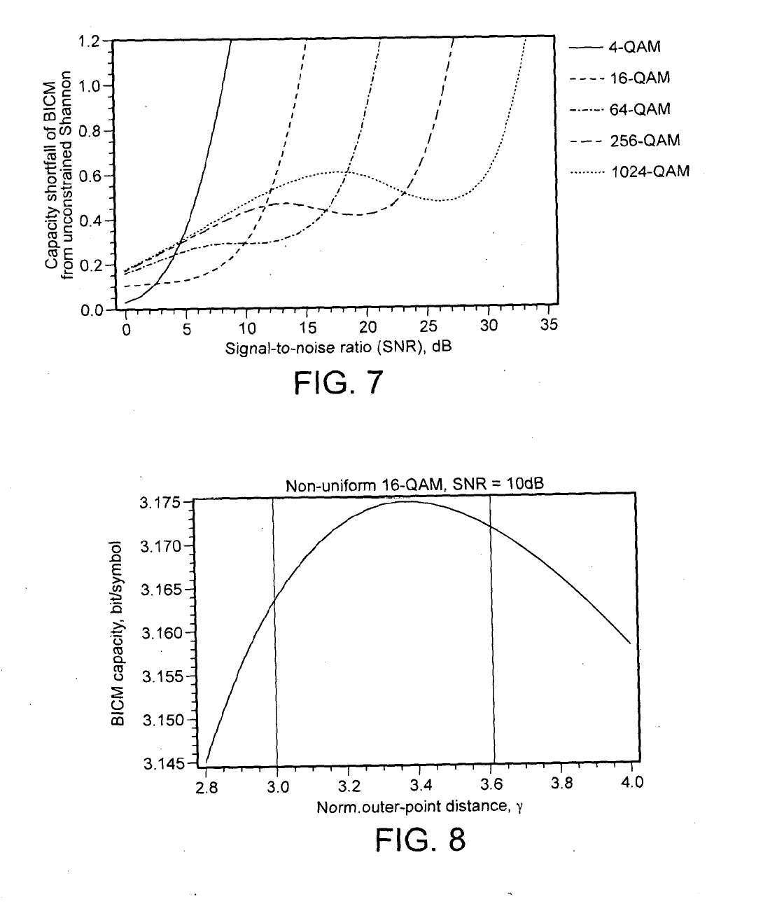

As can be seen from the equation for capacity of a bit (equation 4) and the substitutions for conditional probabilities (equations 6, 7), the BICM capacity of a channel is a function of AWGN and hence a function of SNR. A graph of the BICM capacity with SNR for various uniform QAM orders is shown in FIG. 6. As can be seen, as SNR increases, the QAM sizes take turns to have greatest BICM capacity but gulf from the unconstrained Shannon theoretical limit grows as before. For example, 64-QAM is the leader around 12 dB SNR, while 256-QAM is best around 18 dB, with 1024-QAM taking over above 23 dB. The shortfall of the BICM calculation of capacity from the unconstrained Shannon theoretical limit can be seen in FIG. 7. This visibly confirms each order takes turns as best, and that the gulf grows with SNR.

The present proposed improvement appreciates that QAM is not Gaussian and that known fixed non-uniform QAM constellations are deficient. The improvement resides in the idea of adapting the non-uniformity of the QAM constellation in order to maximise the capacity, in particular the BICM capacity, at some particular “design” SNR, and adapting it again at every other SNR.

We may draw a distinction between design SNR (the SNR for which the capacity is optimised) and the operational SNR actually experienced by any particular receiver. A system for broadcasting has one transmitter and many receivers, usually with no return signalling. In this case the same signal format must be sent to all receivers. In such a situation it would be appropriate to choose a design SNR for the system, namely the SNR at which some aspect of the system is optimised. Preferably, the design SNR corresponds to the SNR likely to be experienced by a receiver at the edge of the intended coverage area. Other receivers within the coverage area may well experience an appreciably better SNR. Optimising for the design SNR will in this case optimise the capacity for the worst-placed receiver. Other receivers having a higher operational SNR will receive the very same signal; while they therefore gain no capacity advantage from their greater SNR, they will nevertheless receive an equally satisfactory result as will have been achieved for the worst case. Although in principle these particular receivers could be sent a signal with higher capacity, that would only be at the cost of losing service to receivers at edge of intended coverage. The “design” SNR in the embodiment is thus that predicted for the worst-placed receiver for which coverage is intended; it is then assumed that all receivers will enjoy this same SNR or better in practice, and thus all will perform satisfactorily. By being able to optimise capacity for the design SNR then the highest capacity which it is possible to deliver to all simultaneously is achieved.

In principle, an alternative embodiment could be a one-to-one 2-way link, in which case the design SNR may be adapted based on the actual SNR experienced at a receiver; the receiver could report back to the sender what SNR it is experiencing for the time being. In principle the transmitter can then adapt the transmission to achieve the best result. Existing systems might perhaps switch QAM orders in such a situation. In principle, such a system embodying the present invention they could instead adapt the positions of the constellation points to maximise the capacity at the current SNR, so that the design and operational SNR are one and the same.

The improvement will first be explained with reference to 16-QAM. This presents a simple case to examine, precisely because there is very little that can be changed. If we consider that uniform 16-QAM uses positions {−3, −1, +1, +3}, then we can make a non-uniform version having positions {−γ, −1, +1,+γ}, using one parameter γ (the ratio of the outer point position to the inner point position). For any particular SNR, using the equations discussed above or calculations based upon them, we can plot the BICM capacity as a function of γ and hence find the BICM optimum for one SNR. This is shown in FIG. 8. Note that the two vertical gridlines correspond to γ=3 (left), for uniform QAM, and γ=3.61 (right), which is a fixed value determined by other methods. We see that for this SNR the optimum γ in fact lies between these two, and that there is a very modest improvement in capacity.

The process can easily be repeated for other SNRs, and doing so we find the optimum γ depends on the SNR. We can then find the optimum γ and resulting BICM capacity for each SNR.

The chosen approach to the calculation is to use numerical optimisation. Potentially, the relationship between the optimum γ and the SNR could be expressed as a function and the value of γ determined analytically. For example, if BICM capacity could be easily expressed as f(γ), then the position of the maxima could be solved by differentiation. However, as the method is applied to higher orders, the calculation becomes more complex. As explained later, for higher orders there are more parameters, for example 7 parameters for 256-QAM, so that the function to be solved becomes differentiating with respect to each parameter in turn and solve for example df/dα=0, df/dβ=0 and so on. In view of the complexity, instead the preferred approach is numerical optimisation. The embodiment described uses the known Mathematica program and its “Nmaximize” command; this uses a multiplicity of numerical optimisation techniques, which, in essence maximise the function f(α,β,γ,δ,ε,ζ,η) by varying each of the parameters (α,β,γ,δ,ε,ζ,η).

The results are shown in FIG. 9. The solid curve shows the BICM capacity improvement (compared with uniform 16-QAM) for the single, fixed non-uniform constellation having γ=3.61 produced by the known methods. The points show the BICM capacity improvement for non-uniform QAM which is optimised for each particular SNR using the improvement. We had reasoned that per-SNR optimisation would be better, and this is confirmed by the plotted points. They show that the ‘old’ method was close to optimum for SNRs in the range say 6 to 9 dB, but elsewhere the per-SNR optimisation is clearly better. Of course, the benefits are small, as we might expect. Eventually at high SNR there is no longer any advantage for non-uniformity, just as predicted. The new method also shows a striking improvement at low SNR, towards 0 dB and below.

FIG. 10 shows as expected that for high SNR the optimum γ tends towards 3, returning the constellation to uniformity. It has its peak value (rather greater than that of the known method) around 7 dB SNR, below which it drops again. When the SNR is low enough (below about 1 dB) γ converges to 1, so that the constellation has collapsed from 16- to 4-QAM, and its LSB now has zero capacity. This explains the apparent advantage of non-uniformity at very low SNRs, as shown in FIG. 9: the advantage is actually simply that of 4-QAM over uniform 16-QAM at low SNR. As can be seen, the optimised outer constellation point position γ tends to 3 at high SNR, this being the uniform QAM position since the inner-point position is taken as 1 giving a uniform spacing of 2. At low SNR values the constellation outer point position reduces below 3 and so is most “compressed” in the sense that the outer-point and inner-point positions are closer to one another. Around 7 dB, the outer-point position γ is a maximum of around 3.8 meaning that the outer-point is “stretched” in the sense that the outer-point and inner-points are further away.

To extend our optimisation method to higher-order constellations is easy in principle, but computationally challenging. We have to define more parameters over which to optimise the BICM (or indeed CM) capacity, and these multiply alarmingly. We label the assumed constellation points on one axis as follows:
16-QAM:—{−γ,−1, +1,+γ}
64-QAM:—{−γ,−β,−α,−1, +1,+α,+β,+γ}
256-QAM:—{−η,−ζ,−ε,−δ,−γ,−β,−α,−1, +1,+α,+β,+γ,+δ,+ε,+ζ,+η}

so that 16-QAM has 1 parameter, 64-QAM has 3 and 256-QAM has 7. 1024-QAM, would have 15 parameters. We can even extend this to 4096 QAM with 31 parameters and 16384 QAM with 63 parameters. With this number of parameters we no longer have any option of using plots to find maxima. Instead, we use numerical optimisation.

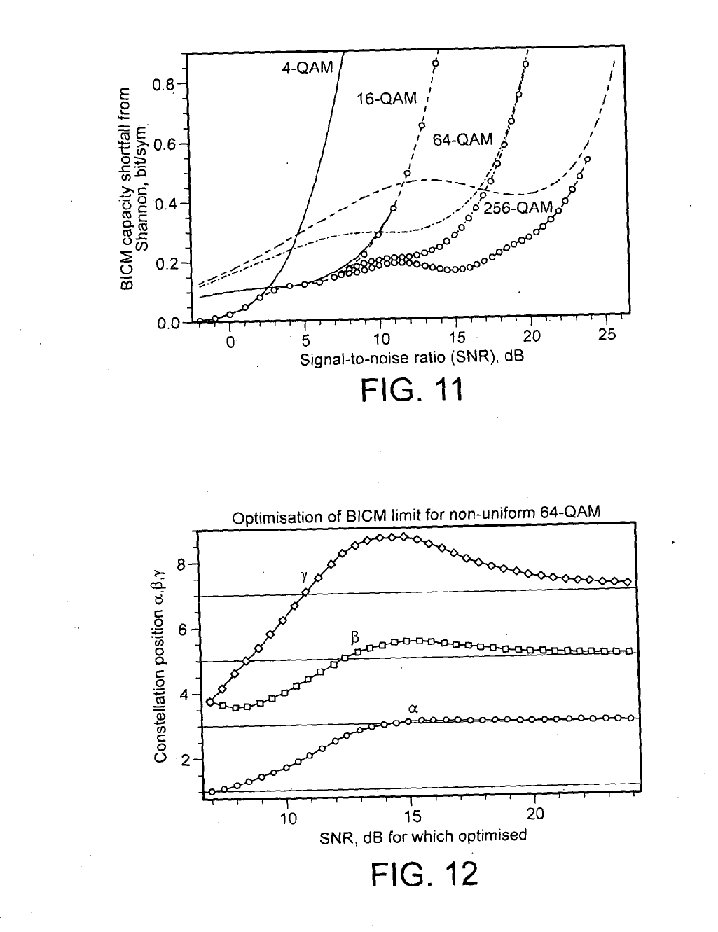

The BICM capacities achieved are illustrated in FIG. 11. The results for uniform QAM constellations are reproduced as dashed lines, while the corresponding results for the per-SNR optimised non-uniform QAM constellations are shown in the same tone and labelled, as solid lines with plot points. We see, as already concluded, that the non-uniform 16-QAM improves slightly on uniform 16-QAM in the expected SNR range from roughly 6 to 11 dB. It also gives an improvement at low SNR by converging on the uniform-4-QAM curve (because here it is in effect collapsing down to 4-QAM). Non-uniform 64-QAM and 256-QAM are rather more interesting: they give much larger improvement compared with their uniform versions. This is perhaps not surprising, as there is very little scope to optimise the simple 16-QAM constellation, but these larger constellations have more parameters to adjust. Their results also converge on the results for lower QAM orders at low SNR.

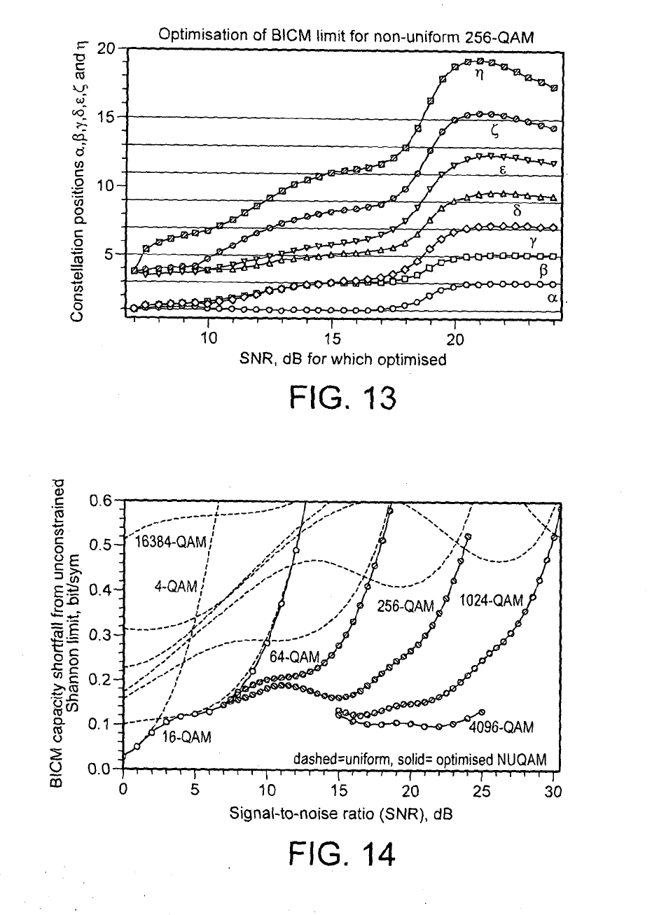

We get more insight by looking at the optimised constellation positions, see FIG. 12 for 64-QAM and FIG. 13 for 256-QAM.

FIG. 12 shows how the optimum constellation-spot positions vary when the BICM of 64-QAM is optimised at different SNRs. The grid lines at values {1, 3, 5, 7} remind us where they would lie in conventional uniform 64-QAM. Remember that for simplicity the innermost positions have been kept at ±1 so as to minimise the number of parameters to be optimised. We see that at high SNR the positions are indeed converging towards the uniform-QAM values {1, 3, 5, 7}. At low SNR, 7 dB, we see that it has fully converged to non-uniform 16-QAM. In between those two extremes, we see first a somewhat squashed constellation at lower SNRs, then an expanded one where all of {α, β, γ} exceed the uniform-QAM values before they reduce again.

FIG. 13 shows how the optimum constellation-spot positions vary when the BICM of 256-QAM is optimised at different SNRs. Referring back to the capacity plots of FIG. 11, we note that optimised non-uniform 256-QAM offers quite significant benefits over both uniform 256-QAM and optimised non-uniform 64-QAM for SNRs above say 13 dB SNR, while still offering more modest benefits over optimised non-uniform 64-QAM below that. FIG. 13 shows several different regions. At very high SNR, the constellation tends to approach the uniform 256-QAM constellation. Around say 20 dB SNR, we see the constellation is stretched out, the most in the outer positions. As the SNR reduces below that we see the constellation becoming compressed, and as the SNR decreases, some points begin to merge, and maybe de-merge and re-merge with others. It is possible that this slightly confused behaviour is an artefact of the numerical optimisation, or of the existence of multiple solutions. E.g. by simply changing the initial conditions of the optimisation a different, anomalous result in terms of positions can be achieved for 8 dB SNR, without changing the capacity achieved.

Nevertheless, it is clear that the constellation does in effect shrink its number of points as the SNR reduces, going from 256-QAM, down to ultimately becoming non-uniform 16-QAM at about 7 dB SNR. In many places we have essentially 144-QAM, but with different points pairing to produce it at different SNRs; around 16 dB we have essentially 196-QAM. Interestingly, at no point does it seem to collapse fully to 64-QAM. The most important thing is that these messy hybrids do achieve greater capacity at the SNRs for which they are optimised than more ‘normal’ QAM constellations do.

### Proposed Further Improvement

We have appreciated that it becomes computationally complex to compute the outer-point ratios for higher order constellations, and potentially computationally infeasible. We have appreciated, from the above analysis, that within certain SNR ranges it is possible to reduce the complexity of calculation by computing ratios for fewer than the full set of 2ⁿ points of an n-order QAM constellation and then using this calculation as an approximation for the full QAM constellation.

Consider again the shortfall in capacity of BICM in comparison to the Shannon limit (as previously shown in FIG. 11) extended to include calculations of some of the SNR values for 1024 and 4096 QAM as shown in FIG. 14. As before, the dashed lines denote uniform QAM, while the corresponding results for the per-SNR optimised non-uniform QAM (NUQAM) constellations are shown in the same tones and labelled, as solid lines with plot points.

The improvement gained by non-uniform 1024-QAM over uniform 1024-QAM in the SNR range from 15 to 20 dB is very substantial, and sufficient to put 1024-NUQAM in the lead over the previously-favoured 256-NUQAM. This is despite the fact that uniform 256-QAM has better capacity than uniform 1024-QAM in this range. (The ‘natural’ range of application of uniform 1024-QAM comes at higher SNRs). Indeed, at best the shortfall from the unconstrained Shannon limit is reduced to as little as 0.123 bit/symbol at 16.5 dB SNR. The gain over 256-NUQAM increases further at higher SNRs, but the shortfall now increases too, suggesting that higher orders of NUQAM would now take over as the best choice such as the 4096-QAM shown. The shortfall curve has some curious detail; although the shortfall is minimised at about 16.5 dB SNR, there are other points where the curvature changes sign, as if there are different zones of behaviour.

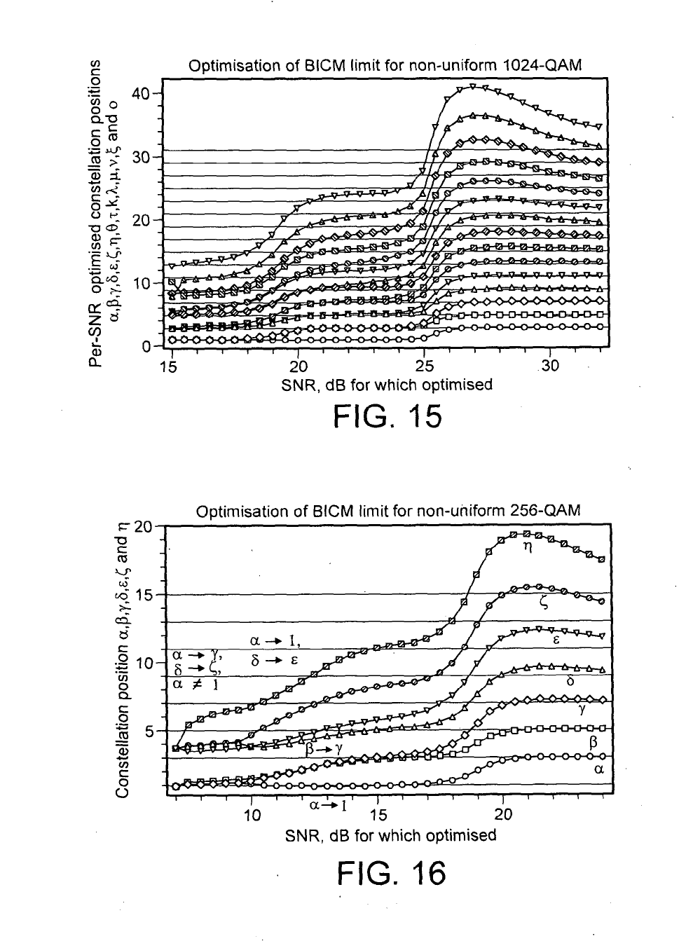

The results of computing the per-SNR ratio optimised constellation positions for 1024 QAM are shown in FIG. 15. As previously noted, the inner point is deemed to be at position unity, so that all of the other positions are expressed as a ratio to 1. Recall that uniform QAM has a spacing of 2 giving a sequence: 1, 3, 5, 7, 9, 11, 13, 15, 17, 19, 21, 23, 25, 27, 31, 33. At high SNR (above 24 dB) all the constellation points are distinct, so we do indeed have a genuine 1024-NUQAM constellation, albeit at first they are somewhat compressed together. As the SNR increases, this compression turns to expansion of the constellation, which reaches its maximum extent around 27 dB. As the SNR gets very high we see clear signs of the positions converging on the uniform-QAM positions that are denoted in the Figure by the horizontal gridlines at {1, 3, 5 . . . 29, 31}.

In the middle zone (roughly 20 to 24 dB) we see that some of the spots have virtually converged. So in this range we could consider that we have something ‘like’ 576-QAM.
α is nearly merged with the fixed position 1
β and γ have nearly merged at about 3
δ and ε have nearly merged at about 5
ζ and η are close in value
θ and ι are fairly close initially, and κ and λ less so, the remainder being well distinct throughout.

In the lower-SNR zone (roughly 15.5 to 17.5 dB) we see that more of the spots have virtually converged. So in this range we could consider that we have something ‘like’ 256-, 400- and 484-QAM by turns.
α, β and γ are nearly merged with the fixed position 1
δ and ε have nearly merged at about 3, and ζ and η are also nearly merged at a slightly greater value
θ and ι are nearly merged
κ and λ are very close
μ and ν are distinct but fairly close, while ξ and o remain well distinct

However, these descriptions are better thought of as tendencies-by-way-of-explanation; the points do all remain distinct (albeit you have to look to several decimal places in some cases). Note that our optimisation of 1024-NUQAM at 16.5 dB (the best result in terms of shortfall from Shannon) has a clear capacity advantage over 256-NUQAM even though we can observe it to be ‘virtually’ converged to 256-QAM. The per-SNR optimised 1024-NUQAM positions we have obtained do rather tend towards only 256-NUQAM at the bottom of the SNR range examined, yet the calculated BICM capacity appears appreciably better than was achieved when we directly optimised 256-NUQAM (as shown in FIG. 14).

Calculations may be performed to confirm that gradually reducing the number of constellation points by merging those positions that are very close anyway does, as expected, reduce the corresponding theoretical BICM capacity—but not by a very great deal, even when the number of positions is reduced to the point where the constellation has only 256 positions, the same number as 256-QAM. Yet 1024 QAM at low SNR where it has only 256 positions still produces a better capacity than of 256-QAM. This apparent conundrum can be clarified by considering the way the calculations are performed. In the previous work to optimise 256 QAM, we started with 8 bits Gray-mapped to the 256 QAM positions, and optimised that state of affairs. In the current work, we started with 1024 bits Gray-mapped to the 1024 QAM positions, and optimised that different situation. It so happens that in certain SNR ranges some of the positions were very close, and if we progressively merge them we do eventually end up with a constellation with 256 positions. However, it is a different scenario in that 10 bits are still mapped to that constellation, albeit that we have very badly weakened some of them by the merging of positions. No bit is totally eliminated.

We have therefore shown that performing calculations to derive constellation positions using fewer than a full 2ⁿ points of a given QAM order gives sufficiently accurate constellation positions for the full order, at least in an appropriate SNR range. The full order when used in a broadcast system gives improved capacity over a lower order. We will use the name Condensed QAM for this approach, and propose a notation like 1024-256-ConQAM for the case where we start from 1024-QAM Gray mapping (carrying in this case 10 coded bit/symbol) but merge (or “condense”) some of the positions before optimisation so that we end up with (in this example) 256 distinct points. The number of points to which the constellation is condensed need not be a power of 2. Furthermore a name like 1024-256-ConQAM is not enough to specify a scenario uniquely, because you might choose different ways to merge down to the same number of states before optimisation.

We will first consider the example of condensing 256-QAM. 256-NUQAM is a good place to start since we can try many optimisations fairly quickly. The somewhat ‘messy’ behaviour of the optimised positions with design SNR leads us into some complication, as there is no one condensation pattern that is likely to be universally applicable. See FIG. 16 which shows:
above say 17 dB SNR all the points are distinct so no condensed version would work well
roughly from 10 to 17 dB we have α→1
roughly from 11 to 14 dB we have {α→1,β→γ}
roughly at 10 dB we have {α→1,δ→}
below 10 dB we have {α→γ,δ→ζ}

This leads us to try several ConQAM variants, imposing these condensations before optimisation:
256-196-ConQAM, imposing simply α→1
256-144-A-ConQAM, imposing {α→1,β→γ}
256-144-B-ConQAM, imposing {α→γ, δ→ζ}
256-144-C-ConQAM, imposing {α→1, δ→}

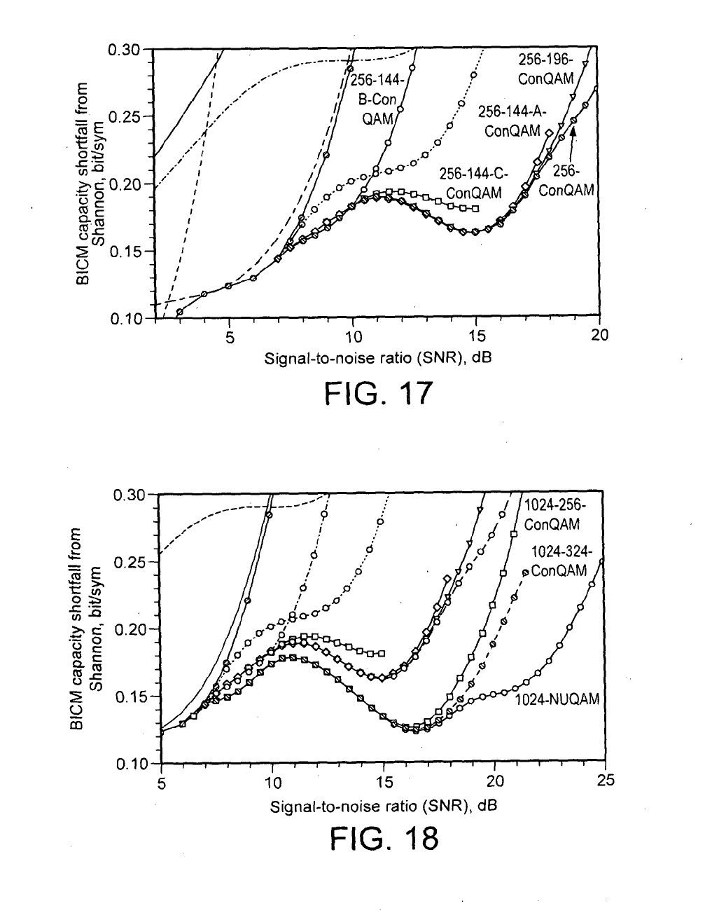

FIG. 17 shows the calculated BICM shortfall for each of these variants of 256 NUQAM. The calculations are performed by imposing the conditions above and then computing the optimum positions of the merged variables using a numerical approach based on the equations 4 to 7 above. As predicted, the different versions perform best in certain SNR ranges. As expected, the less-condensed 256-196-ConQAM performs well up to 17 dB, while 256-144-AConQAM works well from say 10.5 to 15.5 dB. 256-144-B-ConQAM is best below 10 dB (but falls off very quickly above), while 256-144-C-ConQAM essentially devised just for 10 dB—is indeed the best there, falling off both above and below 10 dB. In summary, improvements can be made if you pick the right flavour of 256-ConQAM to match the SNR desired. Nevertheless, with the right choice, 256-ConQAM indeed essentially matches the capacity of its parent 256-NUQAM, while having fewer states to calculate

FIG. 18 shows the BICM capacity shortfall of various condensations for 1024 NUQAM. This includes the same curves as FIG. 17, particularly noting the curve for 256-NUQAM and additionally showing 1024-NUQAM as well as the following condensations:
1024-324-ConQAM,

with {α→1,β→1,γ→1, δ→ε, ζ→η, θ→ι, κ→λ}
1024-256-ConQAM,

with {α→1,β→1,γ→1, δ→η, ε→η, η→η, θ→ι, κ→λ}

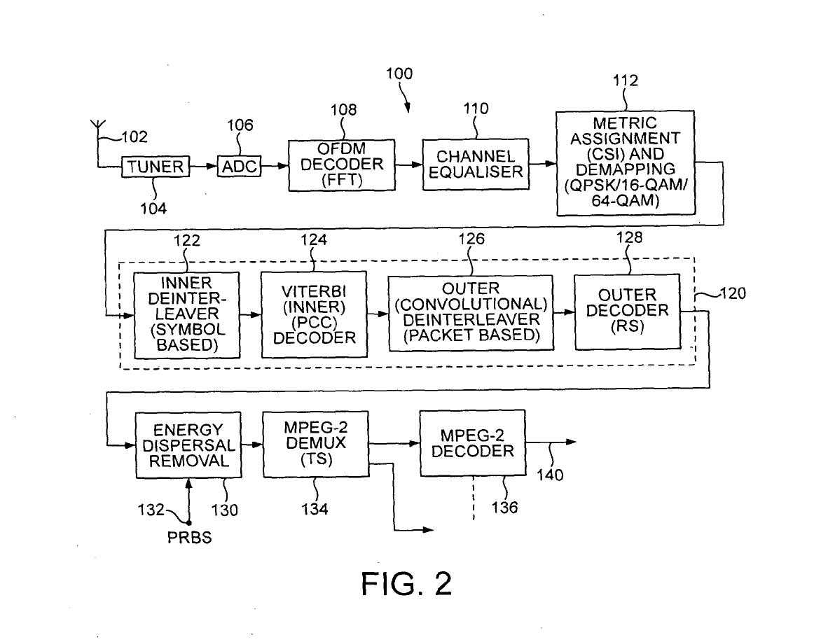

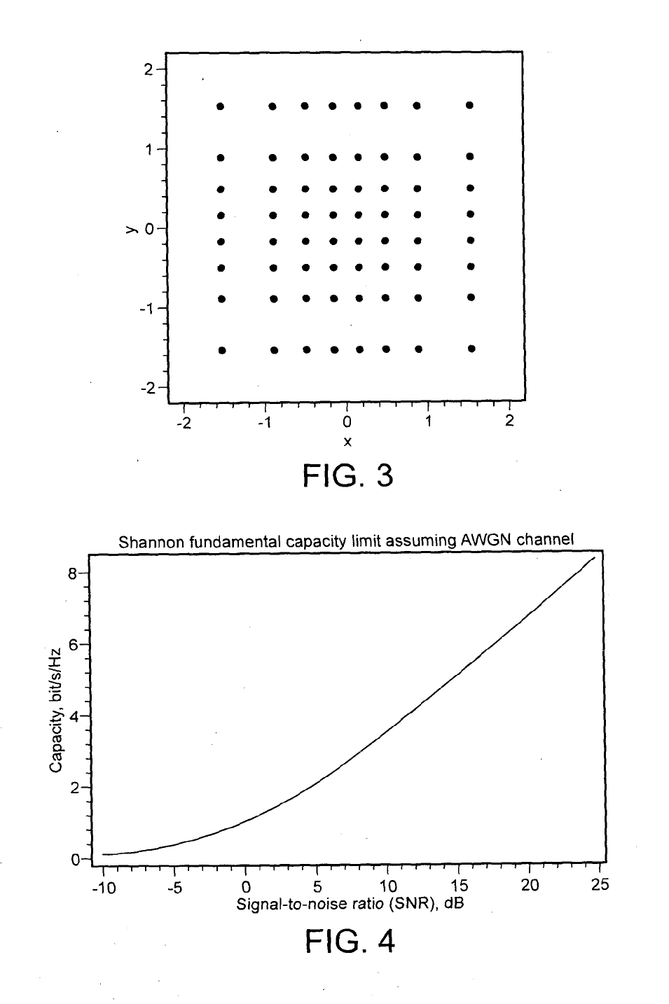

Below 18 dB SNR the 1024-324-ConQAM gets close to 1024-NUQAM, while the more condensed 1024-256-ConQAM only does so below 16.5 dB. Both are very close indeed at 15 dB, the lowest value for which we have an optimised 1024-NUQAM result. For still lower SNRs the two condensations essentially match. At higher SNRs (above 18 dB) these ConQAMs perform appreciably worse than the parent NUQAM, just as we would expect from observing FIG. 2; less-aggressive condensations would be needed here.

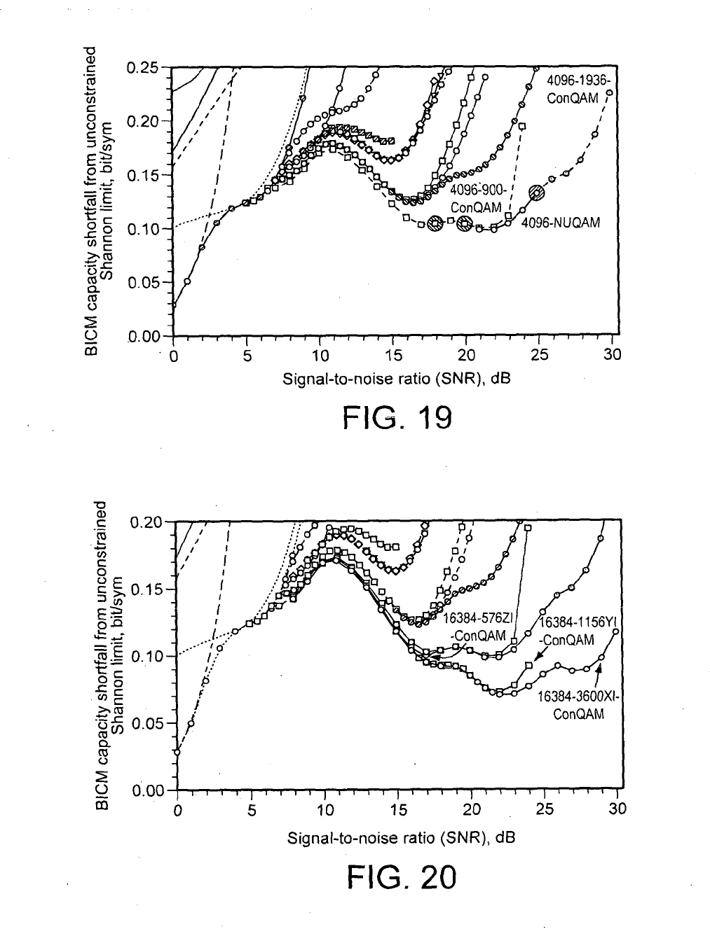

The concepts may be extended to ever higher QAM orders. As final examples, FIGS. 19 and 20 show, respectively, the BICM shortfall with SNR for condensed 4096-QAM and condensed 16384-QAM. 4096-900-QAM was designed knowing the positions for 4096-NUQAM at 18 and 20 dB. It closely matches 4096-NUQAM below 20 dB. At higher SNRs the less condensed 4096-1936-QAM matches 4096-NUQAM up to at least 25 dB, and probably rather higher. The really striking thing is how well both 4096-NUQAM and 4096-900-ConQAM perform, significantly reducing the capacity shortfall of 1024-QAM and lesser constellations, especially at 21 dB SNR. Also observe that uniform 4096-QAM only puts in a distant appearance in the top left corner of the diagram—its natural place for application would be at very much higher SNRs; it is only the NUQAM optimisation that brings such high-order constellations into utility at ‘ordinary’ SNRs that are useful to us.

It is computationally expensive and potentially not currently feasible to optimise 16384-NUQAM directly. However, the improvement of using Condensed QAM as a sufficiently close approximation holds out some chance of gaining some limited insight into how 16384-NUQAM might perform. We simply have to make an inspired guess as to what suitable condensations might apply at some SNR we are interested in We can then optimise that for BICM. This result will be valid for that condensation, and we may infer that the performance of 16384-NUQAM would be the same or better. FIG. 20 shows various trial condensations which indeed achieve further marked improvements over 4096-NUQAM or Con-QAM.

### Further Example Constellations

As discussed above, in ConQAM the number of distinct positions in the constellation is deliberately reduced before optimisation (the constellation is ‘condensed’), while still mapping the same number of bits to it. This reduces the computing power needed to perform the optimisation. We have established that suitable, well-chosen condensations give capacity (within an appropriate SNR range) essentially equivalent to that of the NUQAM from which the ConQAM has been derived. We have further appreciated provided suitable condensations could be chosen it would be possible to produce designs of ConQAM corresponding to much larger parent constellations, those for which direct NUQAM optimisation was not currently feasible. Their calculated capacity would represent a lower bound on the capacity of the related NUQAM. If the condensation were well-chosen it would be a very close bound, but if not then the true NUQAM capacity might still be appreciably higher. In any case, any ‘good’ results showing a closer approach to the unconstrained Shannon limit would be very interesting.

We have provided above results for various ConQAMs which are condensations of 16384-QAM, and whose capacity is shown to be usefully greater than that established for 4096-NUQAM. ConQAM was thus initially conceived as a way to be able to estimate the BICM capacity of very large NUQAMs that could not practicably be optimised directly. However it has uses in its own right. In some cases ConQAM can lead to instrumental simplifications. The capacities presented so far all concern optimising the capacity of rectangular QAM constellations used in transmission over a single SISO Gaussian channel. There is much interest now in MIMO systems. Now, in principle, given that the channels involved in a MIMO system were precisely known then some modulation system could be perhaps be devised that would give the optimum MIMO capacity for that situation. However, in broadcasting we cannot work like that, since the same transmissions are used to serve simultaneously a very large number of receivers each of which is operating in different conditions, with different channels. True MIMO optimisation is therefore not realistic. We have appreciated, therefore, an approach in which we try to optimise the SISO capacity of each transmitted component—at the very least this would give the best result when the various MIMO paths were totally distinct. So, for broadcasting applications, it appears possibly useful to apply the NUQAM/ConQAM concept to MIMO systems. Now, in at least one method of decoding in a MIMO receiver the reduction in constellation cardinality offered by ConQAM can greatly reduce the required search space for MIMO decoding, and hence receiver complexity and power consumption, particularly where very large constellations would otherwise be required. So we have a very good reason to use ConQAM in its own right. The further constellation examples here present some new results for BICM capacity of ConQAM, at both extremes of the range of interest. At the heroic huge-constellation-at-high-SNR end the ultimate capacity is extended by the use of largish constellations like 65536-QAM condensed to 3600, 4096, 4900 or 5476 points. On the other hand, results are also presented for condensations to only 100 or 144 points, for parent constellations from 1024- to 262144-QAM. These were investigated in order to see what might be possible when strictly minimising the number of states in order to simplify a MIMO receiver. In all cases the AWGN channel is assumed.

The results above show that ‘bigger’ constellations, either NUQAMs or their ConQAM substitutes whose condensations are not too ‘tight’, always appear to give better capacity than ‘smaller’ constellations, except at the very lowest SNRs where large NUQAMs appear naturally to collapse to 16-NUQAM and ultimately (uniform) 4-QAM. However, “bigger is better” applies with particular force at the higher SNRs. This is for the simple reason that e.g. 1024-QAM has a limiting capacity of 10 bit/symbol at infinite SNR, whereas the unconstrained Shannon capacity goes on increasing with SNR and thus leaves e.g. 1024-QAM (and each finite-sized QAM) behind. So if we look at the SNR range above say 15 dB we see each successively bigger NUQAM gets a bit closer to the unconstrained Shannon limit, and continues to do so to a higher SNR than its smaller predecessor. Each size then eventually reaches an SNR where it rapidly falls away from the ultimate, and to do better at higher SNR we then have to go to a larger NUQAM. The largest NUQAM discussed is 4096-NUQAM, but results are also given for condensations of the next biggest, 16384-QAM, which show a performance improvement that is steadily more significant from 15 dB upwards. Indeed 16384-3600X1-ConQAM introduces a fresh lobe of locally-good behaviour at 27 to 28 dB before its performance too falls away above 29 dB. Now, maybe some of that final capacity limitation occurs because a condensation to 3600 points is by then too ‘tight’, just as the more tightly condensed 16384-1156Y1-ConQAM reaches its limitations rather earlier. However, we also know from the NUQAM results (and the reasoning of the previous paragraph) that ultimately we'd need the next bigger constellation anyway.

65536-ConQAM.

As previously explained, it is easy to choose condensations where we have results for the NUQAM, as we do up to 4096-NUQAM. We simply observe which points in the constellation tend to merge at the SNR of interest, and define a condensation in which those points are precisely condensed before performing the optimisation. It gets harder when the constellation is sufficiently large that we cannot directly optimise the NUQAM. We have to use a combination of inspiration and trial-and-error. If we find a good one the results speak for themselves. Of course, such ConQAM results can only be a lower bound on the potential NUQAM performance as it is always possible that there might be a ‘better’ condensation that we haven't tried—and this applies with ever greater force as the constellations get bigger and the number of possible condensations consequently mushrooms. Even describing condensations in a simple way becomes more challenging as the constellation size increases, which can make things harder to visualise. At first, with small constellations, we could describe the condensation rules directly as e.g.
{α→1, β→γ} of 256-I44A-ConQAM

As things got more complicated we l list instead the number of adjacent points in the NUQAM that had been condensed to form each ConQAM point, working outward from the origin. E.g. the condensation for 16384-576Z1-ConQAM can be written as {16, 16, 8, 8, 4, 4, 2, 2, 1, 1, 1, 1}. The number of entries is the number of condensed points on one side of one constellation axis (i.e. one-half the size of the PAM constellation, or one-half of the square root of the number of points in the ConQAM constellation in all). So even a list like this gets unwieldy with large ConQAMs—it becomes difficult for the eye to take in how many 8s, 4s etc there are next to each other. A possibly helpful further shorthand is then to say that for this example we have {2, 2, 2, 2, 4} groups of {16, 8, 4, 2, 1} adjacent points respectively. What should we try for 65536-ConQAM? A possibility is to see what can be done with a condensation to 3600 positions, the same as the biggest 16384-ConQAM produced. We have appreciated this may be a good choice because the complexity of the optimisation is broadly similar (same number of free variables, but a slightly more complicated integrand) and so should be possible with the resources to hand, given that 16384-3600 could be done. We might wonder if it may prove a little ‘tight’ at higher SNR, but discuss this further below.

65536-3600-ConQAM

The first idea tried was 65536-3600A, which had {1, 9, 5, 5, 10} groups of {16, 8, 4, 2, 1} adjacent points respectively. In some parts of the SNR range this was inferior to 16384-ConQAM so it wasn't pursued further. One thought was that perhaps grouping 16 points near the origin might have been excessive, so an arrangement 65536-3600B which avoided that was tried. It had {11, 5, 6, 8 } groups of {8, 4, 2, 1} points. More promising results were obtained with 65536-3600C, which had {3, 5, 4, 6, 12} groups of {16, 8, 4, 2, 1} adjacent points. A worthwhile improvement could be noted at SNR of 23 dB, but the capacity shortfall steadily increased after that. Noting that 16384-3600-ConQAM managed to have a further lobe of slightly better performance around 28 dB, while 65536-3600C did not, suggested that perhaps a less ‘tight’ condensation with more points might offer a benefit. So we tried with a condensation to 4096 points (same number of independent variables to optimise as 4096-NUQAM).

65536-4096-ConQAM

It wasn't immediately clear which part of the 65536-3600C was too ‘tight’ so for the first try with the slightly bigger 65536-4096A-ConQAM we tried relaxing both the ‘inside’ and the ‘outside’ slightly by splitting one of the 16s back to two 8s and the outermost pair to two singles, giving {2, 7, 4, 5, 14} groups of {16, 8, 4, 2, 1} adjacent points. This gave a slight improvement at high SNR, in that the rate at which performance fell off at high SNR was tamed a little. Looking at the spot positions suggested that two pairs of singles could perhaps be re-merged, allowing some of the larger groups to be split while keeping the number of points the same. So this led to 65536-4096B-ConQAM, having {1, 8, 6, 7, 10} groups of {16, 8, 4, 2, 1} adjacent points. This improved the high-SNR performance further—but still there was no sign of another lobe of better performance forming, nor did it beat 16384-3600-ConQAM at highest SNR.

65536-4900-ConQAM

The desire for further improvement led us to try more condensed points still, opening up the innermost group of 16 to two 8s, and splitting the two outermost 8s as well. This gave 65536-4900AConQAM, having {8, 10, 7, 10} groups of {8, 4, 2, 1} adjacent points. This now produced the hoped-for extra lobe of good performance around 28 dB, and so represented a big improvement on 65536-4096BConQAM and of course 16384-3600X1-ConQAM.

65536-5476-ConQAM

We then tried relaxing the promising 65536-4900A-ConQAM condensations slightly further to see what might be gained by splitting two of its groupings. Based on the spot-position behaviour we tried 65536-5476 A-ConQAM, having {8, 9, 8, 12} groups of {8, 4, 2, 1} adjacent points. This gave very similar performance except at the highest SNR where the rate of fall-off was very slightly reduced, confirming that the groups that had been split had indeed been ‘pinching’ slightly in 65536-4900AConQAM at these highest SNRs.

Results for various 65536-ConQAM condensations at high SNR

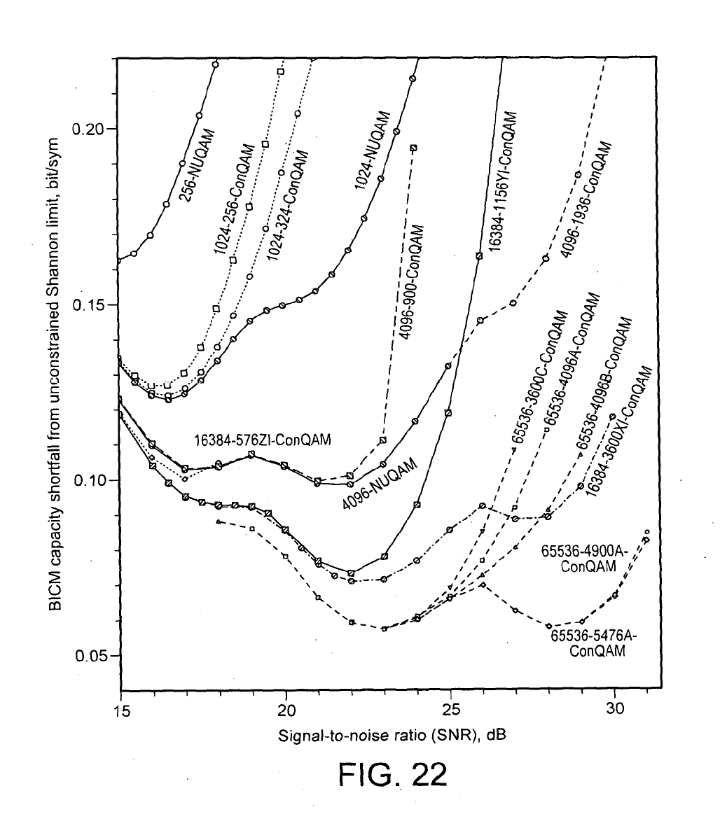

The results of these various condensations of 65536-QAM are presented in. FIG. 22, which follows the previous figures in presenting the shortfall in BICM capacity from the unconstrained Shannon limit, as a function of SNR. The same presentation is used as before, in that solid lines and plot points represent NUQAM, while ConQAM have dashed lines with open plot-point markers. The previous assertion that at high SNRs “bigger is better” seems to be maintained. Condensations of 65536-QAM have been found that consistently outperform all the ‘smatter’ constellations found so far, at all SNRs but especially so in the highest-SNR range. The ‘extra lobe’ finally unearthed with the least condensed variants 65536-4900A and 65536-5476A extends the range of good performance to higher SNRs than previously. Unfortunately it does seem that ConQAMs having more points than before are needed to achieve this. Nevertheless, 4900 is much fewer than 65536. The results all converge below 24 dB, so that the condensation to 3600 points is sufficient in this lower range, and indeed at lower SNRs tighter condensations still would probably be adequate.

Compact ConQAMs and MIMO

As explained in the start of this section, for broadcast MIMO applications there are attractions to using Condensed QAM, for the reduction it brings in total distinct points transmitted and, in consequence, in decoding complexity. Furthermore, with the current state of the decoding art, there are applications where quite small numbers of points are desirable. This therefore argues against using the larger NUQAMs, despite their capacity advantages, simply because they are large. However, Condensed QAM brings the possibility of having some of the performance advantages of a larger constellation with fewer points. The previous sections have shown this happening with particular force at high SNR—but there even Condensed QAM is still using an uncomfortably large number of distinct points for present-technology MIMO decoders. Nevertheless there are applications in the lower SNR range that are of interest. Could we find some useful ConQAMs here? Let us suppose we need something with rather fewer than 256 points but hopefully with better performance than 256-NUQAM (i.e. we're greedily looking for better performance and less complexity at the same time). To what extent might such condensations, when applied to progressively larger parent constellations, still pay off in the extreme? We know from past results that tight condensations show their limits at high SNR, and conversely that tighter condensations of a particular NUQAM tend to become possible as SNRs reduce. However, we now have a slightly different question: suppose we keep a fixed number of condensed points, in some lower SNR range—how does capacity then vary with the size of the parent constellation?

A Way to Construct Condensations

Here we report some investigation of ConQAMs condensed to just 100 or 144 points. If we consider ConQAM having 100 condensed points, that is 10×10 or just 5 points on one side of a single (PAM) axis. This is in fact the next possible size up from a constellation having 64 points in all, or 4 points on one side of the axis. Suppose we then consider the next bigger ‘regular’ QAM, which is 256-QAM. If we were to condense its points in such a way that each adjacent pair were condensed to one point we'd have points grouped as {2, 2, 2, 2} points, and of course it would represent an exact collapse to 64-NUQAM, with identical performance since the coded bit mapped to the LSB would in effect not be transmitted—this coded bit would have no effect on what points were transmitted. So this thought-experiment has, apparently rather uselessly, constructed 256-collapsed-to-64-QAM.

However, if we now change this grouping slightly and consider {2, 2, 2, 1, 1} we now have a valid 256-100 QAM—there are 5 points on one side of the axis, and the outermost state of ‘256-collapsedto-64-QAM’ has been split into 2. The LSB coded bit now does something, some of the time, so we can hope for an increase in BICM capacity, compared with 64-NUQAM. We can extend this rule to larger parents of xxx-100-ConQAM. We first group the appropriate power of −2 adjacent points together to form ‘xxx-64-CollapsedQAM’, then split off 1 unique position from the outermost state. This is better expressed in a small table:

| ConQAM | Point grouping |
|---|---|
| 1024-100A | {4, 4, 4, 3, 1} |
| 4096-100A | {8, 8, 8, 7, 1} |
| 16384-100A | {16, 16, 16, 15, 1} |
| 65536-100A | {32, 32, 32, 31, 1} |
| 262144-100A | {64, 64, 64, 63, 1} |

In a similar way we can construct a form of the next largest condensation to 144 points by similarly splitting the next-to-outermost group in the previous table.

| ConQAM | Point grouping |
|---|---|
| 1024-144A | {4, 4, 4, 2, 1, 1} |
| 4096-144A | {8, 8, 8, 4, 3, 1} |
| 16384-144A | {16, 16, 16, 8, 7, 1} |
| 65536-144A | {32, 32, 32, 16, 15, 1} |
| 262144-144A | {64, 64, 64, 32, 31, 1} |

Now whether these are in any way useful choices we have to determine by trying them. They do seem to follow some ‘rules’ of previously observed behaviour:
outermost points are usually the last to merge as SNR is lowered—in other words having a singleton point at the outside is a good idea
when inner points converge they often seem to converge by groups which contain 2^{k} points, with larger groups near the origin than further out

On the other hand it must be observed that there is a rather stark change from the singleton at the outside to the increasingly large group comprising the next-to-outermost point, as the parent size increases. There may be other better solutions. However, several different ways of dealing with 4096-100-ConQAM were tried, and the construction shown in the table remained the best amongst those at least. The results follow interesting patterns which we'll examine in stages.

Results at Very Low SNR

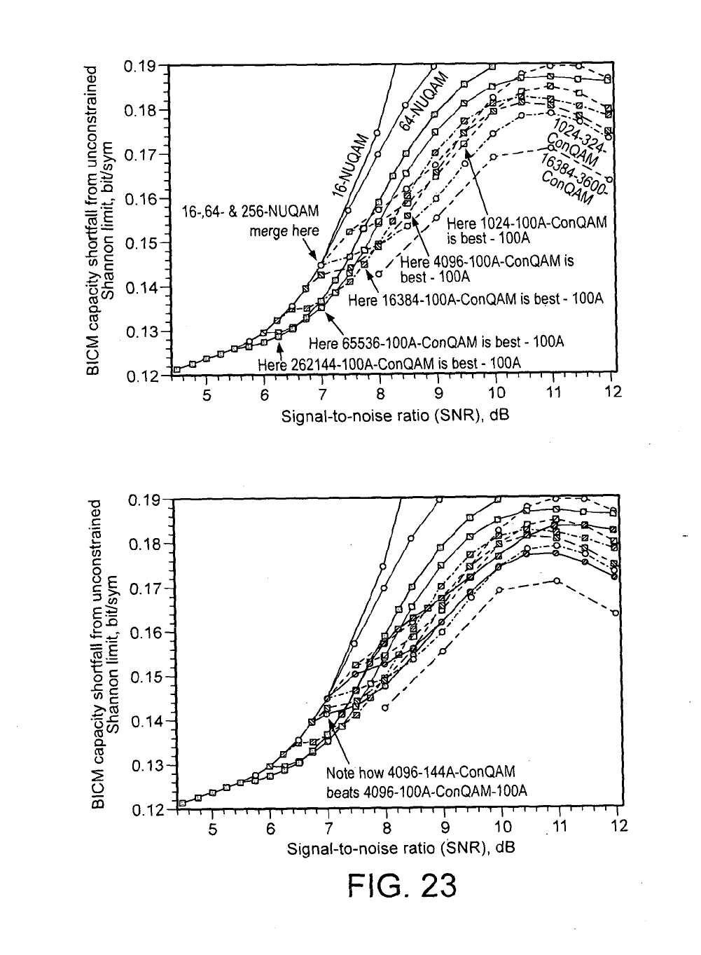

The results at very low SNR follow an interesting and simple pattern. FIG. 23 shows the shortfall in BICM capacity from the Shannon unconstrained limit (for a Gaussian channel), for the various xxx-100A ConQAMs having 100 condensed points (upper Figure) and then with the xxx-144A added as well (lower Figure). Note first, to set a kind of reference, that the various NUQAMs (16-, 64- and 256-NUQAM) are shown with solid lines. Furthermore the dashed plots with circle markers are for various ConQAMs. The upper such plot is for the lightly condensed 1024-324-ConQAM. In this SNR range we can take this as a good prediction for 1024-NUQAM. We see that amongst these, as we expect, “bigger is better”, down to the SNR of about 7 dB where they all merge, the bigger ones all collapsing to 16-NUQAM. The lower dashed plot with circle markers is for the relatively lightly condensed 16384-3600-ConQAM, which we take as a good prediction for 16384-NUQAM in this range. These results don't extend low enough in SNR to see where this merges, but it looks likely to be below 7 dB. Now consider what happens with our various xxx-100A ConQAMs, all plotted with square markers and dashed lines—see upper FIG. 23. These must of course perform worse than (or, at most, the same as) the NUQAMs from which they are derived. We see clearly that this is true for 1024-100A-ConQAM, which we see joining the 256-NUQAM curve at 7.5 dB. As it happens we don't have any plots here for 4096-QAM, but we see that its tight new condensation 4096-100A-ConQAM does better than 1024-100A, only collapsing to 16-NUQAM somewhat below 7 dB. Similarly, 16384-100A-ConQAM, 65536-100A-ConQAM and 262144-100A-ConQAM collapse by turns even further down in SNR, around 5.5 dB for the last. So considering only this range of tight condensations to just 100 points, we see that for very low SNRs it is advantageous to use the largest parent QAM in deriving the 100-point ConQAM.

However, amongst these “bigger (parent) is not always better”. If we look at the biggest, 262144-100A-ConQAM, and follow it upwards in SNR we see we reach a point (between 6.5 and 6.75 dB) where the next-smaller parent (65536-100A-ConQAM) becomes preferable. Then that in turn hands over again to 16384-100AConQAM around 7.25 dB, then to 4096-100A-ConQAM just below 8 dB and then to 1024-100AConQAM just below 9 dB. These small, equal-sized ConQAMs thus follow here an interesting inversion of the pattern seen for UQAMs. Previously as SNR increased, the increasing sizes of UQAM took turns to be the best; here, at low SNR, with small xxx-100A ConQAMs we see they take turns to be the best in the reverse order of the parent-QAM size. We shouldn't be surprised: we know from previous results that at higher SNRs the performance degrades as a particular parent QAM is condensed more and more tightly. While, as we see, at very low SNR a huge parent condensed to 100 points outperforms a similarly condensed smaller parent, there has to come a point as SNR increases where the strain of this tight condensation will tell. When this happens, the next smaller parent ‘feels the pinch’ less severely and thus comes to win—for a while, and so on. The lower FIG. 23 shows the xxx-144A results added, in matching shades but with diamond markers. This is starting to get hard to read. Careful scrutiny shows that this slightly more relaxed condensation performs slightly better in each case. It's quite clear (at low SNR) for 1024- and 4096A-144-ConQAMs but barely perceptible there for the bigger ones. The same pattern (of being best by turns) applies amongst the xxx-144A-ConQAMs as it does amongst the xxx-100A-ConQAMs. As the SNR increases we see a greater divergence appearing between the −100A and −144A versions of ConQAM from the same parent size. E.g. for 262144-ConQAM it becomes quite apparent above say 8 dB, with 262144-144A clearly beating 262144-100A.

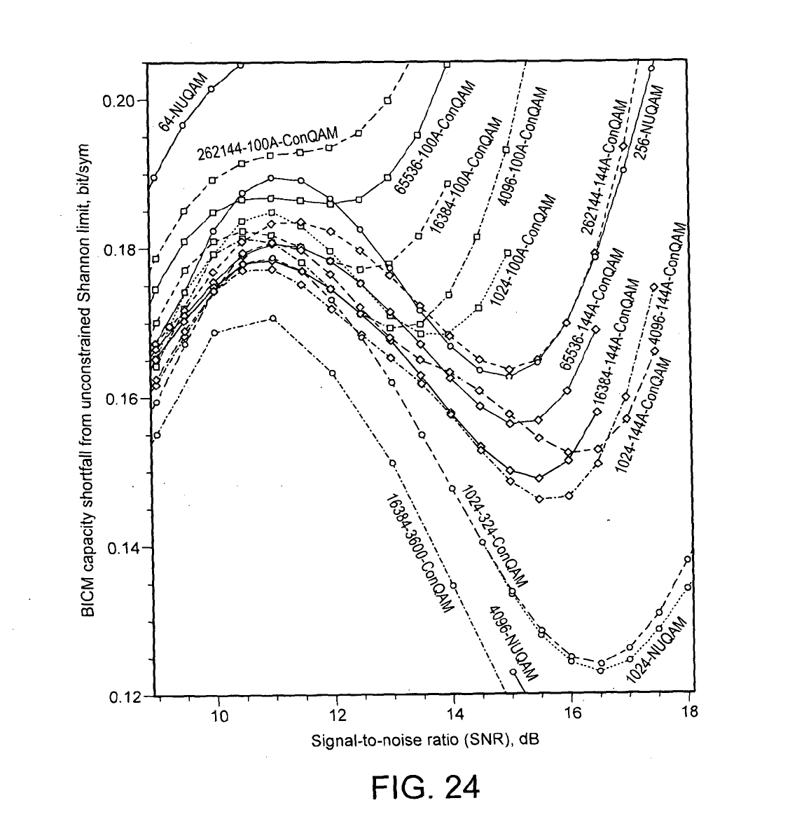

Studied closely, FIG. 23 already reveals that the simple pattern of behaviour observed at low SNR is starting to break up as the SNR increases. We therefore produce another set of plots to examine this in FIG. 24. The same plotting styles are used as in FIG. 23, so the plots with squares and diamonds are the xxx-100As and xxx-144As respectively as before. We can see that each ConQAM finally reaches an SNR where the curves turn sharply upwards and the performance falls off (relative to the Shannon unconstrained capacity). And this happens in more or less the order you expect; for each parent constellation the more-condensed xxx-100A turns up at a lower SNR than its slightly less condensed xxx-144A ‘sibling’. Amongst the xxx-100A set, the ConQAM with the largest parent turns up first, and then the others in order of decreasing parent size, so that the smallest shown (1024-100A) fails last, and is the best amongst these at the highest SNR. The same rule applies amongst the xxx-144A set. However, we also have to be careful not to over-generalise. At any particular SNR operating point we have to be careful to pick the best performer for our application. The very best performance of course is given by the least condensed version available of the very biggest parent, i.e. amongst the results here it would be 16384-3600-ConQAM. However, if we need a compact constellation (e.g. in order to simplify a MIMO receiver) then ConQAM can certainly offer a useful solution and we just have to use e.g. FIG. 24 to choose the right option. To give an example, suppose we need a compact ConQAM at 11 dB SNR. We see that in this case, if we need 100 points, the best is 4096-100A, followed in order by 16384-100A, 1024-100A, 65536-100A and finally 262144-100A is the worst. If we need 144 points, the best is 4096-144A, followed in order by 16384-144A, 65536-144A, 1024-144A (just worse, reversing the order c.f. −100A), and finally 262144-144A is the worst. Looking more widely, 4096-100A is the best xxx-100A-ConQAM from 10 dB to about 13.3 dB. Above that SNR 1024-100A wins; it also wins below it from about 8.8 dB to 10 dB. On the other hand, 4096-144A is the best xxx-144A-ConQAM over a wider range from about 9.8 dB to about 16.7 dB. The 1024-144A wins above and immediately below this range. A further useful comparison is to note that at least one of the xxx-100A ConQAMs beats 256-NUQAM at every SNR up to about 13.8 dB. And one or more of the xxx-144A ConQAMs beats 256-NUQAM over the whole SNR range. In other words, with ConQAM we can eat our cake and have it too: reduced complexity (for MIMO at least, from having fewer condensed constellation points) and better capacity, at the same time.

### Conclusions

We have shown that ConQAM achieves similar BICM capacity to the NUQAM scheme on which it is based over certain SNR ranges; that is that some points within a constellation may be constrained to be at the same position. Accordingly, the ConQAM scheme can be used as an approximation to NUQAM and then use the “full” NUQAM scheme (with 2ⁿ distinct constellation positions) or indeed the ConQAM scheme may be used in its own right (with fewer than 2ⁿ constellation positions). Tables giving positions of constellation points determined according to the proposed further improvement for various QAM schemes are given at appendix A.

As a recap, as can be seen in FIG. 18, BICM-optimised 1024-256-ConQAM provides an improvement over BICM optimised 256-QAM. This is at first a surprising result as both schemes have 256 constellation positions. What this means is that the 256 positions do not occur with equal probability. The improvement gained relates to the combination of the forward error corrector (FEC) and the design SNR for which the constellation positions are optimised.

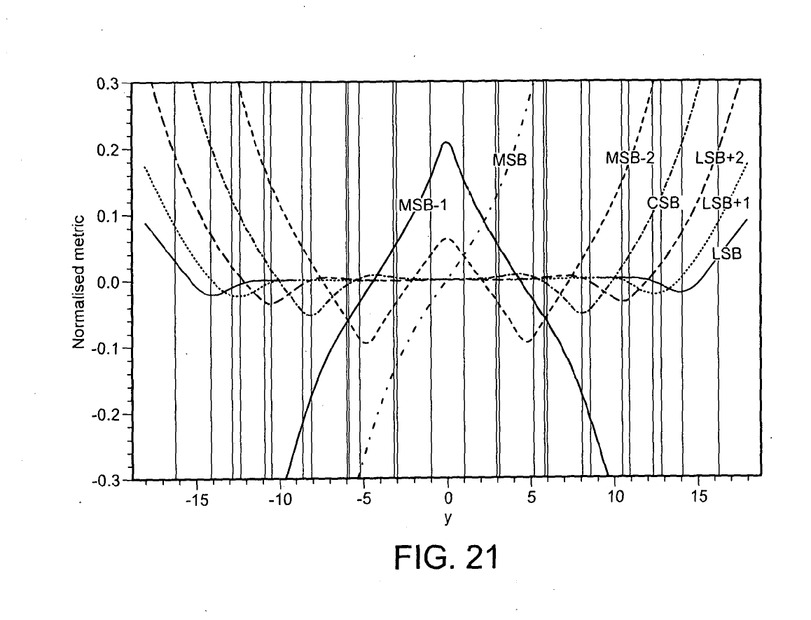

Some explanation of the improvement gained using the embodiments of the invention may be made by considering the operation of the receiver and receiver metrics with reference to FIG. 21. A receiver using soft decisions calculates what are known as LLRs, log likelihood-ratios. In knowing what voltage y has been received, the receiver then needs to infer from that information the likelihoods that a 0 or 1 has been transmitted, and the log of their ratio is taken as the soft-decision metric fed to the FEC decoder (error corrector block 120 of FIG. 2).

The use of a logarithmic form is convenient, because multiplication of probabilities can be achieved by simple addition, e.g. in implementations of a Viterbi decoder. For simple 2-level signalling (as in 4-QAM) it is easy to show that the LLR is a linear function of voltage y, having a slope proportional to the (linear) SNR. Things get more complicated with higher orders of QAM. At very high SNR the LLR now takes a piecewise linear form, but this becomes more ‘curvy’ at lower SNRs. The overall ‘gain’ still varies with SNR, just as for 4-QAM. It can therefore be useful to consider a normalised metric, where the LLR has been divided by the SNR, when comparing the metrics calculated at different SNRs. This makes it easier to compare degrees of curviness, and note any movements of the decision boundaries (zerocrossings) as the SNR changes. Such a plot of normalised metrics is shown in FIG. 21. The vertical gridlines are at the constellation-spot positions.

As can be seen, at some constellation positions (values of voltage), the lower significant bits (LSB, LSB+1 and LSB+2) provide no contribution. However, when those lower significant bits are at higher voltages (relating to non-merged states) they provide a contribution. We can see that as we go to higher-order BICM-optimised NUQAMs (or their well-chosen ConQAM derivatives) the LSBs become ‘weaker’, having ‘dead-zones’ in their metrics where they contribute little. Clearly they become in a sense ‘part-time’: when the high-significance bits cause non-merged states to be occupied, they have something to offer; when merged states are occupied the LSBs become powerless. In effect it is very like puncturing.

Punctured codes are used as a way to have a family of FEC codes that cover a range of code rates. A good mother code having a low code rate is used as a starting point. When a code of higher rate is needed, that implies that fewer coded bits can be transmitted for a given number of input uncoded bits. One way to achieve this is simply to omit to send some of the coded bits that the mother code has generated. This is done in a systematic pattern known to both transmitter and receiver and is known as puncturing the code. At the receiver, dummy bits are fed to the FEC decoder in those locations in the sequence where the punctured bits were never transmitted, so that the decoder receives the same number as were originally generated. However, these added dummy bits are marked as erasures, so that the decoder ‘knows’ not to attach any significance to them. The marking-as-erased simply means that the soft-decision metric is set to zero (in effect ‘I have zero confidence in the accuracy of this bit’).

Now consider what is happening as we adopt higher-order NUQAM constellations. We find that BICM-capacity optimisation leaves some of the constellation points very close together indeed (and in ConQAM they are deliberately co-located). The consequence is that the receiver metric for the affected bits (the LSB, and some others, depending on the constellation) is very flat and equal to zero (or essentially so) for a range of positions around the (nearly) merged positions. So when the received signal is in this range, the soft-decision information is as good as marking an erasure.

The difference between this and puncturing is very small. In puncturing, a coded bit is punctured because of where it happens to fall in the coded sequence in relation to the prearranged puncturing pattern. In NUQAM, the essentially-erased bits suffer this fate as a consequence of being mapped at a weak level (e.g. the LSB) in a symbol where the high-significance bits happen to take a combination which determines that the ‘weak bit’ in question is mapped to a (nearly) merged state. But some of the time the same ‘weak bit’ is mapped to a constellation position that is well-separated from its neighbours, and then it does make a contribution to the capacity. Suppose a particular application needs to transmit a payload whose uncoded bit rate is equivalent to 6 bit/symbol. Suppose also that we use a particular FEC code of rate 1/2. So it generates 12 coded bits per transmission symbol. We could map all of these coded bits to 4096-NUQAM (or a ConQAM derivative).

To make for easy numbers, suppose the mapping is such that the 2 LSBs are ‘erased’ say ½ of the time, and 2 next-to-LSBs are ‘erased’ say ¼ of the time. On average then 10.5 coded bits are received unerased per symbol, so the ‘effective’ code rate becomes 6÷10.5=4/7. If instead we used say 256-QAM (and assume no flat spots in the metric), then we can send 8 coded bits per symbol, and the ‘effective’ code rate becomes 6÷8=3/4, a rather higher rate, in this case achieved by traditional puncturing. Perhaps by avoiding explicit puncturing, and letting it happen as an incidental yet integral part of the mapping/demapping process of high-order NUQAM, we are in some way helping the BICM work more effectively

So far we have considered optimising the constellation for the best BICM capacity. Since we have a direct interest in implementing practical versions of BICM, this is the topic of most interest. However, other measures of capacity such as CM capacity could be optimised as alternatives. Indeed we can apply exactly the same approach e.g. in the range where 16-QAM optimises nicely for BICM, the CM is also well-behaved, albeit that slightly different values for γ are needed to optimise CM and BICM capacities at the same SNR.

### Further Conclusions

An important point has been to recognise that there is an additional advantage to ConQAM, namely that the reduction it offers in the number of distinct points in the constellation (‘cardinality’ in the jargon) brings an appreciable reduction of the complexity of a receiver that is used in a MIMO context. Although the constellations reported in all this work, here are optimised, per-SNR, for the single AWGN channel (and thus for SISO systems) we have to note that we cannot easily optimise for the MIMO channel in broadcast applications. The channel is not known to the transmitter, indeed there are countless different ones, since many receiving locations are served simultaneously. So constellations optimised for SISO may well be as good as we can do, in which case all the results so far are of interest to MIMO, and the reduction in the number of constellation points in ConQAM becomes exciting.

There have therefore been two areas of interest to study. One is to look for useful condensations of ever-huger QAM constellations to see how closely the Shannon unconstrained BICM capacity limit can be approached. The largest ConQAM was 16384-3600-ConQAM, whose best result was a shortfall of 0.071 bit/symbol at a design SNR of 22 dB. Extending to 65536-ConQAM has reduced the shortfall to 0.057 bit/symbol at 23 dB SNR, and opened out a second lobe of good behaviour having 0.058 bit/symbol shortfall at 28 dB SNR. So our hope of getting ever closer to the unconstrained limit by using a ‘sufficiently relaxed’ condensation of the next bigger QAM has borne fruit again. It seems likely that this could be continued indefinitely, given sufficient patience and computing time to do the optimisation. However, picking a suitable condensation (without having results for the ‘parent’ NUQAM to examine, because they are beyond reasonable computation) is becoming a bit haphazard. There is no guarantee that the best ones have been found for the cases reported here, so as always all ConQAM capacity results here must simply be treated as a lower bound on what may be possible with the parent NUQAM.

The second area of interest, particularly now potential applicability to MIMO and simplifying its receivers has been appreciated, is to look at ‘compact’ ConQAMs having quite few condensed points, whatever parent QAM they have been condensed from. Examples have been examined, mostly for the cases having 100 or 144 points in the constellation. As far as MIMO-receiver complexity goes, this would be intermediate between 64-NUQAM and 256-NUQAM. We find that 144-point ConQAMs can always be found that out-perform 256-NUQAM. This means we can have less complexity and better performance at the same time. 100-point ConQAMs can always be found that out-perform 64-NUQAM, and even out-perform 256-NUQAM up to about 13.8 dB.

Which compact ConQAM is best depends on the SNR range. At the very lowest SNR, the most extreme examples tried win (262144-144A and 262144-100A). For a given number of points, the optimum parent constellation then changes in decreasing order as the SNR rises. So 65536-100A takes over from 262144-100A at slightly higher SNR and so on, see FIG. 23. In the medium SNR range the pattern is not so simple. 4096-144A and 4096-100A are best over most of the SNR range. 1024-144A and 1024-100A are better at higher SNRs and also for a range of intermediate SNRs, again please refer to FIG. 23. In effect, the choice of ConQAM scheme is selected by: choosing the number of points to be used in the scheme; analysing the capacity at a given SNR for different NUQAM schemes condensed to have the chosen number of points; and selecting the ConQAM scheme having the maximum channel capacity.

The processing required by a MIMO receiver may be reduced using the ConQAM schemes described. This is because a MIMO receiver has, in principle, to ‘try all the constellation points’ to find the one must likely to have been sent (given the received signal value). So to do this in a ‘brute force’ fashion needs M*N tries, where M is the constellation cardinality and N the number of transmitters in the MIMO set-up. So we gain in conQAM a factor R*N where R is the ratio of condensed cardinality to that of the mother constellation. In practice the search can be done in cleverer ways than just the ‘brute force’ method, but the potential gains are still substantial and well worth the choice of ConQAM over NUQAM despite the very small performance price paid.

Appendix A

TABLE 1
1024 QAM Optimisation

| SNR, | capacity, | | | | | | | |
|---|---|---|---|---|---|---|---|---|
| dB | bit/symbol | α | β | γ | δ | ε | ζ | η |
| 15. | 4.89436 | 0.980548 | 0.982758 | 1.00237 | 3.03113 | 2.91166 | 2.90001 | 3.0208 |
| 15.5 | 5.06119 | 1.0011 | 0.993904 | 0.99287 | 2.94158 | 2.96032 | 3.10758 | 3.08959 |
| 16. | 5.22667 | 0.998635 | 1.00858 | 1.00987 | 2.9737 | 2.99864 | 3.17946 | 3.15367 |
| 16.5 | 5.39016 | 0.995345 | 1.02894 | 1.03346 | 2.99909 | 3.02854 | 3.25465 | 3.22147 |
| 17. | 5.55129 | 0.992261 | 1.06113 | 1.06883 | 3.02488 | 3.05485 | 3.35029 | 3.31249 |
| 17.5 | 5.71027 | 0.991597 | 1.11898 | 1.12762 | 3.06942 | 3.09267 | 3.50188 | 3.46689 |
| 18. | 5.86808 | 0.993958 | 1.21872 | 1.22528 | 3.15912 | 3.17184 | 3.74734 | 3.72184 |
| 18.5 | 6.02576 | 0.997143 | 1.38671 | 1.39016 | 3.33217 | 3.33661 | 4.13732 | 4.12177 |
| 19. | 6.18436 | 0.999598 | 1.71173 | 1.71267 | 3.68679 | 3.6862 | 4.83051 | 4.82213 |
| 19.5 | 6.34552 | 1.00032 | 2.19428 | 2.19426 | 4.21036 | 4.20732 | 5.76432 | 5.76034 |
| 20. | 6.50853 | 1.00041 | 2.54817 | 2.54753 | 4.59098 | 4.58659 | 6.41861 | 6.42171 |
| 20.5 | 6.67157 | 1.00035 | 2.75608 | 2.7548 | 4.81468 | 4.81048 | 6.79684 | 6.81277 |
| 21. | 6.83358 | 1.00005 | 2.87771 | 2.67606 | 4.94493 | 4.94352 | 7.01385 | 7.04948 |
| 21.5 | 6.99385 | 0.999671 | 2.94674 | 2.94547 | 5.01741 | 5.02246 | 7.13124 | 7.19564 |
| 22. | 7.15197 | 0.999494 | 2.98298 | 2.98366 | 5.0526 | 5.06992 | 7.18169 | 7.29029 |
| 22.5 | 7.30796 | 1.00016 | 3.00014 | 3.00589 | 5.06408 | 5.10337 | 7.1865 | 7.36325 |
| 23. | 7.46195 | 1.00314 | 3.00793 | 3.02476 | 5.06207 | 5.13871 | 7.16522 | 7.44122 |
| 23.5 | 7.61397 | 1.01176 | 3.01298 | 3.05314 | 5.05466 | 5.197 | 7.13856 | 7.56502 |
| 24. | 7.76423 | 1.03416 | 3.02417 | 3.11316 | 5.06028 | 5.31848 | 7.15873 | 7.80308 |
| 24.5 | 7.91305 | 1.09301 | 3.06369 | 3.25935 | 5.13672 | 5.60203 | 7.35201 | 8.28985 |
| 25. | 8.06121 | 1.26816 | 3.21705 | 3.66962 | 5.49885 | 6.33058 | 8.0494 | 9.33465 |
| 25.5 | 8.21114 | 2.01084 | 3.98927 | 5.1756 | 7.1137 | 8.57658 | 10.508 | 12.2638 |
| 26. | 8.36395 | 2.56887 | 4.57204 | 6.23344 | 8.25661 | 10.0819 | 12.1691 | 14.2126 |
| 26.5 | 8.51512 | 2.80158 | 4.81384 | 6.68009 | 8.73557 | 10.7268 | 12.8768 | 15.0562 |
| 27. | 8.66295 | 2.91328 | 4.92997 | 6.89612 | 8.9681 | 11.0421 | 13.2249 | 15.4729 |
| 27.5 | 8.80673 | 2.96647 | 4.98552 | 6.99946 | 9.08022 | 11.1939 | 13.3928 | 15.6711 |
| 28. | 8.94595 | 2.99044 | 5.01062 | 7.0456 | 9.12981 | 11.2569 | 13.4611 | 15.744 |
| 28.5 | 9.08006 | 3.00002 | 5.02001 | 7.06184 | 9.14424 | 11.2735 | 13.4669 | 15.7358 |
| 29. | 9.2083 | 3.00317 | 5.02183 | 7.06309 | 9.13919 | 11.259 | 13.4349 | 15.6781 |
| 29.5 | 9.32963 | 3.00375 | 5.02035 | 7.05762 | 9.12488 | 11.2308 | 13.3853 | 15.5985 |
| 30. | 9.44276 | 3.00354 | 5.01794 | 7.05037 | 9.1085 | 11.2001 | 13.3335 | 15.5178 |
| 30.5 | 9.54634 | 3.00306 | 5.01536 | 7.04316 | 9.09297 | 11.1716 | 13.2862 | 15.4449 |
| 31. | 9.63918 | 3.00263 | 5.01318 | 7.03705 | 9.07984 | 11.1475 | 13.2463 | 15.3833 |
| 31.5 | 9.7204 | 3.00234 | 5.0115 | 7.03215 | 9.06915 | 11.1277 | 13.2133 | 15.3321 |
| 32. | 9.78953 | 3.00196 | 5.00984 | 7.02768 | 9.05973 | 11.1105 | 13.1849 | 15.2883 |
| SNR, | | | | | | | | |
| dB | θ | L | κ | λ | μ | ν | ξ | ∘ |
| 15. | 5.09067 | 5.76678 | 5.66847 | 5.03139 | 10.3416 | 8.41086 | 7.89393 | 12.7861 |
| 15.5 | 5.16717 | 5.09769 | 5.76268 | 5.90028 | 8.00865 | 8.55482 | 10.5983 | 13.1201 |
| 16. | 5.23365 | 5.1576 | 5.85493 | 6.02778 | 8.10571 | 8.67254 | 10.7971 | 13.3781 |
| 16.5 | 5.29126 | 5.21295 | 5.9608 | 6.16483 | 8.19518 | 8.7822 | 10.9569 | 13.5764 |
| 17. | 5.35297 | 5.28087 | 6.12213 | 6.34928 | 8.31759 | 8.93196 | 11.1359 | 13.7831 |
| 17.5 | 5.46145 | 5.40974 | 6.4215 | 6.65648 | 8.56852 | 9.22375 | 11.4593 | 14.1483 |
| 18. | 5.68115 | 5.65763 | 6.90221 | 7.14195 | 9.03588 | 9.75566 | 12.0451 | 14.8148 |
| 18.5 | 6.08225 | 6.08516 | 7.5738 | 7.83811 | 9.77544 | 10.6001 | 12.9814 | 15.8922 |
| 19. | 6.84088 | 6.86902 | 8.6285 | 8.94488 | 11.0206 | 12.0116 | 14.5759 | 17.7498 |
| 19.5 | 7.88704 | 7.94379 | 9.97567 | 10.3757 | 12.6439 | 13.8682 | 16.6698 | 20.1861 |
| 20. | 8.62116 | 8.7192 | 10.8987 | 11.4209 | 13.7807 | 15.2901 | 18.2004 | 21.9161 |
| 20.5 | 9.04263 | 9.19548 | 11.4224 | 12.0857 | 14.4598 | 16.2572 | 19.1908 | 22.9744 |
| 21. | 9.28037 | 9.49864 | 11.7215 | 12.5222 | 14.8749 | 16.9009 | 19.8316 | 23.6042 |
| 21.5 | 9.40045 | 9.70035 | 11.8833 | 12.8281 | 15.1288 | 17.3104 | 20.2226 | 23.9349 |
| 22. | 9.43665 | 9.85031 | 11.9597 | 13.0839 | 15.3007 | 17.5747 | 20.453 | 24.0762 |
| 22.5 | 9.42063 | 9.98967 | 12.0037 | 13.3402 | 15.4636 | 17.7804 | 20.6133 | 24.1351 |
| 23. | 9.39534 | 10.1514 | 12.0653 | 13.5898 | 15.6487 | 17.9757 | 20.758 | 24.1769 |
| 23.5 | 9.4098 | 10.3931 | 12.2052 | 13.8676 | 15.9006 | 18.2251 | 20.9615 | 24.2889 |
| 24. | 9.54621 | 10.7727 | 12.511 | 14.2703 | 16.3123 | 18.6428 | 21.3539 | 24.6199 |
| 24.5 | 9.95856 | 11.3948 | 13.1326 | 14.9827 | 17.0781 | 19.4536 | 22.1903 | 25.4603 |
| 25. | 11.028 | 12.6739 | 14.5289 | 16.5402 | 18.7909 | 21.3247 | 24.2218 | 27.6602 |
| 25.5 | 14.2848 | 16.3468 | 18.622 | 21.1001 | 23.8594 | 26.9534 | 30.4759 | 34.6399 |
| 26. | 16.4521 | 18.7881 | 21.3349 | 24.1084 | 27.1736 | 30.5875 | 34.4497 | 38.9882 |
| 26.5 | 17.3892 | 19.8491 | 22.5063 | 25.3881 | 28.545 | 32.0334 | 35.9511 | 40.5229 |
| 27. | 17.8523 | 20.3679 | 23.0646 | 25.9709 | 29.1288 | 32.5923 | 36.4549 | 40.9319 |
| 27.5 | 18.0666 | 20.5943 | 23.285 | 26.1657 | 29.273 | 32.6581 | 36.4093 | 40.7288 |
| 28. | 18.1317 | 20.6408 | 23.2947 | 26.1182 | 29.1444 | 32.4212 | 36.0311 | 40.1623 |
| 28.5 | 18.0972 | 20.5667 | 23.1638 | 25.9112 | 28.8392 | 31.9923 | 35.4469 | 39.3768 |
| 29. | 18.0021 | 20.4211 | 22.952 | 25.6157 | 28.4399 | 31.4657 | 34.7634 | 38.493 |
| 29.5 | 17.8819 | 20.2482 | 22.7126 | 25.2941 | 28.0181 | 30.9225 | 34.0717 | 37.6124 |
| 30. | 17.7629 | 20.0803 | 22.4838 | 24.9906 | 27.6241 | 30.4186 | 33.4335 | 36.8029 |
| 30.5 | 17.6565 | 19.9312 | 22.2814 | 24.7229 | 27.2769 | 29.975 | 32.8712 | 36.0884 |
| 31. | 17.5663 | 19.8047 | 22.1095 | 24.4951 | 26.9806 | 29.5949 | 32.3873 | 35.4703 |
| 31.5 | 17.4913 | 19.699 | 21.9652 | 24.3029 | 26.7296 | 29.2713 | 31.9733 | 34.9381 |
| 32. | 17.4271 | 19.6086 | 21.8418 | 24.1382 | 26.5139 | 28.9924 | 31.6149 | 34.4751 |

TABLE 2
1024-324-ConQAM optimisation

| SNR, | capacity, | | | |
|---|---|---|---|---|
| dB | bit/symbol | ε | η | ι |
| 6. | 2.18683 | 0.999999 | 0.999999 | 3.67143 |
| 6.5 | 2.3152 | 0.999999 | 0.999999 | 3.75316 |
| 7. | 2.44312 | 1.10986 | 1.04723 | 3.5599 |
| 7.5 | 2.58114 | 1.14236 | 1.06266 | 3.61984 |
| 8. | 2.72075 | 1.17279 | 1.07911 | 3.66489 |
| 8.5 | 2.86095 | 1.20629 | 1.09982 | 3.68473 |
| 9. | 3.00125 | 1.253 | 1.132 | 3.68824 |
| 9.5 | 3.14202 | 1.33214 | 1.20673 | 3.67313 |
| 10. | 3.28527 | 1.48451 | 1.40041 | 3.69571 |
| 10.5 | 3.43325 | 1.6556 | 1.60503 | 3.83759 |
| 11. | 3.58571 | 1.83437 | 1.8 | 4.01656 |
| 11.5 | 3.74201 | 2.02863 | 2.0085 | 4.2175 |
| 12. | 3.90144 | 2.23361 | 2.22648 | 4.42464 |
| 12.5 | 4.06333 | 2.42847 | 2.43539 | 4.61192 |
| 13. | 4.22719 | 2.59327 | 2.61805 | 4.76366 |
| 13.5 | 4.3927 | 2.72324 | 2.76986 | 4.88359 |
| 14. | 4.55939 | 2.8198 | 2.89082 | 4.97779 |
| 14.5 | 4.72672 | 2.88742 | 2.98414 | 5.05093 |
| 15. | 4.89405 | 2.93223 | 3.05543 | 5.10669 |
| 15.5 | 5.0607 | 2.95962 | 3.11052 | 5.14665 |
| 16. | 5.22595 | 2.97222 | 3.15399 | 5.16895 |
| 16.5 | 5.38914 | 2.97001 | 3.19003 | 5.17036 |
| 17. | 5.54985 | 2.95169 | 3.22479 | 5.15153 |
| 17.5 | 5.70809 | 2.91913 | 3.2677 | 5.12588 |
| 18. | 5.86442 | 2.8822 | 3.32057 | 5.11277 |
| 18.5 | 6.01914 | 2.85299 | 3.3789 | 5.11987 |
| 19. | 6.17196 | 2.83371 | 3.44676 | 5.14581 |
| 19.5 | 6.32249 | 2.82303 | 3.54051 | 5.19689 |
| 20. | 6.47105 | 2.82382 | 3.67801 | 5.28795 |
| 20.5 | 6.61875 | 2.84005 | 3.85076 | 5.42203 |
| 21. | 6.76606 | 2.86666 | 4.02658 | 5.58063 |
| 21.5 | 6.91203 | 2.89404 | 4.18109 | 5.74222 |

| SNR, | | | | | |
|---|---|---|---|---|---|
| dB | λ | μ | ν | ξ | ο |
| 6. | 3.67143 | 3.67143 | 3.67143 | 3.67143 | 3.67143 |
| 6.5 | 3.75316 | 3.75316 | 3.75316 | 3.75316 | 3.75316 |
| 7. | 3.26454 | 3.77922 | 3.52617 | 4.11246 | 5.79963 |
| 7.5 | 3.35041 | 3.84158 | 3.60879 | 4.1811 | 6.18871 |
| 8. | 3.41609 | 3.88532 | 3.68658 | 4.26554 | 6.42906 |
| 8.5 | 3.4527 | 3.90625 | 3.75583 | 4.37587 | 6.57478 |
| 9. | 3.47237 | 3.92303 | 3.84729 | 4.58227 | 6.68033 |
| 9.5 | 3.53019 | 4.07965 | 4.07864 | 4.95942 | 6.8723 |
| 10. | 3.73332 | 4.77697 | 4.68263 | 5.42231 | 7.3882 |
| 10.5 | 3.96001 | 5.47993 | 5.27582 | 5.86231 | 7.98101 |
| 11. | 4.18549 | 5.96956 | 5.8043 | 6.411 | 8.57892 |
| 11.5 | 4.42758 | 6.41493 | 6.31385 | 6.9723 | 9.20648 |
| 12. | 4.68194 | 6.80378 | 6.79682 | 7.56013 | 9.84802 |
| 12.5 | 4.93354 | 7.11108 | 7.22823 | 8.17431 | 10.4747 |
| 13. | 5.16547 | 7.3533 | 7.59411 | 8.77771 | 11.0675 |
| 13.5 | 5.36794 | 7.55937 | 7.89906 | 9.32346 | 11.6171 |
| 14. | 5.53539 | 7.73216 | 8.14519 | 9.78251 | 12.1108 |
| 14.5 | 5.66848 | 7.86897 | 8.33376 | 10.1486 | 12.5378 |
| 15. | 5.77261 | 7.9718 | 8.46825 | 10.4272 | 12.8873 |
| 15.5 | 5.85464 | 8.0432 | 8.55385 | 10.6239 | 13.1467 |
| 16. | 5.92116 | 8.08287 | 8.59621 | 10.7416 | 13.3053 |
| 16.5 | 5.9817 | 8.0931 | 8.60505 | 10.7886 | 13.3656 |
| 17. | 6.05543 | 8.08945 | 8.60308 | 10.7909 | 13.3563 |
| 17.5 | 6.17147 | 8.10982 | 8.63453 | 10.8016 | 13.3403 |
| 18. | 6.32678 | 8.17795 | 8.72575 | 10.8568 | 13.3635 |
| 18.5 | 6.48466 | 8.27731 | 8.86188 | 10.9479 | 13.4213 |
| 19. | 6.62848 | 8.38758 | 9.03172 | 11.0647 | 13.505 |
| 19.5 | 6.76645 | 8.50779 | 9.25551 | 11.2266 | 13.6365 |
| 20. | 6.91682 | 8.65716 | 9.57107 | 11.479 | 13.8637 |
| 20.5 | 7.08988 | 8.85297 | 9.95795 | 11.8242 | 14.1884 |
| 21. | 7.27743 | 9.07518 | 10.3405 | 12.1926 | 14.5375 |
| 21.5 | 7.46401 | 9.29504 | 10.6833 | 12.537 | 14.8618 |

TABLE 3
1024-256-ConQAM optimisation

| SNR, | capacity, | | | |
|---|---|---|---|---|
| dB | bit/symbol | η | ι | λ |
| 6. | 2.18683 | 1. | 3.67143 | 3.67143 |
| 6.5 | 2.3152 | 1. | 3.75317 | 3.75317 |
| 7. | 2.44291 | 1.07813 | 3.55495 | 3.26386 |
| 7.5 | 2.58081 | 1.1018 | 3.61117 | 3.3512 |
| 8. | 2.72028 | 1.12537 | 3.65074 | 3.42007 |
| 8.5 | 2.86034 | 1.15389 | 3.6615 | 3.46285 |
| 9. | 3.0005 | 1.1995 | 3.65039 | 3.49632 |
| 9.5 | 3.14144 | 1.30977 | 3.57085 | 3.65249 |
| 10. | 3.28562 | 1.41742 | 3.63143 | 3.75644 |
| 10.5 | 3.43315 | 1.63399 | 3.84222 | 3.96769 |
| 11. | 3.58566 | 1.81732 | 4.0174 | 4.18785 |
| 11.5 | 3.742 | 2.0179 | 4.21711 | 4.42839 |
| 12. | 3.90144 | 2.22953 | 4.42416 | 4.68206 |
| 12.5 | 4.06332 | 2.43266 | 4.61265 | 4.93352 |
| 13. | 4.22717 | 2.60867 | 4.7667 | 5.16523 |
| 13.5 | 4.39259 | 2.75209 | 4.8892 | 5.36625 |
| 14. | 4.55914 | 2.8627 | 4.98562 | 5.52985 |
| 14.5 | 4.72624 | 2.9437 | 5.06052 | 5.65568 |
| 15. | 4.89323 | 3.00106 | 5.11819 | 5.74886 |
| 15.5 | 5.05943 | 3.04068 | 5.16076 | 5.81569 |
| 16. | 5.22406 | 3.06658 | 5.18682 | 5.86131 |
| 16.5 | 5.38636 | 3.08076 | 5.19248 | 5.89076 |
| 17. | 5.54562 | 3.08481 | 5.17588 | 5.91543 |
| 17.5 | 5.70135 | 3.08144 | 5.14178 | 5.96248 |
| 18. | 5.85365 | 3.07443 | 5.10671 | 6.0787 |
| 18.5 | 6.00361 | 3.06684 | 5.09523 | 6.27457 |
| 19. | 6.15212 | 3.0598 | 5.10396 | 6.46972 |
| 19.5 | 6.29859 | 3.05335 | 5.11221 | 6.61054 |
| 20. | 6.44221 | 3.04772 | 5.11339 | 6.69684 |
| 20.5 | 6.58258 | 3.04275 | 5.11002 | 6.7531 |
| 21. | 6.71821 | 3.03813 | 5.10443 | 6.79736 |
| 21.5 | 6.84666 | 3.03386 | 5.09727 | 6.83242 |
| SNR, | | | | |
| dB | μ | ν | ξ | ο |
| 6. | 3.67143 | 3.67143 | 3.67143 | 3.67143 |
| 6.5 | 3.75316 | 3.75316 | 3.75316 | 3.75316 |
| 7. | 3.52715 | 3.78552 | 5.79489 | 4.10369 |
| 7.5 | 3.61231 | 3.85513 | 6.1867 | 4.16576 |
| 8. | 3.91279 | 3.69566 | 4.24013 | 6.4303 |
| 8.5 | 3.9625 | 3.77692 | 4.33227 | 6.58234 |
| 9. | 4.0477 | 3.90109 | 4.50547 | 6.70615 |
| 9.5 | 4.98365 | 4.29056 | 4.36087 | 7.03732 |
| 10. | 4.62501 | 5.449 | 7.36058 | 4.5906 |
| 10.5 | 5.29203 | 5.59848 | 7.99206 | 5.75489 |
| 11. | 5.98843 | 5.80901 | 6.39597 | 8.58138 |
| 11.5 | 6.41926 | 6.3148 | 6.96795 | 9.20621 |
| 12. | 6.80397 | 6.7966 | 7.55919 | 9.84736 |
| 12.5 | 7.11162 | 7.22882 | 8.17493 | 10.4757 |
| 13. | 7.35591 | 7.59681 | 8.77953 | 11.0716 |
| 13.5 | 7.56348 | 7.90372 | 9.32631 | 11.6244 |
| 14. | 7.73629 | 8.15042 | 9.78555 | 12.1197 |
| 14.5 | 7.8712 | 8.33729 | 10.15 | 12.5453 |
| 15. | 7.9705 | 8.46792 | 10.425 | 12.8906 |
| 15.5 | 8.03643 | 8.54727 | 10.6157 | 13.1428 |
| 16. | 8.06758 | 8.58 | 10.724 | 13.2904 |
| 16.5 | 8.06206 | 8.57168 | 10.7536 | 13.3312 |
| 17. | 8.02678 | 8.53644 | 10.7213 | 13.2839 |
| 17.5 | 7.98806 | 8.50791 | 10.6682 | 13.198 |
| 18. | 7.99989 | 8.54731 | 10.6658 | 13.1577 |
| 18.5 | 8.10209 | 8.69674 | 10.7657 | 13.2235 |
| 19. | 8.23931 | 8.90649 | 10.9184 | 13.3437 |
| 19.5 | 8.35157 | 9.14838 | 11.0896 | 13.4811 |
| 20. | 8.44107 | 9.45452 | 11.3238 | 13.6813 |
| 20.5 | 8.53335 | 9.76673 | 11.601 | 13.9249 |
| 21. | 8.61751 | 10.0095 | 11.8411 | 14.1327 |
| 21.5 | 8.68431 | 10.187 | 12.0292 | 14.2903 |

TABLE 4
16384-3600X1-ConQAM optimisation

| SNR, | capacity, | | | | | | |
|---|---|---|---|---|---|---|---|
| dB | bit/symbol | a₇ | a₁₁ | a₁₅ | a₁₉ | a₂₃ | a₂₇ |
| 8 | 2.72734 | 1.08326 | 1.17456 | 1.0829 | 1.17738 | 1.2761 | 1.17777 |
| 9 | 3.00564 | 0.982229 | 1.14162 | 1.16226 | 1.35865 | 1.33726 | 1.14765 |
| 10 | 3.29065 | 1.36347 | 1.35002 | 0.987438 | 1.09894 | 1.51547 | 1.5265 |
| 11 | 3.59369 | 1.00254 | 1.00511 | 1.00254 | 1.82566 | 1.85079 | 1.82566 |
| 12 | 3.91129 | 0.988968 | 0.978133 | 0.988987 | 2.21285 | 2.21223 | 2.21285 |
| 13 | 4.23805 | 0.997742 | 0.970074 | 0.972196 | 2.54459 | 2.53816 | 2.56468 |
| 14 | 4.57251 | 1.00038 | 0.968317 | 0.967971 | 2.76995 | 2.76865 | 2.83907 |
| 15 | 4.90964 | 1.00181 | 0.98141 | 0.979712 | 2.89731 | 2.90503 | 3.02045 |
| 16 | 5.24694 | 0.999359 | 1.00509 | 1.0057 | 2.96949 | 2.99047 | 3.16142 |
| 17 | 5.58085 | 0.993567 | 1.04771 | 1.05406 | 3.0158 | 3.04478 | 3.30927 |
| 18 | 5.90975 | 0.99281 | 1.16713 | 1.17471 | 3.11108 | 3.12814 | 3.61865 |
| 19 | 6.23777 | 0.998531 | 1.52987 | 1.53185 | 3.48694 | 3.48853 | 4.44814 |
| 20 | 6.57286 | 1.0003 | 2.40996 | 2.40971 | 4.44123 | 4.43778 | 6.16156 |
| 20.5 | 6.74246 | 1.00024 | 2.67444 | 2.67358 | 4.72547 | 4.72129 | 6.64618 |
| 21 | 6.91156 | 1.00018 | 2.8277 | 2.8263 | 4.89046 | 4.88741 | 6.92291 |
| 21.5 | 7.07963 | 0.999872 | 2.91589 | 2.91439 | 4.98435 | 4.98519 | 7.07764 |
| 22 | 7.2464 | 0.999532 | 2.96474 | 2.96403 | 5.03451 | 5.04287 | 7.15641 |
| 23 | 7.57619 | 1.00058 | 3.00273 | 3.01023 | 5.06358 | 5.10819 | 7.18025 |
| 24 | 7.90158 | 1.01319 | 3.01355 | 3.05642 | 5.05301 | 5.20045 | 7.13261 |
| 25 | 8.22388 | 1.08849 | 3.06023 | 3.2467 | 5.1278 | 5.57321 | 7.32594 |
| 26 | 8.54845 | 1.87888 | 3.84986 | 4.92006 | 6.83439 | 8.20486 | 10.0921 |
| 27 | 8.88364 | 2.74514 | 4.75445 | 6.56773 | 8.61233 | 10.554 | 12.6798 |
| 28 | 9.21477 | 2.93823 | 4.95493 | 6.94063 | 9.01191 | 11.0955 | 13.2732 |
| 29 | 9.53771 | 2.99128 | 5.01069 | 7.04314 | 9.12174 | 11.241 | 13.4278 |
| 30 | 9.85018 | 3.0017 | 5.01907 | 7.05691 | 9.12853 | 11.241 | 13.4074 |

| SNR, | | | | | | | | |
|---|---|---|---|---|---|---|---|---|
| dB | a₃₁ | a₃₅ | a₃₉ | a₄₁ | a₄₃ | a₄₅ | a₄₇ | a₄₈ |
| 8 | 1.08589 | 4.24341 | 3.85714 | 3.67473 | 3.64099 | 3.83402 | 3.88403 | 4.35029 |
| 9 | 1.16834 | 3.92034 | 4.07512 | 3.71438 | 3.68267 | 3.60105 | 3.62884 | 3.97705 |
| 10 | 1.113 | 4.50629 | 3.73974 | 3.82721 | 3.87097 | 4.70967 | 4.60105 | 5.7432 |
| 11 | 1.80242 | 3.9835 | 4.11507 | 4.24428 | 4.2481 | 4.11489 | 4.11524 | 5.9971 |
| 12 | 2.21342 | 4.34853 | 4.50795 | 4.68889 | 4.68203 | 4.50114 | 4.51416 | 7.03118 |
| 13 | 2.57061 | 4.67585 | 4.68891 | 5.06998 | 5.09735 | 5.0659 | 5.04104 | 7.16914 |
| 14 | 2.84052 | 4.89629 | 4.88589 | 5.43865 | 5.43643 | 5.44085 | 5.44285 | 7.65962 |
| 15 | 3.01374 | 5.07636 | 5.03211 | 5.67103 | 5.65867 | 5.72613 | 5.73925 | 7.91885 |
| 16 | 3.14014 | 5.21564 | 5.14796 | 5.8143 | 5.83863 | 5.98356 | 5.98017 | 8.10862 |
| 17 | 3.27448 | 5.32341 | 5.25068 | 6.03856 | 6.0607 | 6.26726 | 6.24609 | 8.27665 |
| 18 | 3.58941 | 5.55785 | 5.52155 | 6.63467 | 6.66877 | 6.89293 | 6.8588 | 8.80054 |
| 19 | 4.43702 | 6.4168 | 6.4299 | 8.03497 | 8.07196 | 8.34123 | 8.29899 | 10.3531 |
| 20 | 6.16015 | 8.33249 | 8.40046 | 10.5214 | 10.5542 | 10.9808 | 10.9341 | 13.3284 |
| 20.5 | 6.6538 | 8.87435 | 8.98843 | 11.2013 | 11.2218 | 11.7823 | 11.745 | 14.1555 |
| 21 | 6.94555 | 9.18017 | 9.35197 | 11.5839 | 11.5923 | 12.2921 | 12.2686 | 14.6401 |
| 21.5 | 7.1217 | 9.34546 | 9.58355 | 11.7965 | 11.7956 | 12.6231 | 12.615 | 14.9202 |
| 22 | 7.23072 | 9.41892 | 9.73946 | 11.9032 | 11.8956 | 12.8575 | 12.867 | 15.0767 |
| 23 | 7.36876 | 9.40375 | 9.98988 | 11.98 | 11.9717 | 13.2927 | 13.3326 | 15.305 |
| 24 | 7.56537 | 9.39726 | 10.3797 | 12.1705 | 12.1746 | 13.7691 | 13.8508 | 15.6587 |
| 25 | 8.23272 | 9.89876 | 11.3031 | 13.0044 | 13.0364 | 14.749 | 14.9227 | 16.6623 |
| 26 | 11.7679 | 13.7222 | 15.6944 | 17.8274 | 17.9175 | 20.0681 | 20.4322 | 22.5464 |
| 27 | 14.8077 | 17.096 | 19.4907 | 21.9665 | 22.2007 | 24.5917 | 25.3403 | 27.6548 |
| 28 | 15.5156 | 17.8758 | 20.3611 | 22.7932 | 23.2969 | 25.5311 | 26.7969 | 28.9394 |
| 29 | 15.6881 | 18.0443 | 20.5118 | 22.8316 | 23.661 | 25.7087 | 27.3692 | 29.3646 |
| 30 | 15.6374 | 17.9443 | 20.3412 | 22.6044 | 23.8812 | 25.7267 | 27.5483 | 29.4623 |

| SNR, | | | | | | | |
|---|---|---|---|---|---|---|---|
| dB | a₄₉ | a₅₀ | a₅₁ | a₅₂ | a₅₃ | a₅₄ | a₅₅ |
| 8 | 4.28822 | 4.20413 | 4.24074 | 3.83578 | 3.85273 | 3.90168 | 3.88836 |
| 9 | 3.9673 | 3.91436 | 3.91141 | 4.08427 | 4.05113 | 4.11133 | 4.16609 |
| 10 | 5.85407 | 5.84912 | 5.76955 | 3.95915 | 3.98991 | 3.92099 | 3.89438 |
| 11 | 6.24694 | 6.46584 | 6.23237 | 5.83998 | 5.99979 | 5.87355 | 5.7212 |
| 12 | 6.83203 | 7.15562 | 7.38259 | 6.89608 | 6.78302 | 6.59557 | 6.69079 |
| 13 | 7.21012 | 7.37622 | 7.30865 | 7.43985 | 7.53103 | 7.37421 | 7.30717 |
| 14 | 7.59812 | 7.76499 | 7.81957 | 7.99376 | 7.95655 | 7.76648 | 7.82095 |
| 15 | 7.89844 | 7.91203 | 7.93365 | 8.36338 | 8.33635 | 8.28673 | 8.31156 |
| 16 | 8.10064 | 8.06785 | 8.0755 | 8.59152 | 8.57396 | 8.60704 | 8.62372 |
| 17 | 8.28007 | 8.22263 | 8.21948 | 8.77079 | 8.77535 | 8.88401 | 8.88052 |
| 18 | 8.81053 | 8.73717 | 8.7288 | 9.33206 | 9.35494 | 9.5322 | 9.51004 |
| 19 | 10.3667 | 10.282 | 10.2713 | 11.0288 | 11.0679 | 11.3229 | 11.2841 |
| 20 | 13.3405 | 13.2662 | 13.2569 | 14.381 | 14.4358 | 14.7839 | 14.7275 |
| 20.5 | 14.1609 | 14.123 | 14.1187 | 15.5026 | 15.5577 | 15.9322 | 15.8718 |
| 21 | 14.6389 | 14.6435 | 14.6446 | 16.2592 | 16.3071 | 16.7258 | 16.6668 |
| 21.5 | 14.9158 | 14.9643 | 14.9682 | 16.7283 | 16.7609 | 17.2609 | 17.2117 |
| 22 | 15.0726 | 15.1678 | 15.1717 | 17.0093 | 17.0258 | 17.6162 | 17.5819 |
| 23 | 15.3056 | 15.4945 | 15.4939 | 17.3771 | 17.3717 | 18.1007 | 18.1022 |
| 24 | 15.6632 | 15.9896 | 15.9832 | 17.7991 | 17.7847 | 18.7147 | 18.7527 |
| 25 | 16.665 | 17.2263 | 17.2198 | 18.9685 | 18.9614 | 20.22 | 20.2899 |
| 26 | 22.5465 | 23.5301 | 23.5263 | 25.6417 | 25.6513 | 27.4646 | 27.6131 |
| 27 | 27.6523 | 29.2516 | 29.2586 | 31.563 | 31.6214 | 33.8621 | 34.1681 |
| 28 | 28.9411 | 30.9083 | 30.9464 | 33.1576 | 33.3333 | 35.5279 | 36.1236 |
| 29 | 29.3913 | 31.4133 | 31.5451 | 33.5931 | 34.0234 | 35.9991 | 37.0393 |
| 30 | 29.5807 | 31.4542 | 31.846 | 33.6305 | 34.5353 | 36.2518 | 37.7261 |

| SNR, | | | | | | | | |
|---|---|---|---|---|---|---|---|---|
| dB | a₅₆ | a₅₇ | a₅₈ | a₅₉ | a₆₀ | a₆₁ | a₆₂ | a₆₃ |
| 8 | 4.34682 | 4.28563 | 4.20169 | 4.23763 | 8.19018 | 5.26038 | 5.34614 | 7.02518 |
| 9 | 6.14147 | 5.09697 | 4.99794 | 6.30002 | 8.39078 | 4.82575 | 4.97647 | 7.09509 |
| 10 | 3.74948 | 3.76999 | 3.82647 | 3.80288 | 6.88469 | 6.68155 | 7.415 | 9.05164 |
| 11 | 5.99711 | 6.24694 | 6.46584 | 6.23237 | 8.5469 | 7.73453 | 7.79394 | 10.4136 |
| 12 | 7.03008 | 6.83118 | 7.15462 | 7.38148 | 8.81157 | 8.68814 | 11.6936 | 9.86896 |
| 13 | 8.59326 | 9.5516 | 9.05841 | 8.51591 | 8.59365 | 9.56237 | 10.9895 | 13.2649 |
| 14 | 9.59232 | 10.5562 | 10.0475 | 9.52335 | 9.59152 | 10.5562 | 12.012 | 14.3922 |
| 15 | 10.0381 | 10.1583 | 10.5116 | 10.3444 | 11.5478 | 11.9879 | 13.1184 | 15.2668 |
| 16 | 10.4708 | 10.4787 | 10.927 | 10.8691 | 12.3309 | 12.795 | 14.0941 | 16.239 |
| 17 | 10.7818 | 10.7403 | 11.2236 | 11.2669 | 12.8882 | 13.376 | 14.9513 | 17.14 |
| 18 | 11.4593 | 11.3996 | 11.9076 | 12.0196 | 13.7808 | 14.281 | 16.1227 | 18.4582 |
| 19 | 13.3913 | 13.3152 | 13.9132 | 14.09 | 16.0756 | 16.6416 | 18.8177 | 21.487 |
| 20 | 17.1626 | 17.0632 | 17.8556 | 18.1302 | 20.4966 | 21.2244 | 23.9171 | 27.1936 |
| 20.5 | 18.3139 | 18.2112 | 19.1008 | 19.4278 | 21.8308 | 22.6361 | 25.435 | 28.8486 |
| 21 | 19.0525 | 18.9613 | 19.9792 | 20.3504 | 22.7014 | 23.5938 | 26.4099 | 29.8691 |
| 21.5 | 19.501 | 19.4439 | 20.6466 | 21.0467 | 23.295 | 24.2965 | 27.0688 | 30.515 |
| 22 | 19.7702 | 19.7582 | 21.144 | 21.5839 | 23.7177 | 24.8712 | 27.5569 | 30.9526 |
| 23 | 20.1218 | 20.1991 | 21.7749 | 22.3446 | 24.3067 | 25.8275 | 28.3342 | 31.5766 |
| 24 | 20.5947 | 20.7549 | 22.4075 | 23.0848 | 24.9685 | 26.7269 | 29.1458 | 32.2362 |
| 25 | 22.0128 | 22.2833 | 23.9777 | 24.8326 | 26.696 | 28.63 | 31.0714 | 34.1255 |
| 26 | 29.6918 | 30.2168 | 32.3122 | 33.6901 | 35.9776 | 38.5213 | 41.6079 | 45.4084 |
| 27 | 36.4731 | 37.3906 | 39.7349 | 41.7214 | 44.3397 | 47.3538 | 50.9109 | 55.2202 |
| 28 | 38.2894 | 39.679 | 41.8881 | 44.1463 | 46.7932 | 49.8212 | 53.3191 | 57.4886 |
| 29 | 38.9822 | 40.7375 | 42.8393 | 45.1489 | 47.7461 | 50.6657 | 53.9826 | 57.8808 |
| 30 | 39.5015 | 41.3748 | 43.4449 | 45.7167 | 48.2201 | 50.9906 | 54.0961 | 57.7009 |

TABLE 5
16384-1156Y1-ConQAM optimisation

| SNR, | capacity, | | | | | | | |
|---|---|---|---|---|---|---|---|---|
| dB | bit/symbol | ,a₁₅ | a₂₃ | a₃₁ | a₂₀ | a₄₃ | a₄₇ | a₅₁ |
| 9 | 3.00505 | 1.17244 | 1.37616 | 1.17162 | 4.0637 | 3.71755 | 3.67503 | 4.05482 |
| 10 | 3.29 | 1.09028 | 1.54707 | 1.40692 | 3.85703 | 3.87754 | 3.79878 | 4.74328 |
| 11 | 3.59224 | 1.00723 | 1.85421 | 1.81572 | 4.05176 | 4.25071 | 4.15309 | 6.04781 |
| 12 | 3.90958 | 0.985938 | 2.2154 | 2.21038 | 4.39927 | 4.69159 | 4.58682 | 6.79082 |
| 13 | 4.23701 | 0.971837 | 2.54249 | 2.56946 | 4.68342 | 5.10851 | 5.04167 | 7.25687 |
| 14 | 4.57165 | 0.968052 | 2.76557 | 2.83471 | 4.88738 | 5.43511 | 5.42641 | 7.63583 |
| 15 | 4.90944 | 0.979609 | 2.89812 | 3.01398 | 5.04865 | 5.66609 | 5.71968 | 7.90678 |
| 16 | 5.2467 | 1.00592 | 2.98059 | 3.15328 | 5.18179 | 5.85697 | 5.97365 | 8.09688 |
| 16.5 | 5.41419 | 1.02638 | 3.01145 | 3.22348 | 5.24073 | 5.96162 | 6.10778 | 8.18308 |
| 17. | 5.58046 | 1.05562 | 3.03945 | 3.30777 | 5.30327 | 6.10058 | 6.27525 | 8.2895 |
| 17.5 | 5.74543 | 1.1014 | 3.07314 | 3.42931 | 5.39479 | 6.32396 | 6.52451 | 8.47161 |
| 18. | 5.90944 | 1.17664 | 3.1314 | 3.62187 | 5.56271 | 6.6917 | 6.91189 | 8.81118 |
| 18.5 | 6.07322 | 1.30101 | 3.24697 | 3.92496 | 5.86555 | 7.23196 | 7.47146 | 9.37517 |
| 19. | 6.2375 | 1.53201 | 3.49039 | 4.44567 | 6.42822 | 8.05608 | 8.32794 | 10.3187 |
| 19.5 | 6.40371 | 1.97226 | 3.9685 | 5.33646 | 7.42744 | 9.36179 | 9.68755 | 11.8724 |
| 20. | 6.5725 | 2.41119 | 4.44093 | 6.16286 | 8.3692 | 10.5416 | 10.9486 | 13.2913 |
| 21 | 6.91077 | 2.8304 | 4.89262 | 6.94027 | 9.27099 | 11.6115 | 12.2255 | 14.6261 |
| 22 | 7.24415 | 2.9686 | 5.04427 | 7.20146 | 9.57572 | 11.9287 | 12.7037 | 15.0511 |
| 23 | 7.56973 | 3.00852 | 5.08794 | 7.27118 | 9.63242 | 11.932 | 12.9216 | 15.1246 |
| 24 | 7.88612 | 3.0159 | 5.08871 | 7.25619 | 9.56683 | 11.839 | 13.2425 | 15.2638 |

| SNR, | | | | | | | | | |
|---|---|---|---|---|---|---|---|---|---|
| dB | a₅₁ | a₅₅ | a₅₇ | a₅₈ | a₅₉ | a₆₀ | a₆₁ | a₆₂ | a₆₃ |
| 9 | 4.09504 | 4.03633 | 5.14662 | 5.18988 | 5.1524 | 6.63509 | 6.2204 | 6.88263 | 8.47642 |
| 10 | 4.83038 | 4.7485 | 5.81835 | 5.88934 | 5.87154 | 7.23981 | 6.73174 | 7.14332 | 9.15544 |
| 11 | 5.93253 | 5.8306 | 6.47978 | 6.62936 | 6.51681 | 7.73328 | 7.65533 | 8.55753 | 10.3345 |
| 12 | 6.80614 | 6.68312 | 7.43947 | 7.6839 | 7.53162 | 8.72256 | 8.7904 | 9.8073 | 11.6447 |
| 13 | 7.58531 | 7.36174 | 8.53837 | 8.85558 | 8.67025 | 9.79722 | 9.97014 | 10.9774 | 12.981 |
| 14 | 7.98312 | 7.88643 | 9.47623 | 9.83016 | 9.6435 | 10.7138 | 11.0303 | 12.0988 | 14.1873 |
| 15 | 8.33533 | 8.29093 | 10.0731 | 10.4886 | 10.3469 | 11.5667 | 11.9895 | 13.1326 | 15.258 |
| 16 | 8.58012 | 8.60485 | 10.4794 | 10.9241 | 10.8703 | 12.3267 | 12.7943 | 14.093 | 16.2409 |
| 16.5 | 8.6834 | 8.74125 | 10.6397 | 11.0922 | 11.0848 | 12.638 | 13.1175 | 14.5496 | 16.7121 |
| 17. | 8.80917 | 8.897 | 10.8081 | 11.2646 | 11.2977 | 12.9358 | 13.4193 | 14.9988 | 17.1955 |
| 17.5 | 9.02159 | 9.13679 | 11.0572 | 11.518 | 11.5827 | 13.2987 | 13.7824 | 15.5033 | 17.7596 |
| 18. | 9.40841 | 9.55106 | 11.4889 | 11.9627 | 12.052 | 13.8469 | 14.3351 | 16.1907 | 18.5343 |
| 18.5 | 10.0413 | 10.215 | 12.1916 | 12.6944 | 12.8067 | 14.6943 | 15.1991 | 17.1982 | 19.6674 |
| 19. | 11.0905 | 11.304 | 13.3704 | 13.9294 | 14.0689 | 16.0934 | 16.6369 | 18.8273 | 21.4974 |
| 19.5 | 12.8033 | 13.0703 | 15.3153 | 15.9698 | 16.1454 | 18.3886 | 19.0043 | 21.478 | 24.4737 |
| 20. | 14.4268 | 14.7544 | 17.1151 | 17.8837 | 18.1028 | 20.5081 | 21.2011 | 23.9143 | 27.1903 |
| 21 | 16.2221 | 16.6653 | 18.9593 | 20.0089 | 20.33 | 22.6929 | 23.5537 | 26.3866 | 29.8451 |
| 22 | 16.911 | 17.4823 | 19.6555 | 21.049 | 21.4943 | 23.6202 | 24.7917 | 27.4688 | 30.8594 |
| 23 | 17.091 | 17.7449 | 19.8366 | 21.4461 | 22.0109 | 23.9701 | 25.5245 | 28.0138 | 31.2312 |
| 24 | 17.2368 | 17.9987 | 19.9887 | 21.7134 | 22.3315 | 24.223 | 25.9905 | 28.3723 | 31.3974 |

TABLE 6
16384-576Z1-ConQAM optimisation

| SNR, | capacity, | | | | | |
|---|---|---|---|---|---|---|
| dB | bit/symbol | a₃₁ | a₃₉ | a₄₇ | a₅₁ | a₅₅ |
| 9 | 3.00282 | 1.20815 | 3.66321 | 3.48922 | 4.06001 | 3.93793 |
| 10 | 3.28893 | 1.46327 | 3.71204 | 3.75229 | 4.8855 | 4.78853 |
| 11 | 3.59166 | 1.82872 | 4.03512 | 4.19215 | 5.98792 | 5.86887 |
| 12 | 3.90889 | 2.22549 | 4.42188 | 4.6733 | 6.79339 | 6.78673 |
| 13 | 4.23637 | 2.5965 | 4.75283 | 5.15015 | 7.35846 | 7.5361 |
| 14 | 4.57094 | 2.85525 | 4.97837 | 5.51628 | 7.76557 | 8.07594 |
| 15 | 4.90839 | 2.99506 | 5.11379 | 5.73216 | 7.98869 | 8.39613 |
| 16 | 5.24465 | 3.0615 | 5.18215 | 5.84477 | 8.06389 | 8.53331 |
| 17 | 5.57585 | 3.0835 | 5.1805 | 5.89647 | 8.02344 | 8.51772 |
| 18 | 5.89777 | 3.07678 | 5.11662 | 5.99775 | 7.95729 | 8.48117 |

| SNR, | | | | | | |
|---|---|---|---|---|---|---|
| dB | a₅₇ | a₅₉ | a₆₀ | a₆₁ | a₆₂ | a₆₃ |
| 9 | 4.60221 | 4.68413 | 6.55298 | 5.83653 | 6.14395 | 7.91429 |
| 10 | 5.52817 | 5.62956 | 7.24859 | 6.54936 | 6.77969 | 8.92141 |
| 11 | 6.57899 | 6.5983 | 7.6319 | 7.5603 | 8.50299 | 10.2788 |
| 12 | 7.60834 | 7.70666 | 8.7679 | 8.80093 | 9.81737 | 11.6886 |
| 13 | 8.71664 | 8.90984 | 10.0309 | 10.1179 | 11.073 | 13.135 |
| 14 | 9.63943 | 9.90295 | 10.9888 | 11.2412 | 12.3 | 14.4068 |
| 15 | 10.1688 | 10.5213 | 11.7291 | 12.1343 | 13.2988 | 15.4265 |
| 16 | 10.4211 | 10.8378 | 12.2632 | 12.7384 | 14.0452 | 16.1879 |
| 17 | 10.4476 | 10.8949 | 12.5099 | 12.9792 | 14.5267 | 16.6676 |
| 18 | 10.3831 | 10.8263 | 12.55 | 12.9791 | 14.7164 | 16.8766 |

TABLE 7
4096-1936-ConQAM optimisation

| SNR, | capacity, | | | | | |
|---|---|---|---|---|---|---|
| dB | bit/symbol | a₃ | a₅ | a₇ | a₉ | a₁₁ |
| 15 | 4.90495 | 1.0019 | 0.981787 | 0.979994 | 2.89835 | 2.90673 |
| 16 | 5.24117 | 0.999239 | 1.00572 | 1.00644 | 2.97039 | 2.99225 |
| 17 | 5.57302 | 0.993195 | 1.05046 | 1.05718 | 3.01758 | 3.04704 |
| 18 | 5.89853 | 0.993115 | 1.18064 | 1.18796 | 3.12332 | 3.13913 |
| 19 | 6.22281 | 0.998856 | 1.58041 | 1.58204 | 3.54233 | 3.5432 |
| 20 | 6.55432 | 1.00031 | 2.45767 | 2.45732 | 4.49277 | 4.48905 |
| 21 | 5.88867 | 1.00013 | 2.84345 | 2.84198 | 4.90755 | 4.90488 |
| 22 | 7.21887 | 0.99955 | 2.97021 | 2.96977 | 5.04023 | 5.05041 |
| 23 | 7.54326 | 1.00105 | 3.00437 | 3.01376 | 5.06375 | 5.11522 |
| 24 | 7.86216 | 1.017 | 3.01526 | 3.0672 | 5.05255 | 5.22327 |
| 25 | 8.17739 | 1.11523 | 3.08108 | 3.3117 | 5.17505 | 5.69625 |
| 26 | 8.49579 | 2.14367 | 4.12843 | 5.42402 | 7.38321 | 8.92187 |
| 27 | 8.82209 | 2.7999 | 4.81164 | 6.67446 | 8.72769 | 10.7115 |
| 28 | 9.14123 | 2.95726 | 4.97574 | 6.97906 | 9.05496 | 11.1546 |
| 29 | 9.44901 | 2.99673 | 5.01652 | 7.05392 | 9.13353 | 11.2564 |
| 30 | 9.7421 | 3.00284 | 5.01969 | 7.05719 | 9.12628 | 11.235 |

| SNR, | | | | | | | | |
|---|---|---|---|---|---|---|---|---|
| dB | a₁₃ | a₁₅ | a₁₇ | a₁₉ | a₂₀ | a₂₁ | a₂₂ | a₂₃ |
| 15 | 3.02225 | 3.01494 | 5.08076 | 5.03356 | 5.67044 | 5.65747 | 5.72994 | 5.74285 |
| 16 | 3.16451 | 3.14227 | 5.21975 | 5.14985 | 5.83439 | 5.84175 | 5.99236 | 5.9862 |
| 17 | 3.31791 | 3.28217 | 5.3298 | 5.25658 | 6.05077 | 6.07594 | 6.28818 | 6.26399 |
| 18 | 3.65257 | 3.62438 | 5.58951 | 5.55678 | 6.70104 | 6.73686 | 6.96445 | 6.92826 |
| 19 | 4.55644 | 4.5463 | 6.53632 | 6.55354 | 8.20052 | 8.23862 | 8.5192 | 8.47487 |
| 20 | 6.25041 | 6.25017 | 8.43272 | 8.5083 | 10.6489 | 10.6808 | 11.133 | 11.0856 |
| 21 | 6.95166 | 6.97747 | 9.2123 | 9.39536 | 11.6271 | 11.6337 | 12.3593 | 12.3375 |
| 22 | 7.16504 | 7.24636 | 9.42659 | 9.76608 | 11.9208 | 11.9114 | 12.9037 | 12.9185 |
| 23 | 7.17733 | 7.38544 | 9.40023 | 10.0269 | 11.9982 | 11.9905 | 13.3569 | 13.4037 |
| 24 | 7.13205 | 7.6133 | 9.42068 | 10.4667 | 12.2368 | 12.2444 | 13.8638 | 13.9611 |
| 25 | 7.43151 | 8.42829 | 10.0856 | 11.546 | 13.2608 | 13.3017 | 15.0343 | 15.2381 |
| 26 | 10.8889 | 12.6971 | 14.7606 | 16.8635 | 19.1225 | 19.2345 | 21.4994 | 21.9342 |
| 27 | 12.8544 | 15.0191 | 17.3341 | 19.7659 | 22.2522 | 22.5415 | 24.9132 | 25.7873 |
| 28 | 13.3408 | 15.5982 | 17.9698 | 20.4678 | 22.8793 | 23.4812 | 25.676 | 27.1019 |
| 29 | 13.4439 | 15.7045 | 18.0575 | 20.5182 | 22.8224 | 23.7987 | 25.7926 | 27.5548 |
| 30 | 13.3945 | 15.6146 | 17.9073 | 20.2851 | 22.5684 | 24.0358 | 25.8584 | 27.7343 |

| SNR, | | | | | | | | |
|---|---|---|---|---|---|---|---|---|
| dB | a₂₁ | a₂₅ | a₂₆ | a₂₇ | a₂₈ | a₂₉ | a₃₀ | a₃₁ |
| 15 | 7.90711 | 7.91051 | 8.36321 | 8.31918 | 10.0454 | 10.4799 | 11.8486 | 14.0828 |
| 16 | 8.10969 | 8.06644 | 8.58827 | 8.6393 | 10.4584 | 10.9593 | 12.6437 | 14.9412 |
| 17 | 8.29304 | 8.23063 | 8.78897 | 8.91366 | 10.7834 | 11.3006 | 13.2176 | 15.6154 |
| 18 | 8.8771 | 8.80164 | 9.42193 | 9.61266 | 11.5274 | 12.0797 | 14.1686 | 16.707 |
| 19 | 10.5624 | 10.477 | 11.2739 | 11.5465 | 13.6178 | 14.2955 | 16.6735 | 19.5585 |
| 20 | 13.4963 | 13.4274 | 14.621 | 14.991 | 17.3458 | 18.2756 | 21.1144 | 24.5958 |
| 21 | 14.7014 | 14.7169 | 16.381 | 16.8416 | 19.1255 | 20.3853 | 23.246 | 26.8603 |
| 22 | 15.1071 | 15.2195 | 17.0712 | 17.7035 | 19.8576 | 21.5521 | 24.2719 | 27.7864 |
| 23 | 15.353 | 15.5667 | 17.4421 | 18.2235 | 20.2774 | 22.2244 | 24.8456 | 28.1842 |
| 24 | 15.7539 | 16.1265 | 17.9183 | 18.9475 | 20.8766 | 22.9374 | 25.4905 | 28.6688 |
| 25 | 16.982 | 17.61 | 19.3601 | 20.7472 | 22.6595 | 24.8397 | 27.4358 | 30.6053 |
| 26 | 24.1543 | 25.2817 | 27.5135 | 29.5887 | 32.1358 | 35.0629 | 38.4868 | 42.6153 |
| 27 | 28.0822 | 29.8311 | 32.181 | 34.6768 | 37.5333 | 40.7773 | 44.5033 | 48.9295 |
| 28 | 29.2128 | 31.284 | 33.6299 | 36.2046 | 39.0672 | 42.262 | 45.8736 | 50.1044 |
| 29 | 29.5715 | 31.713 | 34.0406 | 36.5701 | 39.3323 | 42.3689 | 45.756 | 49.6736 |
| 30 | 29.7356 | 31.8646 | 34.1395 | 36.5775 | 39.2033 | 42.0546 | 45.1989 | 48.794 |

TABLE 8
4096-NUQAM optimisation

| SNR, | capacity, | | | | |
|---|---|---|---|---|---|
| dB | bit/symbol | a₁ | a₂ | a₃ | a₄ |
| 15 | 4.90495 | 1.00025 | 1.00217 | 1.00189 | 0.981791 |
| 16 | 5.24117 | 1.00002 | 0.999256 | 0.999228 | 1.0057 |
| 17 | 5.57302 | 1.00091 | 0.994102 | 0.993176 | 1.05044 |
| 18. | 5.89853 | 1.00112 | 0.994224 | 0.993105 | 1.18067 |
| 19 | 6.22281 | 1.00018 | 0.999045 | 0.998875 | 1.58047 |
| 20. | 6.55432 | 0.999898 | 1.00023 | 1.00027 | 2.45754 |
| 21 | 6.88866 | 1.02897 | 1.03482 | 1.02912 | 2.94686 |
| 22 | 7.21887 | 0.999913 | 0.999436 | 0.999461 | 2.96989 |
| 23 | 7.54326 | 1.00002 | 1.0011 | 1.00109 | 3.00452 |
| 24 | 7.86216 | 0.999906 | 1.0169 | 1.01693 | 3.01502 |
| 25. | 8.17739 | 0.999838 | 1.11494 | 1.11504 | 3.08058 |

| SNR, | | | | | | |
|---|---|---|---|---|---|---|
| dB | a₅ | a₆ | a₇ | a₈ | a₉ | a₁₀ |
| 15 | 0.98205 | 0.980253 | 0.979997 | 2.8978 | 2.8997 | 2.90807 |
| 16 | 1.00572 | 1.00645 | 1.00642 | 2.97104 | 2.96973 | 2.99159 |
| 17 | 1.05136 | 1.05808 | 1.05716 | 3.02091 | 3.01694 | 3.04634 |
| 18. | 1.18186 | 1.18919 | 1.188 | 3.12632 | 3.12378 | 3.13956 |
| 19 | 1.58072 | 1.58234 | 1.5821 | 3.54278 | 3.54265 | 3.54352 |
| 20. | 2.4575 | 2.45715 | 2.45719 | 4.49233 | 4.49267 | 4.48895 |
| 21 | 2.94643 | 2.94524 | 2.94558 | 5.08612 | 5.08514 | 5.08168 |
| 22 | 2.9699 | 2.96945 | 2.96944 | 5.03964 | 5.03973 | 5.04991 |
| 23 | 3.00447 | 3.01386 | 3.01391 | 5.06382 | 5.06412 | 5.11559 |
| 24 | 3.01503 | 3.06694 | 3.06694 | 5.05211 | 5.05215 | 5.22285 |
| 25. | 3.08065 | 3.31113 | 3.31105 | 5.17424 | 5.17417 | 5.69517 |

| SNR, | | | | | |
|---|---|---|---|---|---|
| dB | a₁₁ | a₁₂ | a₁₃ | a₁₄ | a₁₅ |
| 15 | 2.90618 | 3.02177 | 3.02353 | 3.01624 | 3.01446 |
| 16 | 2.99291 | 3.16515 | 3.16384 | 3.14159 | 3.14291 |
| 17 | 3.05048 | 3.32173 | 3.31681 | 3.28108 | 3.28596 |
| 18. | 3.14219 | 3.65682 | 3.6522 | 3.62401 | 3.62858 |
| 19 | 3.54365 | 4.55771 | 4.55617 | 4.54606 | 4.54756 |
| 20. | 4.48861 | 6.25005 | 6.25004 | 6.2498 | 6.24981 |
| 21 | 5.08251 | 7.20878 | 7.20945 | 7.23626 | 7.2356 |
| 22 | 5.04982 | 7.16462 | 7.1639 | 7.24522 | 7.24593 |
| 23 | 5.11529 | 7.17823 | 7.17707 | 7.3851 | 7.38641 |
| 24 | 5.22281 | 7.13149 | 7.1314 | 7.61255 | 7.61275 |
| 25. | 5.69526 | 7.43018 | 7.43031 | 8.42699 | 8.42655 |

| SNR, | | | | |
|---|---|---|---|---|
| dB | a₁₆ | a₁₇ | a₁₈ | a₁₉ |
| 15 | 5.08463 | 5.07832 | 5.03134 | 5.03718 |
| 16 | 5.21709 | 5.2224 | 5.1522 | 5.14751 |
| 17 | 5.32652 | 5.33785 | 5.26356 | 5.25429 |
| 18. | 5.58965 | 5.5955 | 5.56223 | 5.55736 |
| 19 | 6.53838 | 6.53567 | 6.55303 | 6.55547 |
| 20. | 8.43572 | 8.42874 | 8.50443 | 8.51112 |
| 21 | 9.55615 | 9.55279 | 9.74299 | 9.74676 |
| 22 | 9.42415 | 9.42698 | 9.76677 | 9.76324 |
| 23 | 9.39919 | 9.40213 | 10.0302 | 10.0243 |
| 24 | 9.41998 | 9.41978 | 10.4669 | 10.4648 |
| 25. | 10.0843 | 10.0833 | 11.5416 | 11.5463 |

| SNR, | | | | | | |
|---|---|---|---|---|---|---|
| dB | a₂₀ | a₂₁ | a₂₂ | a₂₃ | a₂₄ | a₂₅ |
| 15 | 5.6723 | 5.6571 | 5.72967 | 5.74461 | 7.90774 | 7.91203 |
| 16 | 5.83332 | 5.84277 | 5.99322 | 5.98526 | 8.11011 | 8.06606 |
| 17 | 6.05081 | 6.08077 | 6.29245 | 6.26459 | 8.29754 | 8.23335 |
| 18. | 6.70394 | 6.7409 | 6.96831 | 6.93151 | 8.8821 | 8.80605 |
| 19 | 8.20122 | 8.23981 | 8.52043 | 8.47552 | 10.5637 | 10.4782 |
| 20. | 10.6476 | 10.681 | 11.1332 | 11.0839 | 13.4957 | 13.4265 |
| 21 | 12.0598 | 12.0671 | 12.8203 | 12.797 | 15.2488 | 15.2649 |
| 22 | 11.9199 | 11.9098 | 12.9018 | 12.9175 | 15.1053 | 15.2179 |
| 23 | 11.9993 | 11.9904 | 13.3572 | 13.4044 | 15.3535 | 15.5674 |
| 24 | 12.2359 | 12.2431 | 13.8626 | 13.9599 | 15.7525 | 16.1251 |
| 25. | 13.2581 | 13.3 | 15.0318 | 15.2358 | 16.9793 | 17.6073 |

| SNR, | | | | | | |
|---|---|---|---|---|---|---|
| dB | a₂₆ | a₂₇ | a₂₈ | a₂₉ | a₃₀ | a₃₁ |
| 15 | 8.36488 | 8.31975 | 10.0465 | 10.481 | 11.8499 | 14.0844 |
| 16 | 8.58772 | 8.6398 | 10.4584 | 10.9595 | 12.6438 | 14.9414 |
| 17 | 8.7914 | 8.91849 | 10.7878 | 11.306 | 13.2234 | 15.6224 |
| 18. | 9.42648 | 9.618 | 11.5335 | 12.0863 | 14.1762 | 16.716 |
| 19 | 11.275 | 11.5479 | 13.6193 | 14.2971 | 16.6753 | 19.5606 |
| 20. | 14.6195 | 14.9901 | 17.3446 | 18.2747 | 21.1131 | 24.5943 |
| 21 | 16.9914 | 17.4696 | 19.838 | 21.1462 | 24.1129 | 27.8612 |
| 22 | 17.0694 | 17.7017 | 19.8554 | 21.5498 | 24.2693 | 27.7834 |
| 23 | 17.4428 | 18.2243 | 20.2783 | 22.2254 | 24.8467 | 28.1854 |
| 24 | 17.9167 | 18.9459 | 20.8748 | 22.9355 | 25.4883 | 28.6663 |
| 25. | 19.357 | 20.744 | 22.6559 | 24.8357 | 27.4313 | 30.6004 |

TABLE 9
Results for 65536-3600C-Con2AM

| SNR, | capacity, | | | |
|---|---|---|---|---|
| dB | bit/symbol | a31 | a47 | a55 |
| 19 | 6.24364 | 1.51227 | 3.46893 | 4.40833 |
| 20 | 6.5804 | 2.38586 | 4.4134 | 6.11654 |
| 21 | 6.92126 | 2.81876 | 4.87973 | 6.90754 |
| 22 | 7.25835 | 2.96262 | 5.03708 | 7.15507 |
| 23 | 7.59033 | 3.00494 | 5.08347 | 7.18485 |
| 24 | 7.91785 | 3.01465 | 5.08882 | 7.10832 |
| 25 | 8.24035 | 3.0146 | 5.07798 | 7.00559 |
| 26 | 8.5561 | 3.0126 | 5.06426 | 6.95813 |
| 27 | 8.86446 | 3.01032 | 5.05209 | 6.99025 |

| SNR, | | | | | |
|---|---|---|---|---|---|
| dB | a63 | a71 | a79 | a87 | a91 |
| 19 | 4.39741 | 6.37441 | 6.38626 | 7.99243 | 8.27303 |
| 20 | 6.11476 | 8.28146 | 8.34642 | 10.4721 | 10.9022 |
| 21 | 6.92909 | 9.16317 | 9.32961 | 11.566 | 12.2568 |
| 22 | 7.22485 | 9.41778 | 9.73026 | 11.8952 | 12.8417 |
| 23 | 7.35248 | 9.40237 | 9.96725 | 11.9627 | 13.2593 |
| 24 | 7.44906 | 9.31528 | 10.2264 | 12.0322 | 13.6005 |
| 25 | 7.58841 | 9.30219 | 10.5636 | 12.2309 | 13.8825 |
| 26 | 7.86274 | 9.44776 | 10.9169 | 12.5643 | 14.203 |
| 27 | 8.24723 | 9.77314 | 11.3446 | 13.0258 | 14.6389 |

| SNR, | capacity, | | | |
|---|---|---|---|---|
| dB | bit/symbol | a95 | a99 | a103 |
| 19 | 6.24364 | 8.24129 | 10.2832 | 10.2071 |
| 20 | 6.5804 | 10.8649 | 13.2497 | 13.1808 |
| 21 | 6.92126 | 12.2348 | 14.6069 | 14.6084 |
| 22 | 7.25835 | 12.8477 | 15.0646 | 15.1533 |
| 23 | 7.59033 | 13.2974 | 15.2786 | 15.4608 |
| 24 | 7.91785 | 13.6787 | 15.4819 | 15.7957 |
| 25 | 8.24035 | 14.0437 | 15.7094 | 16.2476 |
| 26 | 8.5561 | 14.5064 | 16.0603 | 16.8871 |
| 27 | 8.86446 | 15.1375 | 16.6136 | 17.7429 |

| SNR, | | | | | |
|---|---|---|---|---|---|
| dB | a105 | a107 | a109 | a111 | a113 |
| 19 | 10.9588 | 10.9917 | 11.2318 | 11.199 | 13.2967 |
| 20 | 14.2868 | 14.3373 | 14.6722 | 14.6192 | 17.0485 |
| 21 | 16.2054 | 16.2527 | 16.6603 | 16.6031 | 18.9913 |
| 22 | 16.9876 | 17.004 | 17.5915 | 17.5487 | 19.7411 |
| 23 | 17.341 | 17.3372 | 18.056 | 18.0543 | 20.0797 |
| 24 | 17.5964 | 17.5842 | 18.4927 | 18.5247 | 20.3623 |
| 25 | 17.9109 | 17.9057 | 19.113 | 19.1762 | 20.8199 |
| 26 | 18.4188 | 18.4347 | 19.8235 | 19.956 | 21.4662 |
| 27 | 19.1848 | 19.247 | 20.6683 | 20.9324 | 22.3495 |

| SNR, | capacity, | | | |
|---|---|---|---|---|
| dB | bit/symbol | a115 | a116 | a117 |
| 19 | 6.24364 | 13.2247 | 13.8019 | 13.8202 |
| 20 | 6.5804 | 16.9526 | 17.7123 | 17.7468 |
| 21 | 6.92126 | 18.9002 | 19.8735 | 19.9253 |
| 22 | 7.25835 | 19.7235 | 21.0733 | 21.1225 |
| 23 | 7.59033 | 20.1456 | 21.7112 | 21.7281 |
| 24 | 7.91785 | 20.5075 | 22.1497 | 22.1451 |
| 25 | 8.24035 | 21.068 | 22.6924 | 22.6787 |
| 26 | 8.5561 | 21.9104 | 23.4388 | 23.432 |
| 27 | 8.86446 | 23.0532 | 24.4808 | 24.496 |

| SNR, | | | | | |
|---|---|---|---|---|---|
| dB | a118 | a119 | a120 | a121 | a122 |
| 19 | 13.9848 | 13.9666 | 15.9826 | 15.9212 | 16.4448 |
| 20 | 18.0077 | 17.9715 | 20.3906 | 20.3068 | 20.963 |
| 21 | 20.278 | 20.2226 | 22.664 | 22.5652 | 23.3355 |
| 22 | 21.5269 | 21.4672 | 23.7037 | 23.6144 | 24.5485 |
| 23 | 22.2648 | 22.2308 | 24.2256 | 24.2125 | 25.4488 |
| 24 | 22.784 | 22.7837 | 24.6162 | 24.6872 | 26.0963 |
| 25 | 23.457 | 23.4918 | 25.1751 | 25.3217 | 26.8091 |
| 26 | 24.4913 | 24.5595 | 26.0722 | 26.3252 | 27.8124 |
| 27 | 25.7576 | 25.8941 | 27.2909 | 27.7378 | 29.1612 |

| SNR, | capacity, | | | | | |
|---|---|---|---|---|---|---|
| dB | bit/symbol | a123 | a124 | a125 | a126 | a127 |
| 19 | 6.24364 | 16.5587 | 18.3922 | 18.9201 | 20.8759 | 23.3658 |
| 20 | 6.5804 | 21.1518 | 23.427 | 24.0717 | 26.5793 | 29.6717 |
| 21 | 6.92126 | 23.6097 | 25.9748 | 26.7064 | 29.4209 | 32.7315 |
| 22 | 7.25835 | 24.9148 | 27.1128 | 27.9803 | 30.6359 | 33.916 |
| 23 | 7.59033 | 25.8832 | 27.8324 | 28.9508 | 31.4228 | 34.5705 |
| 24 | 7.91785 | 26.6374 | 28.4279 | 29.869 | 32.1755 | 35.1607 |
| 25 | 8.24035 | 27.4379 | 29.1585 | 30.7978 | 33.0226 | 35.857 |
| 26 | 8.5561 | 28.6002 | 30.2478 | 31.9926 | 34.1704 | 36.8811 |
| 27 | 8.86446 | 30.2444 | 31.8169 | 33.6142 | 35.7587 | 38.3729 |

TABLE 10

| SNR, | capacity, | | | |
|---|---|---|---|---|
| dB | bit/symbol | a31 | a39 | a47 |
| 23 | 7.59039 | 3.00576 | 5.06514 | 5.10558 |
| 24 | 7.91837 | 3.01471 | 5.02903 | 5.15323 |
| 25 | 8.24299 | 3.01521 | 4.94298 | 5.2525 |
| 26 | 8.56424 | 3.01325 | 4.85908 | 5.44651 |
| 27 | 8.88051 | 3.01067 | 4.85103 | 5.80077 |
| 28 | 9.19033 | 3.00855 | 4.9047 | 6.16595 |

| SNR, | | | | | |
|---|---|---|---|---|---|
| dB | a55 | a63 | a71 | a79 | a87 |
| 23 | 7.1829 | 7.36399 | 9.40778 | 9.97866 | 11.9726 |
| 24 | 7.09137 | 7.49702 | 9.33114 | 10.2798 | 12.0715 |
| 25 | 6.99479 | 7.78063 | 9.41075 | 10.7298 | 12.3819 |
| 26 | 7.03792 | 8.20414 | 9.70594 | 11.1945 | 12.8352 |
| 27 | 7.27604 | 8.65119 | 10.1481 | 11.7126 | 13.3887 |
| 28 | 7.62048 | 9.1003 | 10.6494 | 12.2729 | 13.99 |

| SNR, | capacity, | | | |
|---|---|---|---|---|
| dB | bit/symbol | a91 | a95 | a99 |
| 23 | 7.59039 | 13.2711 | 13.31 | 15.2913 |
| 24 | 7.91837 | 13.6469 | 13.7232 | 15.5282 |
| 25 | 8.24299 | 14.0394 | 14.1918 | 15.868 |
| 26 | 8.56424 | 14.4815 | 14.7607 | 16.332 |
| 27 | 8.88051 | 15.0087 | 15.4694 | 16.9629 |
| 28 | 9.19033 | 15.6128 | 16.3067 | 17.7373 |

| SNR, | | | | | |
|---|---|---|---|---|---|
| dB | a103 | a105 | a107 | a109 | a111 |
| 23 | 15.4742 | 17.3547 | 17.3512 | 18.0704 | 18.0684 |
| 24 | 15.8383 | 17.6422 | 17.63 | 18.5331 | 18.5646 |
| 25 | 16.3878 | 18.063 | 18.0569 | 19.2456 | 19.3063 |
| 26 | 17.1154 | 18.6692 | 18.6814 | 20.0588 | 20.1804 |
| 27 | 18.0465 | 19.5044 | 19.5556 | 20.9859 | 21.2207 |
| 28 | 19.0349 | 20.4636 | 20.6034 | 21.9858 | 22.4417 |

| SNR, | capacity, | | | |
|---|---|---|---|---|
| dB | bit/symbol | a113 | a114 | a115 |
| 23 | 7.59039 | 20.0969 | 20.1609 | 20.1629 |
| 24 | 7.91837 | 20.407 | 20.5507 | 20.5507 |
| 25 | 8.24299 | 20.9639 | 21.2055 | 21.201 |
| 26 | 8.56424 | 21.709 | 22.1296 | 22.1235 |
| 27 | 8.88051 | 22.6606 | 23.3164 | 23.314 |
| 28 | 9.19033 | 23.7938 | 24.766 | 24.7745 |

| SNR, | | | | | |
|---|---|---|---|---|---|
| dB | a116 | a117 | a118 | a119 | a120 |
| 23 | 21.7279 | 21.7465 | 22.2615 | 22.2454 | 24.2432 |
| 24 | 22.1927 | 22.1884 | 22.8258 | 22.8249 | 24.6608 |
| 25 | 22.8349 | 22.8208 | 23.5868 | 23.6205 | 25.3173 |
| 26 | 23.673 | 23.6637 | 24.6914 | 24.7556 | 26.2921 |
| 27 | 24.7694 | 24.7793 | 26.0235 | 26.1467 | 27.5656 |
| 28 | 26.1276 | 26.1798 | 27.5049 | 27.7411 | 29.0879 |

| SNR, | capacity, | | | |
|---|---|---|---|---|
| dB | bit/symbol | a121 | a122 | a123 |
| 23 | 7.59039 | 24.2292 | 25.4672 | 25.9017 |
| 24 | 7.91837 | 24.7304 | 26.138 | 26.6779 |
| 25 | 8.24299 | 25.4596 | 26.9469 | 27.5712 |
| 26 | 8.56424 | 26.5298 | 28.0275 | 28.792 |
| 27 | 8.88051 | 27.9798 | 29.4218 | 30.4641 |
| 28 | 9.19033 | 29.7387 | 31.1175 | 32.4005 |

| SNR, | | | | |
|---|---|---|---|---|
| dB | a124 | a125 | a126 | a127 |
| 23 | 27.8518 | 28.9701 | 31.4434 | 34.5927 |
| 24 | 28.471 | 29.9084 | 32.2182 | 35.208 |
| 25 | 29.2992 | 30.9336 | 33.1673 | 36.0168 |
| 26 | 30.4569 | 32.2005 | 34.3923 | 37.1273 |
| 27 | 32.0524 | 33.855 | 36.0175 | 38.6617 |
| 28 | 33.9891 | 35.8209 | 37.9595 | 40.5278 |

TABLE 11
Results for 65536-4096B-ConQAM

| SNR, | capacity, | | | |
|---|---|---|---|---|
| dB | bit/symbol | a23 | a31 | a39 |
| 18 | 5.91408 | 1.16843 | 1.17311 | 3.11907 |
| 19 | 6.24366 | 1.51156 | 1.51303 | 3.46815 |
| 20 | 6.58041 | 2.38621 | 2.38605 | 4.41532 |
| 21 | 6.92126 | 2.81945 | 2.81808 | 4.88131 |
| 22 | 7.25834 | 2.96301 | 2.96225 | 5.03328 |
| 23 | 7.59039 | 3.00153 | 3.00832 | 5.06251 |
| 24 | 7.91842 | 2.99677 | 3.03285 | 5.02384 |
| 25 | 8.24361 | 2.95215 | 3.08428 | 4.92329 |
| 26 | 8.56801 | 2.86012 | 3.2277 | 4.86014 |
| 27 | 8.8917 | 2.80225 | 3.4857 | 4.98166 |
| 28 | 9.21284 | 2.83285 | 3.88559 | 5.29319 |
| 29 | 9.52887 | 2.88567 | 4.18088 | 5.60623 |

| SNR, | | | | | |
|---|---|---|---|---|---|
| dB | a47 | a55 | a63 | a71 | a79 |
| 18 | 3.13536 | 3.61987 | 3.59167 | 5.56771 | 5.53031 |
| 19 | 3.46981 | 4.40858 | 4.39723 | 6.37466 | 6.38617 |
| 20 | 4.41201 | 6.1171 | 6.11519 | 8.28208 | 8.34688 |
| 21 | 4.87812 | 6.90769 | 6.92887 | 9.16309 | 9.32954 |
| 22 | 5.04092 | 7.1544 | 7.22588 | 9.41797 | 9.73078 |
| 23 | 5.10473 | 7.17989 | 7.36148 | 9.4036 | 9.97501 |
| 24 | 5.16111 | 7.09139 | 7.50343 | 9.3345 | 10.2866 |
| 25 | 5.30792 | 7.01228 | 7.84233 | 9.45547 | 10.7845 |
| 26 | 5.69061 | 7.18491 | 8.4128 | 9.89536 | 11.384 |
| 27 | 6.15944 | 7.56438 | 8.9492 | 10.4355 | 11.992 |
| 28 | 6.64058 | 8.06361 | 9.52636 | 11.0608 | 12.6736 |
| 29 | 7.04718 | 8.53191 | 10.0637 | 11.6563 | 13.3202 |

| SNR, | capacity, | | | |
|---|---|---|---|---|
| dB | bit/symbol | a109 | a111 | a113 |
| 18 | 5.91408 | 9.53499 | 9.51777 | 11.4683 |
| 19 | 6.24366 | 11.2343 | 11.2008 | 13.2951 |
| 20 | 6.58041 | 14.6729 | 14.6202 | 17.0464 |
| 21 | 6.92126 | 16.6599 | 16.6024 | 18.991 |
| 22 | 7.25834 | 17.5823 | 17.5492 | 19.7419 |
| 23 | 7.59039 | 18.0627 | 18.0609 | 20.0868 |
| 24 | 7.91842 | 18.5387 | 18.5701 | 20.4132 |
| 25 | 8.24361 | 19.2959 | 19.3555 | 21.0178 |
| 26 | 8.56801 | 20.2478 | 20.3611 | 21.904 |
| 27 | 8.8917 | 21.3052 | 21.5155 | 22.9758 |
| 28 | 9.21284 | 22.5012 | 22.8913 | 24.2747 |
| 29 | 9.52887 | 23.7476 | 24.422 | 25.7255 |

| SNR, | | | | | |
|---|---|---|---|---|---|
| dB | a115 | a117 | a118 | a119 | a120 |
| 18 | 11.4139 | 11.9184 | 12.0182 | 12.0158 | 13.8086 |
| 19 | 13.2234 | 13.8142 | 13.9856 | 13.9711 | 15.982 |
| 20 | 16.9509 | 17.732 | 18.0058 | 17.9778 | 20.3883 |
| 21 | 18.8994 | 19.8975 | 20.2717 | 20.23 | 22.6582 |
| 22 | 19.7241 | 21.0958 | 21.5226 | 21.477 | 23.6979 |
| 23 | 20.1525 | 21.7257 | 22.2693 | 22.2399 | 24.2311 |
| 24 | 20.5567 | 22.1965 | 22.8322 | 22.8299 | 24.6673 |
| 25 | 21.2542 | 22.8812 | 23.6384 | 23.6674 | 25.3722 |
| 26 | 22.3017 | 23.8566 | 24.8548 | 24.9151 | 26.4718 |
| 27 | 23.5879 | 25.0685 | 26.2956 | 26.406 | 27.8474 |
| 28 | 25.1741 | 26.5804 | 27.931 | 28.1191 | 29.5005 |
| 29 | 26.8893 | 28.286 | 29.6749 | 29.9991 | 31.3353 |

| SNR, | capacity, | | | |
|---|---|---|---|---|
| dB | bit/symbol | a121 | a122 | a123 |
| 18 | 5.91408 | 13.7651 | 14.2379 | 14.2872 |
| 19 | 6.24365 | 15.9224 | 16.4465 | 16.5578 |
| 20 | 6.58041 | 20.3087 | 20.9666 | 21.149 |
| 21 | 6.92126 | 22.5673 | 23.343 | 23.6051 |
| 22 | 7.25834 | 23.6179 | 24.5625 | 24.9152 |
| 23 | 7.59039 | 24.2204 | 25.4579 | 25.8901 |
| 24 | 7.91842 | 24.736 | 26.1436 | 26.6831 |
| 25 | 8.24361 | 25.5103 | 26.9988 | 27.6204 |
| 26 | 8.56801 | 26.6973 | 23.2031 | 28.9506 |
| 27 | 8.8917 | 28.2315 | 29.6909 | 30.6926 |
| 28 | 9.21284 | 30.0821 | 31.4928 | 32.7365 |
| 29 | 9.52887 | 32.19 | 33.5445 | 34.9476 |

| SNR, | | | | |
|---|---|---|---|---|
| dB | a124 | a125 | a126 | a127 |
| 18 | 15.8387 | 16.3254 | 17.9036 | 20.0768 |
| 19 | 18.3929 | 18.92 | 20.8763 | 23.366 |
| 20 | 23.4279 | 24.0702 | 26.5794 | 29.6718 |
| 21 | 25.9757 | 26.7017 | 29.4194 | 32.7298 |
| 22 | 27.118 | 27.9772 | 30.6368 | 33.9169 |
| 23 | 27.8406 | 28.9567 | 31.43 | 34.5783 |
| 24 | 28.4768 | 29.9135 | 32.2239 | 35.2143 |
| 25 | 29.3517 | 30.9839 | 33.221 | 36.0762 |
| 26 | 30.6291 | 32.3714 | 34.5742 | 37.3286 |
| 27 | 32.2981 | 34.1046 | 36.2837 | 38.9559 |
| 28 | 34.3325 | 36.1746 | 38.3369 | 40.944 |
| 29 | 36.5808 | 38.4442 | 40.5883 | 43.1337 |

TABLE 12
Results for 65536-4900A-ConQAM

| SNR, | capacity, | | | |
|---|---|---|---|---|
| dB | bit/symbol | a15 | a23 | a31 |
| 22 | 7.25834 | 0.99956 | 2.9623 | 2.9615 |
| 23 | 7.59039 | 1.00062 | 3.00261 | 3.0095 |
| 24 | 7.91842 | 1.01191 | 3.01298 | 3.05271 |
| 25 | 8.24375 | 1.07978 | 3.05399 | 3.22539 |
| 26 | 8.5711 | 1.75148 | 3.71541 | 4.67358 |
| 27 | 8.90978 | 2.72176 | 4.73074 | 6.52297 |
| 28 | 9.24602 | 2.92863 | 4.94476 | 6.92158 |
| 29 | 9.57647 | 2.98633 | 5.00471 | 7.03251 |
| 30 | 9.90043 | 3.00049 | 5.01801 | 7.05527 |
| 31 | 10.2146 | 3.00318 | 5.01833 | 7.05212 |

| SNR, | | | | | | |
|---|---|---|---|---|---|---|
| dB | a39 | a47 | a55 | a63 | a67 | a71 |
| 22 | 5.03203 | 5.03968 | 7.15262 | 7.22408 | 9.41478 | 9.41648 |
| 23 | 5.06446 | 5.1067 | 7.18269 | 7.36434 | 9.4059 | 9.40869 |
| 24 | 5.05341 | 5.19257 | 7.13368 | 7.54865 | 9.39025 | 9.39047 |
| 25 | 5.11418 | 5.53229 | 7.29337 | 8.16528 | 9.8374 | 9.83646 |
| 26 | 6.56542 | 7.85173 | 9.69893 | 11.3102 | 13.2098 | 13.21 |
| 27 | 8.56484 | 10.489 | 12.6086 | 14.7216 | 16.9953 | 17.0046 |
| 28 | 8.99094 | 11.0666 | 13.2404 | 15.4754 | 17.8044 | 17.8568 |
| 29 | 9.10933 | 11.2244 | 13.409 | 15.6662 | 17.9289 | 18.1267 |
| 30 | 9.12775 | 11.2413 | 13.4104 | 15.6452 | 17.7561 | 18.2657 |
| 31 | 9.11344 | 11.2098 | 13.3505 | 15.5446 | 17.564 | 18.48 |

| SNR, | capacity, | | | |
|---|---|---|---|---|
| dB | bit/symbol | a75 | a79 | a83 |
| 22 | 7.25834 | 9.72936 | 9.72735 | 11.8964 |
| 23 | 7.59039 | 9.98155 | 9.97621 | 11.9771 |
| 24 | 7.91842 | 10.3498 | 10.3469 | 12.148 |
| 25 | 8.24375 | 11.2178 | 11.22 | 12.917 |
| 26 | 8.5711 | 15.1115 | 15.1261 | 17.1866 |
| 27 | 8.90978 | 19.3509 | 19.4102 | 21.8433 |
| 28 | 9.24602 | 20.2137 | 20.4179 | 22.7226 |
| 29 | 9.57647 | 20.2694 | 20.8474 | 22.8519 |
| 30 | 9.90043 | 20.1345 | 21.2671 | 22.9989 |
| 31 | 10.2146 | 20.151 | 21.6185 | 23.2541 |

| SNR, | | | | | | |
|---|---|---|---|---|---|---|
| dB | a87 | a91 | a95 | a99 | a103 | a105 |
| 22 | 11.8889 | 12.8379 | 12.8461 | 15.0608 | 15.1506 | 16.964 |
| 23 | 11.9676 | 13.2716 | 13.3102 | 15.291 | 15.4738 | 17.3547 |
| 24 | 12.1506 | 13.7344 | 13.8115 | 15.6273 | 15.9388 | 17.7539 |
| 25 | 12.9465 | 14.6517 | 14.815 | 16.5562 | 17.0915 | 18.8353 |
| 26 | 17.2735 | 19.3608 | 19.7024 | 21.7577 | 22.687 | 24.7407 |
| 27 | 22.081 | 24.4657 | 25.1834 | 27.4975 | 29.0494 | 31.3587 |
| 28 | 23.312 | 25.5033 | 26.7806 | 28.9122 | 30.8772 | 33.1114 |
| 29 | 24.0274 | 25.94 | 27.651 | 29.6384 | 31.7226 | 33.8695 |
| 30 | 24.5647 | 26.3351 | 28.158 | 30.1175 | 32.2074 | 34.24 |
| 31 | 24.9256 | 26.691 | 28.5418 | 30.499 | 32.5713 | 34.5296 |

| SNR, | capacity, | | | | |
|---|---|---|---|---|---|
| dB | bit/symbol | a107 | a 109 | a111 | a113 |
| 22 | 7.25834 | 17.0006 | 17.578 | 17.5448 | 19.737 |
| 23 | 7.59039 | 17.3509 | 18.0698 | 18.068 | 20.0947 |
| 24 | 7.91842 | 17.7416 | 18.6493 | 18.6809 | 20.5349 |
| 25 | 8.24375 | 18.8285 | 20.0556 | 20.1173 | 21.8455 |
| 26 | 8.5711 | 24.748 | 26.4912 | 26.6219 | 28.6469 |
| 27 | 8.90978 | 31.4062 | 33.633 | 33.9074 | 36.2173 |
| 28 | 9.24602 | 33.2496 | 35.467 | 35.9881 | 38.1757 |
| 29 | 9.57647 | 34.1695 | 36.2139 | 37.0896 | 39.0838 |
| 30 | 9.90043 | 34.78 | 36.6436 | 37.9197 | 39.7293 |
| 31 | 10.2146 | 35.3668 | 37.0785 | 38.6111 | 40.3612 |

| SNR, | | | | | |
|---|---|---|---|---|---|
| dB | a115 | a117 | a118 | a119 | a120 |
| 22 | 19.7192 | 21.0906 | 21.5173 | 21.4716 | 23.6921 |
| 23 | 20.1605 | 21.7344 | 22.2781 | 22.2487 | 24.2407 |
| 24 | 20.6793 | 22.3289 | 22.9682 | 22.966 | 24.8143 |
| 25 | 22.09 | 23.7806 | 24.5656 | 24.5954 | 26.3677 |
| 26 | 29.1176 | 31.1533 | 32.3842 | 32.4552 | 34.5084 |
| 27 | 37.0666 | 39.409 | 41.2375 | 41.3839 | 43.6741 |
| 28 | 39.4556 | 41.6754 | 43.7482 | 44.0084 | 46.1813 |
| 29 | 40.7404 | 42.831 | 44.9114 | 45.3366 | 47.3618 |
| 30 | 41.5505 | 43.5978 | 45.6046 | 46.2303 | 48.1192 |
| 31 | 42.2294 | 44.2593 | 46.2142 | 47.1168 | 48.8656 |

| SNR, | capacity, | | | |
|---|---|---|---|---|
| dB | bit/symbol | a 121 | a122 | a123 |
| 22 | 7.25834 | 23.6121 | 24.5564 | 24.909 |
| 23 | 7.59039 | 24.23 | 25.4681 | 25.9004 |
| 24 | 7.91842 | 24.8834 | 26.2993 | 26.8421 |
| 25 | 8.24375 | 26.5106 | 28.0565 | 28.7015 |
| 26 | 8.5711 | 34.7771 | 36.7343 | 37.6672 |
| 27 | 8.90978 | 44.1945 | 46.4964 | 47.9379 |
| 28 | 9.24602 | 47.0117 | 49.2316 | 51.0982 |
| 29 | 9.57647 | 48.5306 | 50.588 | 52.6498 |
| 30 | 9.90043 | 49.6064 | 51.5399 | 53.6471 |
| 31 | 10.2146 | 50.5392 | 52.4442 | 54.5393 |

| SNR, | | | | |
|---|---|---|---|---|
| dB | a124 | a125 | a126 | a127 |
| 22 | 27.1112 | 27.9702 | 30.6292 | 33.9085 |
| 23 | 27.8517 | 28.9682 | 31.4425 | 34.592 |
| 24 | 28.6463 | 30.0916 | 32.4157 | 35.4239 |
| 25 | 30.5005 | 32.195 | 34.5196 | 37.4868 |
| 26 | 39.861 | 42.105 | 44.972 | 48.5689 |
| 27 | 50.472 | 53.2725 | 56.6851 | 60.8909 |
| 28 | 53.5839 | 56.4503 | 59.8328 | 63.9262 |
| 29 | 55.0914 | 57.8896 | 61.1243 | 64.9788 |
| 30 | 56.0304 | 58.716 | 61.7713 | 65.3631 |
| 31 | 56.8548 | 59.4219 | 62.302 | 65.6457 |

TABLE 13
Results for 65536-5476A-ConQAM

| SNR, | capacity, | | | | |
|---|---|---|---|---|---|
| dB | bit/symbol | a15 | a23 | a31 | a39 |
| 28 | 9.24604 | 2.92858 | 4.94473 | 6.9215 | 8.99087 |
| 29 | 9.5766 | 2.98611 | 5.0044 | 7.03201 | 9.10871 |
| 30 | 9.9011 | 3.00066 | 5.01846 | 7.05593 | 9.12872 |
| 31 | 10.2169 | 3.00233 | 5.01675 | 7.04986 | 9.11067 |
| SNR, | | | | | |
| dB | a47 | a55 | a63 | a67 | a71 |
| 28 | 11.0664 | 13.2403 | 15.4752 | 17.8042 | 17.8566 |
| 29 | 11.2236 | 13.408 | 15.6651 | 17.9282 | 18.1247 |
| 30 | 11.2426 | 13.4121 | 15.6474 | 17.7608 | 18.2638 |
| 31 | 11.2067 | 13.3472 | 15.5415 | 17.5603 | 18.4538 |
| SNR, | capacity, | | | | |
| dB | bit/symbol | a75 | a79 | a83 | a87 |
| 28 | 9.24604 | 20.2136 | 20.4176 | 22.7225 | 23.3114 |
| 29 | 9.5766 | 20.2688 | 20.8439 | 22.8498 | 24.0218 |
| 30 | 9.9011 | 20.1364 | 21.2596 | 22.9947 | 24.5562 |
| 31 | 10.2169 | 20.1313 | 21.5877 | 23.222 | 24.8883 |
| SNR, | | | | | |
| dB | a91 | a95 | a99 | a101 | a103 |
| 28 | 25.503 | 26.7796 | 28.9114 | 30.8613 | 30.8907 |
| 29 | 25.9354 | 27.6446 | 29.632 | 31.6696 | 31.7623 |
| 30 | 26.3267 | 28.1474 | 30.1062 | 32.0828 | 32.3239 |
| 31 | 26.6497 | 28.4957 | 30.4494 | 32.3202 | 32.8221 |
| SNR, | capacity, | | | | |
| dB | bit/symbol | a105 | a107 | a109 | a111 |
| 28 | 9.24604 | 33.107 | 33.2535 | 35.4661 | 35.9909 |
| 29 | 9.5766 | 33.8488 | 34.1911 | 36.2123 | 37.1142 |
| 30 | 9.9011 | 34.2031 | 34.8991 | 36.6929 | 38.0307 |
| 31 | 10.2169 | 34.5093 | 35.6457 | 37.2501 | 38.8148 |
| SNR, | | | | | |
| dB | a113 | a115 | a116 | a117 | a118 |
| 28 | 38.1766 | 39.4587 | 41.6556 | 41.6996 | 43.7465 |
| 29 | 39.0968 | 40.7596 | 42.7868 | 42.9122 | 44.9118 |
| 30 | 39.8202 | 41.6447 | 43.5655 | 43.8332 | 45.6748 |
| 31 | 40.5525 | 42.4154 | 44.242 | 44.7347 | 46.4223 |
| SNR, | capacity, | | | | |
| dB | bit/symbol | a119 | a120 | a121 | a122 |
| 28 | 9.24604 | 44.0209 | 46.1861 | 47.024 | 49.2405 |
| 29 | 9.5766 | 45.4003 | 47.3941 | 48.5995 | 50.6426 |
| 30 | 9.9011 | 46.4716 | 48.2842 | 49.8156 | 51.7372 |
| 31 | 10.2169 | 47.5999 | 49.2532 | 50.9419 | 52.8383 |
| SNR, | | | | | |
| dB | a123 | a124 | a 1.2 5 | a 12 6 | a127 |
| 28 | 51.1089 | 53.5941 | 56.4602 | 59.8427 | 63.9362 |
| 29 | 52.7067 | 55.1471 | 57.9447 | 61.1793 | 65.0341 |
| 30 | 53.843 | 56.2249 | 58.9105 | 61.9672 | 65.5621 |
| 31 | 54.9281 | 57.2406 | 59.807 | 62.689 | 66.0375 |

TABLE 14
Results for 1024-100A-ConQAM

| SNR, | capacity, | | | | |
|---|---|---|---|---|---|
| dB | bit/symbol | η | λ | ξ | ο |
| 7. | 2.44315 | 1. | 3.77418 | 3.77418 | 3.77418 |
| 7.5 | 2.57517 | 1.10378 | 3.45623 | 3.89014 | 6.30875 |
| 8. | 2.7153 | 1.12763 | 3.51714 | 3.9596 | 6.54934 |
| 8.5 | 2.85595 | 1.15612 | 3.54897 | 4.0287 | 6.69477 |
| 9. | 2.99655 | 1.19905 | 3.564 | 4.13485 | 6.80274 |
| 9.5 | 3.1373 | 1.28234 | 3.59819 | 4.38437 | 6.99551 |
| 10. | 3.28017 | 1.43443 | 3.71087 | 4.88481 | 7.43429 |
| 10.5 | 3.42754 | 1.61857 | 3.89079 | 5.46175 | 8.01984 |
| 11. | 3.57964 | 1.61445 | 4.10157 | 6.01296 | 8.6479 |
| 11.5 | 3.73577 | 2.02565 | 4.33275 | 6.54026 | 9.29979 |
| 12. | 3.89502 | 2.25761 | 4.58741 | 7.0624 | 9.97725 |
| 12.5 | 4.05622 | 2.47625 | 4.8202 | 7.50717 | 10.5712 |
| 13. | 4.2181 | 2.6684 | 5.02934 | 7.88158 | 11.0718 |
| 13.5 | 4.37927 | 2.81235 | 5.19094 | 8.15017 | 11.4231 |
| 14. | 4.53861 | 2.91293 | 5.30992 | 8.32579 | 11.6372 |
| 14.5 | 4.69531 | 2.98308 | 5.39738 | 8.43104 | 11.7438 |
| 15. | 4.84878 | 3.03258 | 5.45879 | 8.47927 | 11.7625 |

Results for 4096-100A-ConQAM

| SNR, | capacity, | | | | |
|---|---|---|---|---|---|
| dB | bit/symbol | a15 | a23 | a30 | a31 |
| 5. | 1.9336 | 1. | 3.33684 | 3.33684 | 3.33684 |
| 5.25 | 1.99605 | 1. | 3.43909 | 3.43909 | 3.43909 |
| 5.5 | 2.05919 | 0.999999 | 3.52986 | 3.52986 | 3.52986 |
| 5.75 | 2.12284 | 1. | 3.60773 | 3.60773 | 3.60773 |
| 6. | 2.18683 | 1. | 3.67143 | 3.67143 | 3.67143 |
| 6.25 | 2.251 | 1. | 3.72006 | 3.72006 | 3.72006 |
| 6.5 | 2.3152 | 1. | 3.75317 | 3.75317 | 3.75317 |
| 6.75 | 2.37928 | 1. | 3.77092 | 3.77092 | 3.77092 |
| 7. | 2.44536 | 1.05196 | 3.48842 | 3.80662 | 7.09664 |
| 7.5 | 2.58351 | 1.06769 | 3.56385 | 3.8927 | 7.28173 |
| 8. | 2.72137 | 1.08868 | 3.58848 | 3.95824 | 7.35737 |
| 8.5 | 2.85844 | 1.1266 | 3.57861 | 4.05912 | 7.39274 |
| 9. | 2.9954 | 1.21633 | 3.57795 | 4.35392 | 7.58179 |
| 9.5 | 3.13528 | 1.36575 | 3.65546 | 4.87534 | 8.0698 |
| 10. | 3.28018 | 1.5291 | 3.79898 | 5.40701 | 8.6591 |
| 10.5 | 3.42996 | 1.70322 | 3.98135 | 5.92109 | 9.2786 |
| 11. | 3.58385 | 1.89288 | 4.19003 | 6.42298 | 9.9104 |
| 11.5 | 3.74091 | 2.10198 | 4.41975 | 6.91549 | 10.5449 |
| 12. | 3.90008 | 2.32626 | 4.66281 | 7.3906 | 11.162 |
| 12. | 3.90008 | 2.32626 | 4.66281 | 7.39061 | 11.162 |
| 12.5 | 4.06016 | 2.5425 | 4.89626 | 7.81371 | 11.7053 |
| 13. | 4.21984 | 2.72041 | 5.0915 | 8.14186 | 12.1074 |
| 13.5 | 4.37792 | 2.84944 | 5.23902 | 8.36471 | 12.3505 |
| 14. | 4.53347 | 2.9389 | 5.34754 | 8.50209 | 12.463 |
| 14.5 | 4.68587 | 3.00196 | 5.42739 | 8.57594 | 12.4779 |
| 15. | 4.8347 | 3.04628 | 5.48089 | 8.59489 | 12.4099 |
| 15.5 | 4.97962 | 3.07398 | 5.50398 | 8.55733 | 12.2594 |
| 16. | 5.12024 | 3.0847 | 5.49175 | 8.46061 | 12.0264 |
| 16.5 | 5.25604 | 3.08572 | 5.45809 | 8.33075 | 11.7501 |
| 17. | 5.38626 | 3.07826 | 5.4073 | 8.17877 | 11.4492 |
| 17.5 | 5.50981 | 3.06832 | 5.35386 | 8.0295 | 11.1599 |
| 18. | 5.62538 | 3.0586 | 5.30473 | 7.89461 | 10.8988 |

TABLE 15
Results for 16384-100A-ConQAM

| SNR, | capacity, | | | | |
|---|---|---|---|---|---|
| dB | bit/symbol | a31 | a47 | a62 | a63 |
| 5.25 | 1.99605 | 1. | 3.43909 | 3.43909 | 3.43909 |
| 5.5 | 2.05919 | 1. | 3.52986 | 3.52986 | 3.52986 |
| 5.75 | 2.12284 | 1. | 3.60773 | 3.60773 | 3.60773 |
| 6. | 2.18683 | 1. | 3.67143 | 3.67144 | 3.67144 |
| 6.25 | 2.251 | 1. | 3.72006 | 3.72006 | 3.72006 |
| 6.5 | 2.31613 | 1.02391 | 3.51224 | 3.72839 | 7.77809 |
| 6.75 | 2.3838 | 1.0287 | 3.56833 | 3.78632 | 7.87779 |
| 7. | 2.45151 | 1.03392 | 3.6082 | 3.83253 | 7.94314 |
| 7.25 | 2.51912 | 1.04004 | 3.63211 | 3.86907 | 7.97613 |
| 7.5 | 2.58653 | 1.04788 | 3.64097 | 3.90019 | 7.98166 |
| 7.75 | 2.55366 | 1.05904 | 3.63627 | 3.93419 | 7.96905 |
| 8. | 2.72052 | 1.077 | 3.6202 | 3.98804 | 7.957 |
| 8.25 | 2.78721 | 1.11215 | 3.60432 | 4.11119 | 8.00731 |
| 8.5 | 2.85411 | 1.16359 | 3.57942 | 4.29739 | 8.11709 |
| 9. | 2.99071 | 1.30183 | 3.61108 | 4.8015 | 8.59551 |
| 9.5 | 3.13221 | 1.44692 | 3.71795 | 5.28651 | 9.14736 |
| 10. | 3.27844 | 1.60279 | 3.87269 | 5.7636 | 9.73013 |
| 10.5 | 3.42881 | 1.77381 | 4.06023 | 6.2403 | 10.3305 |
| 11. | 3.58255 | 1.96167 | 4.26888 | 6.71009 | 10.9277 |
| 11.5 | 3.73873 | 2.17005 | 4.49761 | 7.17622 | 11.5231 |
| 12. | 3.89635 | 2.39028 | 4.7357 | 7.62261 | 12.0885 |
| 12.5 | 4.05425 | 2.59558 | 4.95773 | 8.00897 | 12.559 |
| 13. | 4.21122 | 2.75879 | 5.13833 | 8.29709 | 12.8747 |
| 13.5 | 4.36621 | 2.87527 | 5.27359 | 8.48577 | 13.0342 |
| 14. | 4.51842 | 2.95655 | 5.37386 | 8.59751 | 13.0736 |

Results for 65536-100A-ConQAM

| SNR, | capacity, | | | | |
|---|---|---|---|---|---|
| dB | bit/symbol | a63 | a95 | a126 | a127 |
| 5.5 | 2.05919 | 1. | 3.52986 | 3.52986 | 3.52986 |
| 5.75 | 2.12284 | 0.999999 | 3.60772 | 3.60772 | 3.60772 |
| 6. | 2.18714 | 1.00921 | 3.4876 | 3.62367 | 8.31918 |
| 6.25 | 2.25339 | 1.01203 | 3.56059 | 3.69607 | 8.43219 |
| 6.5 | 2.31984 | 1.01496 | 3.61729 | 3.75506 | 8.50984 |
| 6.75 | 2.38631 | 1.01827 | 3.65722 | 3.80118 | 8.55176 |
| 7. | 2.45268 | 1.02239 | 3.68033 | 3.83639 | 8.55971 |
| 7.25 | 2.51884 | 1.02818 | 3.68699 | 3.86535 | 8.53856 |
| 7.5 | 2.5847 | 1.0377 | 3.67755 | 3.8989 | 8.49932 |
| 7.75 | 2.65027 | 1.05675 | 3.65138 | 3.96586 | 8.47085 |
| 8. | 2.71574 | 1.09889 | 3.61037 | 4.13089 | 8.53193 |
| 8.5 | 2.84874 | 1.22647 | 3.57826 | 4.62508 | 8.95604 |
| 9. | 2.98625 | 1.35691 | 3.64019 | 5.07794 | 9.45664 |
| 9.5 | 3.12833 | 1.49685 | 3.76193 | 5.52331 | 9.99357 |
| 10. | 3.27466 | 1.65059 | 3.92372 | 5.97499 | 10.5567 |
| 10.5 | 3.42467 | 1.82023 | 4.11294 | 6.42993 | 11.13 |
| 11. | 3.57762 | 2.00837 | 4.32292 | 6.88385 | 11.7024 |
| 11.5 | 3.73264 | 2.21646 | 4.55099 | 7.3344 | 12.2691 |
| 12. | 3.88873 | 2.43231 | 4.78369 | 7.75949 | 12.7913 |
| 12.5 | 4.04481 | 2.6289 | 4.99667 | 8.12024 | 13.2067 |
| 13. | 4.19972 | 2.78199 | 5.16719 | 8.38251 | 13.4608 |
| 13.5 | 4.3525 | 2.89065 | 5.2947 | 8.55063 | 13.5628 |
| 14. | 4.50245 | 2.96708 | 5.38985 | 8.64754 | 13.5519 |

TABLE 16
Results for 262144-100A-ConQAM

| SNR, | capacity, | | | | |
|---|---|---|---|---|---|
| dB | bit/symbol | a127 | a191 | a254 | a255 |
| 4.5 | 1.81146 | 1. | 3.10389 | 3.1039 | 3.10389 |
| 4.75 | 1.87201 | 1. | 3.22462 | 3.22462 | 3.22462 |
| 5. | 1.9336 | 1. | 3.33684 | 3.33684 | 3.33685 |
| 5.25 | 1.99605 | 1. | 3.43909 | 3.43909 | 3.43909 |
| 5.5 | 2.05923 | 1.00221 | 3.39975 | 3.481 | 8.70987 |
| 5.75 | 2.12399 | 1.00573 | 3.50179 | 3.58031 | 8.87606 |
| 6. | 2.1892 | 1.00547 | 3.5704 | 3.64845 | 8.96211 |
| 6.25 | 2.25468 | 1.00358 | 3.60596 | 3.69311 | 8.96157 |
| 6.5 | 2.32026 | 1.00891 | 3.67895 | 3.76168 | 9.07231 |
| 5.75 | 2.38581 | 1.0102 | 3.70543 | 3.79463 | 9.06545 |
| 7. | 2.45118 | 1.01451 | 3.72068 | 3.82553 | 9.03972 |
| 7.25 | 2.51629 | 1.02038 | 3.71589 | 3.8514 | 8.982 |
| 7.5 | 2.58108 | 1.03447 | 3.69012 | 3.9055 | 8.92556 |
| 7.75 | 2.64572 | 1.07709 | 3.63331 | 4.08787 | 8.98012 |
| 8. | 2.71088 | 1.14076 | 3.58468 | 4.35479 | 9.18293 |
| 8.25 | 2.77703 | 1.20187 | 3.57088 | 4.59047 | 9.40759 |
| 8.5 | 2.84428 | 1.26212 | 3.58269 | 4.80699 | 9.63732 |
| 9. | 2.98206 | 1.38802 | 3.6605 | 5.22731 | 10.123 |
| 9.5 | 3.12413 | 1.5264 | 3.79027 | 5.65571 | 10.6467 |
| 10. | 3.27019 | 1.67954 | 3.95583 | 6.0952 | 11.1954 |
| 10.5 | 3.4197 | 1.84893 | 4.14625 | 6.53934 | 11.7516 |
| 11. | 3.57194 | 2.03699 | 4.35613 | 6.98325 | 12.3052 |
| 11.5 | 3.72605 | 2.24401 | 4.58232 | 7.42251 | 12.8481 |
| 12. | 3.88107 | 2.45732 | 4.8123 | 7.83623 | 13.3444 |
| 12.5 | 4.03592 | 2.6482 | 5.01939 | 8.18125 | 13.7217 |
| 13. | 4.18951 | 2.79518 | 5.1838 | 8.42837 | 13.9336 |
| 13.5 | 4.34091 | 2.89936 | 5.30683 | 8.58496 | 13.9959 |
| 14. | 4.48949 | 2.97306 | 5.39902 | 8.67361 | 13.9493 |

TABLE 17
Results for I024-I44A-Con2AM

| SNR, | capacity, | | | | | |
|---|---|---|---|---|---|---|
| dB | bit/symbol | η | λ | ν | ξ | ∘ |
| 6. | 2.18683 | 1. | 3.67143 | 3.67144 | 3.67144 | 3.67144 |
| 6.5 | 2.3152 | 1. | 3.75317 | 3.75317 | 3.75317 | 3.75317 |
| 7. | 2.44315 | 1. | 3.77418 | 3.77418 | 3.77418 | 3.77418 |
| 7.5 | 2.57699 | 1.10881 | 3.44715 | 3.80228 | 4.1827 | 6.27365 |
| 8. | 2.71714 | 1.13545 | 3.50972 | 3.87984 | 4.27142 | 6.52131 |
| 8.5 | 2.85795 | 1.1688 | 3.54487 | 3.95855 | 4.38886 | 6.67925 |
| 9. | 2.99902 | 1.22034 | 3.56744 | 4.07509 | 4.6055 | 6.81121 |
| 9.5 | 3.14087 | 1.30408 | 3.60973 | 4.28762 | 4.99147 | 7.01011 |
| 10. | 3.2847 | 1.42499 | 3.70158 | 4.64432 | 5.44005 | 7.34481 |
| 10.5 | 3.43188 | 1.59587 | 3.8664 | 5.18444 | 5.92116 | 7.87536 |
| 11. | 3.58344 | 1.79583 | 4.08018 | 5.7745 | 6.42259 | 8.51585 |
| 11.5 | 3.73913 | 2.01159 | 4.31615 | 6.33522 | 6.92502 | 9.1864 |
| 12. | 3.89807 | 2.24082 | 4.56502 | 6.86024 | 7.42467 | 9.85829 |
| 12.5 | 4.05913 | 2.46623 | 4.80808 | 7.32755 | 7.89946 | 10.4829 |
| 13. | 4.22104 | 2.65816 | 5.01664 | 7.69511 | 8.32013 | 10.9945 |
| 13.5 | 4.38262 | 2.79889 | 5.17337 | 7.93336 | 8.71883 | 11.3706 |
| 14. | 4.54376 | 2.8864 | 5.27183 | 8.03974 | 9.30507 | 11.7299 |
| 14.5 | 4.70624 | 2.94611 | 5.3377 | 8.14305 | 9.90797 | 12.1885 |
| 15. | 4.87019 | 2.99325 | 5.39127 | 8.24054 | 10.3204 | 12.6276 |
| 15.5 | 5.03468 | 3.02949 | 5.43251 | 8.30393 | 10.5947 | 12.9948 |
| 16. | 5.19853 | 3.05654 | 5.4597 | 8.32685 | 10.7486 | 13.2314 |
| 16.5 | 5.3604 | 3.0738 | 5.46734 | 8.30334 | 10.7897 | 13.3145 |
| 17. | 5.51897 | 3.08059 | 5.45166 | 8.23255 | 10.7329 | 13.2592 |
| 17.5 | 5.67298 | 3.07851 | 5.41588 | 8.12514 | 10.6051 | 13.1035 |

Results for 4096-I44A-Con2AM

| SNR, | capacity, | | | | | |
|---|---|---|---|---|---|---|
| dB | bit/symbol | a15 | a23 | a27 | a30 | a31 |
| 6. | 2.18683 | 1. | 3.67143 | 3.67143 | 3.67143 | 3.67143 |
| 6.25 | 2.251 | 1. | 3.72006 | 3.72006 | 3.72006 | 3.72006 |
| 6.5 | 2.3152 | 0.999999 | 3.75316 | 3.75316 | 3.75316 | 3.75316 |
| 6.75 | 2.37928 | 1. | 3.77092 | 3.77092 | 3.77092 | 3.77092 |
| 7. | 2.44634 | 1.0551 | 3.47568 | 3.72861 | 3.97285 | 7.05066 |
| 7.25 | 2.51536 | 1.06353 | 3.52086 | 3.7797 | 4.02149 | 7.16425 |
| 7.5 | 2.58444 | 1.07285 | 3.55231 | 3.82253 | 4.06562 | 7.2459 |
| 7.75 | 2.65346 | 1.08388 | 3.57079 | 3.85983 | 4.10987 | 7.29997 |
| 8. | 2.72236 | 1.09802 | 3.57788 | 3.89673 | 4.16322 | 7.33376 |
| 8.5 | 2.85981 | 1.14838 | 3.57043 | 4.01152 | 4.38837 | 7.40089 |
| 9. | 2.99845 | 1.24628 | 3.5807 | 4.22611 | 4.96712 | 7.61581 |
| 9.5 | 3.14034 | 1.34272 | 3.63403 | 4.45425 | 5.46005 | 7.90142 |
| 10. | 3.28531 | 1.46892 | 3.73945 | 4.83894 | 5.86546 | 8.32962 |
| 10.5 | 3.4341 | 1.64961 | 3.9219 | 5.42718 | 6.3116 | 8.97018 |
| 11. | 3.58716 | 1.85334 | 4.14408 | 6.0277 | 6.78312 | 9.66686 |
| 11.5 | 3.74374 | 2.06972 | 4.38194 | 6.57312 | 7.26767 | 10.3446 |
| 12. | 3.90272 | 2.2953 | 4.62666 | 7.05929 | 7.76479 | 10.9865 |
| 12.5 | 4.06301 | 2.50574 | 4.8532 | 7.44436 | 8.27011 | 11.55 |
| 13. | 4.22388 | 2.66433 | 5.0241 | 7.66401 | 8.82842 | 12.0311 |
| 13.5 | 4.38588 | 2.77706 | 5.14583 | 7.81442 | 9.43219 | 12.5442 |
| 14. | 4.54957 | 2.86836 | 5.24591 | 7.98391 | 9.96648 | 13.0527 |
| 14.5 | 4.71444 | 2.93977 | 5.32717 | 8.13911 | 10.3856 | 13.4701 |
| 15. | 4.87935 | 2.99371 | 5.39165 | 8.25573 | 10.6795 | 13.7605 |
| 15.5 | 5.04305 | 3.03391 | 5.43987 | 8.32546 | 10.8569 | 13.9203 |
| 16. | 5.2044 | 3.06256 | 5.46917 | 8.34521 | 10.9295 | 13.9558 |
| 16.5 | 5.36239 | 3.07768 | 5.47085 | 8.30651 | 10.8979 | 13.8642 |
| 17. | 5.51609 | 3.08178 | 5.44784 | 8.22013 | 10.7856 | 13.6737 |
| 17.5 | 5.66448 | 3.07744 | 5.40613 | 8.10132 | 10.62 | 13.4192 |

TABLE 18
Results for I6384-I44A-Con2AM

| SNR, | capacity, | | | | | |
|---|---|---|---|---|---|---|
| dB | bit/symbol | a31 | a47 | a55 | a62 | a63 |
| 5.25 | 1.99605 | 1. | 3.43909 | 3.43909 | 3.43909 | 3.43909 |
| 5.5 | 2.05919 | 1. | 3.52986 | 3.52986 | 3.52986 | 3.52986 |
| 5.75 | 2.12284 | 1. | 3.60773 | 3.60773 | 3.60773 | 3.60773 |
| 6. | 2.18683 | 1. | 3.67143 | 3.67143 | 3.67143 | 3.67143 |
| 6.25 | 2.251 | 0.999999 | 3.72006 | 3.72006 | 3.72006 | 3.72006 |
| 6.5 | 2.31644 | 1.02485 | 3.50472 | 3.67859 | 3.80851 | 7.75012 |
| 6.75 | 2.38409 | 1.03 | 3.56129 | 3.7392 | 3.86544 | 7.8529 |
| 7. | 2.45179 | 1.03566 | 3.60145 | 3.78785 | 3.9121 | 7.92096 |
| 7.25 | 2.51939 | 1.04239 | 3.62545 | 3.82667 | 3.95137 | 7.95658 |
| 7.5 | 2.5868 | 1.05121 | 3.63412 | 3.86001 | 3.98928 | 7.96501 |
| 7.75 | 2.65397 | 1.06406 | 3.62855 | 3.89698 | 4.03821 | 7.95649 |
| 8. | 2.7209 | 1.08621 | 3.61118 | 3.95414 | 4.13081 | 7.95404 |
| 8.25 | 2.78783 | 1.1295 | 3.58503 | 4.06582 | 4.35883 | 8.01287 |
| 8.5 | 2.85565 | 1.19744 | 3.5648 | 4.18403 | 4.86768 | 8.19325 |
| 8.75 | 2.92508 | 1.24232 | 3.56846 | 4.22771 | 5.24548 | 8.35103 |
| 9. | 2.99562 | 1.27759 | 3.58445 | 4.27838 | 5.48227 | 8.48752 |
| 9.5 | 3.13888 | 1.3528 | 3.63644 | 4.44456 | 5.83144 | 8.78285 |
| 10. | 3.28461 | 1.46449 | 3.73267 | 4.77365 | 6.1747 | 9.1987 |
| 10.5 | 3.43347 | 1.64163 | 3.91169 | 5.33955 | 6.61426 | 9.826 |
| 11. | 3.58613 | 1.85222 | 4.14176 | 5.95684 | 7.10365 | 10.5313 |
| 11.5 | 3.74199 | 2.06717 | 4.37819 | 6.48387 | 7.61025 | 11.2034 |
| 12. | 3.90015 | 2.27735 | 4.60564 | 6.90632 | 8.15 | 11.8428 |
| 12.5 | 4.06008 | 2.46933 | 4.81134 | 7.24162 | 8.72027 | 12.4653 |
| 13. | 4.22163 | 2.63368 | 4.98772 | 7.52637 | 9.29349 | 13.0709 |
| 13.5 | 4.38476 | 2.7666 | 5.13171 | 7.7793 | 9.83242 | 13.6286 |
| 14. | 4.54911 | 2.86828 | 5.24435 | 7.99536 | 10.2955 | 14.0918 |
| 14.5 | 4.71389 | 2.9431 | 5.33105 | 8.16361 | 10.6511 | 14.4255 |
| 15. | 4.87797 | 2.99784 | 5.39775 | 8.2801 | 10.8928 | 14.6226 |
| 15.5 | 5.04024 | 3.03788 | 5.44614 | 8.34466 | 11.0274 | 14.6903 |
| 16. | 5.19969 | 3.06508 | 5.47239 | 8.35463 | 11.0607 | 14.634 |
| 16.5 | 5.35544 | 3.07939 | 5.4717 | 8.30836 | 10.999 | 14.4606 |

Results for 65536-I44A-Con2AM

| SNR, | capacity, | | | | | |
|---|---|---|---|---|---|---|
| dB | bit/symbol | a63 | a95 | a111 | a126 | a127 |
| 5.5 | 2.05919 | 1. | 3.52986 | 3.52986 | 3.52986 | 3.52986 |
| 5.75 | 2.12284 | 1. | 3.60773 | 3.60773 | 3.60773 | 3.60773 |
| 6. | 2.18722 | 1.00935 | 3.48448 | 3.59584 | 3.66062 | 8.30551 |
| 6.25 | 2.25346 | 1.01229 | 3.55775 | 3.66982 | 3.73169 | 8.42001 |
| 6.5 | 2.3199 | 1.01535 | 3.61463 | 3.73025 | 3.78978 | 8.4989 |
| 6.75 | 2.38638 | 1.01881 | 3.65466 | 3.77766 | 3.83557 | 8.54195 |
| 7. | 2.45275 | 1.02314 | 3.67776 | 3.81401 | 3.8714 | 8.55095 |
| 7.25 | 2.5189 | 1.0293 | 3.68421 | 3.84395 | 3.90277 | 8.5309 |
| 7. | 2.45275 | 1.02314 | 3.67776 | 3.81401 | 3.87141 | 8.55096 |
| 7.25 | 2.5189 | 1.0293 | 3.68421 | 3.84395 | 3.90277 | 8.53091 |
| 7.5 | 2.58477 | 1.03959 | 3.67416 | 3.87837 | 3.94303 | 8.49331 |
| 7.75 | 2.65036 | 1.06078 | 3.6463 | 3.94613 | 4.03125 | 8.46944 |
| 8. | 2.71596 | 1.11078 | 3.60022 | 4.10252 | 4.29073 | 8.55034 |
| 8.25 | 2.78319 | 1.19285 | 3.54219 | 4.14842 | 5.11132 | 8.87453 |
| 8.5 | 2.85268 | 1.22534 | 3.54452 | 4.15479 | 5.41485 | 9.04739 |
| 8.75 | 2.92316 | 1.25353 | 3.55962 | 4.18616 | 5.61216 | 9.19174 |
| 9. | 2.99434 | 1.28183 | 3.57945 | 4.23298 | 5.77076 | 9.3268 |
| 9.5 | 3.13823 | 1.37209 | 3.69748 | 4.46176 | 6.16017 | 9.80375 |
| 10. | 3.28401 | 1.44755 | 3.71668 | 4.66772 | 6.34008 | 9.95763 |
| 10.5 | 3.43221 | 1.61186 | 3.87994 | 5.17898 | 6.76318 | 10.5291 |
| 11. | 3.58389 | 1.81809 | 4.10311 | 5.77714 | 7.27461 | 11.2255 |
| 11.5 | 3.73887 | 2.0335 | 4.33969 | 6.312 | 7.81042 | 11.9206 |
| 12. | 3.89644 | 2.24988 | 4.57444 | 6.772 | 8.37274 | 12.6081 |
| 12.5 | 4.05611 | 2.45455 | 4.79443 | 7.16877 | 8.95379 | 13.2815 |
| 13. | 4.2176 | 2.63066 | 4.98372 | 7.50767 | 9.52277 | 13.9069 |
| 13.5 | 4.3806 | 2.76974 | 5.13467 | 7.79135 | 10.042 | 14.4447 |
| 14. | 4.54456 | 2.87315 | 5.24991 | 8.0182 | 10.4743 | 14.8583 |
| 14.5 | 4.70858 | 2.94775 | 5.33726 | 8.1864 | 10.7968 | 15.1286 |
| 15. | 4.87156 | 3.00183 | 5.4038 | 8.29877 | 11.0088 | 15.2599 |
| 15.5 | 5.03246 | 3.04111 | 5.45117 | 8.35766 | 11.1181 | 15.2635 |
| 16. | 5.19035 | 3.06732 | 5.47532 | 8.36102 | 11.1292 | 15.1451 |
| 16.5 | 5.34441 | 3.08046 | 5.47183 | 8.30803 | 11.0482 | 14.9128 |

TABLE 19
Results for 262I44-I44A-Con2AM

| SNR, | capacity, | | | | | |
|---|---|---|---|---|---|---|
| dB | bit/symbol | a127 | a191 | a223 | a254 | a255 |
| 4.5 | 1.81146 | 1. | 3.1039 | 3.1039 | 3.1039 | 3.10391 |
| 4.75 | 1.87201 | 1. | 3.22462 | 3.22462 | 3.22462 | 3.22463 |
| 5. | 1.9336 | 1. | 3.33684 | 3.33684 | 3.33684 | 3.33684 |
| 5.25 | 1.99605 | 1. | 3.43909 | 3.43909 | 3.43909 | 3.43909 |
| 5.5 | 2.05925 | 1.00219 | 3.39862 | 3.46619 | 3.49838 | 8.70357 |
| 5.75 | 2.12401 | 1.0039 | 3.49134 | 3.55725 | 3.58766 | 8.84714 |
| 6. | 2.18921 | 1.00552 | 3.56951 | 3.63534 | 3.66415 | 8.95707 |
| 6.25 | 2.25469 | 1.00718 | 3.63204 | 3.69963 | 3.72706 | 9.03111 |
| 6.5 | 2.32028 | 1.00904 | 3.67816 | 3.74999 | 3.77628 | 9.06818 |
| 6.75 | 2.38582 | 1.01137 | 3.70746 | 3.78739 | 3.8129 | 9.06887 |
| 7. | 2.45119 | 1.01478 | 3.71984 | 3.81494 | 3.84027 | 9.03637 |
| 7.25 | 2.5163 | 1.02084 | 3.71483 | 3.84113 | 3.86766 | 8.97903 |
| 7.5 | 2.5811 | 1.03554 | 3.68839 | 3.89528 | 3.92806 | 8.92382 |
| 7.75 | 2.64576 | 1.08046 | 3.62934 | 4.06959 | 4.1432 | 8.98191 |
| 8 | 2.71201 | 1.17622 | 3.51898 | 4.09325 | 5.17028 | 9.45711 |
| 8.25 | 2.78117 | 1.20531 | 3.52013 | 4.09132 | 5.44933 | 9.64793 |
| 8.5 | 2.85131 | 1.23101 | 3.53576 | 4.11623 | 5.6363 | 9.79644 |
| 8.75 | 2.92213 | 1.24963 | 3.52938 | 4.11192 | 5.75442 | 9.85224 |
| 9. | 2.99345 | 1.25885 | 3.52584 | 4.12655 | 5.82829 | 9.85827 |
| 9.25 | 3.06524 | 1.31184 | 3.60159 | 4.26661 | 6.03822 | 10.1523 |
| 9.5 | 3.13737 | 1.34564 | 3.62916 | 4.35012 | 6.15541 | 10.2676 |
| 10. | 3.2827 | 1.44217 | 3.71241 | 4.62635 | 6.43092 | 10.5816 |
| 10.5 | 3.43022 | 1.60268 | 3.87087 | 5.12186 | 6.84604 | 11.1283 |
| 11. | 3.58111 | 1.80761 | 4.09172 | 5.7144 | 7.36603 | 11.8264 |
| 11.5 | 3.73537 | 2.02475 | 4.32994 | 6.25786 | 7.91633 | 12.5371 |
| 12. | 3.89238 | 2.24538 | 4.56942 | 6.7377 | 8.49195 | 13.2449 |
| 12.5 | 4.05164 | 2.44436 | 4.77646 | 7.1292 | 9.04206 | 13.8511 |
| 13. | 4.2128 | 2.63436 | 4.98768 | 7.51467 | 9.64848 | 14.5544 |
| 13.5 | 4.37547 | 2.76706 | 5.1173 | 7.78325 | 10.095 | 14.9869 |
| 14. | 4.53888 | 2.87744 | 5.25509 | 8.03581 | 10.5717 | 15.4451 |
| 14.5 | 4.70222 | 2.9512 | 5.34201 | 8.20164 | 10.8754 | 15.6705 |
| 15. | 4.86437 | 3.00457 | 5.40798 | 8.31043 | 11.0706 | 15.756 |
| 15.5 | 5.02431 | 3.04322 | 5.4544 | 8.3653 | 11.1655 | 15.7146 |
| 16. | 5.18117 | 3.0687 | 5.47702 | 8.36432 | 11.164 | 15.552 |
| 16.5 | 5.33414 | 3.08105 | 5.47172 | 8.30719 | 11.0722 | 15.2774 |
| 17. | 5.4824 | 3.08205 | 5.44105 | 8.20422 | 10.9099 | 14.919 |
| 17.5 | 5.62497 | 3.07577 | 5.3948 | 8.07607 | 10.7099 | 14.522 |
| 18. | 5.76061 | 3.06657 | 5.34421 | 7.94412 | 10.5044 | 14.1298 |
| 18.5 | 5.88785 | 3.05722 | 5.29669 | 7.82186 | 10.3134 | 13.769 |
| 19. | 6.00513 | 3.04894 | 5.25532 | 7.71472 | 10.1453 | 13.4493 |

TABLE 20
Results for 256-64A-ConQAM
This condensation groups the original 256-QAM points as
{4, 2, 1, 1}, in other words it uses the condensation rules
{α → 1, β →1, γ → 1, δ → ε}.

| SNR, | capacity, | | | |
|---|---|---|---|---|
| dB | bit/symbol | ε | ζ | η |
| 6. | 2.18633 | 3.67143 | 3.67143 | 3.67143 |
| 6.5 | 2.3152 | 3.75317 | 3.75317 | 3.75317 |
| 7. | 2.44315 | 3.77418 | 3.77418 | 3.77418 |
| 7.5 | 2.56994 | 3.70261 | 3.78521 | 3.78521 |
| 8. | 2.70351 | 3.19972 | 3.63027 | 5.07324 |
| 8.5 | 2.84188 | 3.18815 | 3.60007 | 5.25256 |
| 9. | 2.98189 | 3.18038 | 3.58275 | 5.3602 |
| 9.5 | 3.12271 | 3.16568 | 3.56956 | 5.41518 |
| 10. | 3.26357 | 3.14192 | 3.56541 | 5.43162 |
| 10.5 | 3.40385 | 3.10912 | 3.59045 | 5.42773 |

Results for 256-36A-ConQAM
This condensation groups the original 256-QAM points as
{4, 3, 1}, in other words it uses the condensation rules
{α → 1, β → 1, γ → 1, δ → ζ, ε → ζ}.

| SNR, | capacity, | | |
|---|---|---|---|
| dB | bit/symbol | ζ | η |
| 8. | 2.69686 | 3.32811 | 5.12883 |
| 8.5 | 2.83536 | 3.30861 | 5.31059 |
| 9. | 2.97552 | 3.29574 | 5.41515 |
| 9.5 | 3.1164 | 3.278 | 5.46449 |
| 10. | 3.25713 | 3.25425 | 5.47244 |
| 10.5 | 3.39683 | 3.22692 | 5.45281 |

| SNR, | capacity, | | | |
|---|---|---|---|---|
| dB | bit/symbol | a83 | a87 | a91 |
| 18 | 5.91408 | 6.63695 | 6.67039 | 6.89446 |
| 19 | 6.24366 | 7.97494 | 8.01154 | 8.27714 |
| 20 | 6.58041 | 10.4571 | 10.4905 | 10.9065 |
| 21 | 6.92126 | 11.5614 | 11.5707 | 12.2579 |
| 22 | 7.25834 | 11.8991 | 11.8921 | 12.8414 |
| 23 | 7.59039 | 11.972 | 11.9634 | 13.2668 |
| 24 | 7.91842 | 12.0755 | 12.0785 | 13.6528 |
| 25 | 8.24361 | 12.42 | 12.4482 | 14.0898 |
| 26 | 8.56801 | 12.984 | 13.0618 | 14.6633 |
| 27 | 8.8917 | 13.5794 | 13.7602 | 15.2722 |
| 28 | 9.21284 | 14.2369 | 14.5937 | 16.0194 |
| 29 | 9.52887 | 14.8788 | 15.4698 | 16.8337 |

| SNR, | | | | | |
|---|---|---|---|---|---|
| dB | a95 | a99 | a103 | a105 | a107 |
| 18 | 6.86107 | 8.81386 | 8.74249 | 9.3444 | 9.3619 |
| 19 | 8.23564 | 10.2874 | 10.205 | 10.952 | 10.9848 |
| 20 | 10.8597 | 13.2541 | 13.1793 | 14.2801 | 14.3304 |
| 21 | 12.2332 | 14.6075 | 14.6076 | 16.2043 | 16.252 |
| 22 | 12.849 | 15.0646 | 15.1543 | 16.9883 | 17.0048 |
| 23 | 13.3048 | 15.2851 | 15.4677 | 17.3479 | 17.3442 |
| 24 | 13.7294 | 15.5345 | 15.8442 | 17.6485 | 17.6363 |
| 25 | 14.2481 | 15.9233 | 16.4409 | 18.1185 | 18.1121 |
| 26 | 14.9629 | 16.5284 | 17.305 | 18.8657 | 18.8754 |
| 27 | 15.8167 | 17.2741 | 18.3634 | 19.8234 | 19.8662 |
| 28 | 16.8847 | 18.2495 | 19.5472 | 20.9809 | 21.092 |
| 29 | 17.972 | 19.3183 | 20.7306 | 22.1587 | 22.4065 |

1. A method of determining non-uniform QAM constellation positions' of a QAM scheme, the scheme having words of n coded bits mapped to each constellation point, for a signal to be transmitted over a channel in a system using a forward error corrector (FEC), the method comprising:
selecting a signal to noise ratio (SNR) appropriate for the channel and the forward error corrector; and
determining the positions of the constellation points that maximise a measure of channel capacity at the selected SNR.

2. A method according to claim 1, comprising calculating the measure of channel capacity for the channel for a range of positions of the points in the constellation for the selected SNR and selecting from the range of positions the positions that maximise the measure of channel capacity at the selected SNR.

3. A method according to claim 1, comprising constraining the position of at least one of the constellation points to equal the position of another constellation point prior to determining the positions of the constellation points that maximise the measure of channel capacity.

4. A method according to claim 3, comprising constraining the position of each of multiple constellation points to equal the positions of respective other constellation points prior to determining the positions of the constellation points, that maximise the measure of channel capacity.

5. A method according to claim 3, wherein the positions of one or more adjacent constellation points are constrained to equal one another.

6. A method according to claim 3, wherein the positions that are constrained are those representing less than the most significant bit (MSB) of the words.

7. A method according to claim 3, wherein the QAM scheme has constellation quadrants and pairs of constellation points in each quadrant are constrained to be at the same position as each other.

8. A method according to claim 3, wherein the number of points for which the channel capacity is calculated is at least one of:
an integer less than 2ⁿ;
an integer not equal to 2ⁿ⁻ⁱ where i is a variable integer less than n; or
an integer less than 2ⁿ and greater than or equal to 2ⁿ⁻¹.

9. (canceled)

10. (canceled)

11. A method according to claim 1, wherein the measure of channel capacity is a BICM capacity.

12. A method according to claim 11, wherein the BICM capacity is calculated according to:
$$capacity of bit b = {\int }_{Y} p ( b is 0 , y ) {log}_{2} \frac{p ( b is 0 , y )}{P ( b is 0 ) p ( y )} d y + {\int }_{Y} p ( b is 1 , y ) {log}_{2} \frac{p ( b is 1 , y )}{P ( b is 1 ) p ( y )} d y$$

13. A method according to claim 1, wherein the measure of channel capacity is a CM capacity.

14. A method according to claim 13, wherein the CM capacity is calculated according to:
$${\int }_{Y} ( \frac{( p ( y \vert b is 0 ) {log}_{2} p ( y \vert b is 0 ) + p ( y \vert b is 1 ) {log}_{2} p ( y \vert b is 1 ) )}{2} - p ( y ) {log}_{2} p ( y ) ) d y$$
$$p ( y \vert b is 0 ) = \frac{2}{n} {\sum }_{{x}_{i} ∈ {C}_{b}^{0}} p ( y \vert {x}_{i} ) = \frac{2}{n} {\sum }_{{x}_{i} ∈ {C}_{b}^{0}} \frac{{e}^{- \frac{{( y - {x}_{i} )}^{2}}{2 {σ}^{2}}}}{\sqrt{2 π} σ} \\ p ( y ) = {\sum }_{{x}_{i} ∈ C} \frac{p ( y \vert {x}_{i} )}{n} = \frac{1}{n} {\sum }_{{x}_{i} ∈ C} \frac{{e}^{- \frac{{( y - {x}_{i} )}^{2}}{2 {σ}^{2}}}}{\sqrt{2 π} σ}$$

15. A method according to claim 1, wherein the SNR appropriate for the channel is one of:
a design SNR for the channel; or
the SNR below which forward error correction at a receiver distant from a transmitter would fail to recover the signal.

16. (canceled)

17. The method of claim 1 further comprising at least one of:
encoding using the positions of the constellation points; or
decoding the signal using the positions of the constellation points.

18. A transmitter for transmitting a non-uniform QAM signal of the type having a QAM scheme with words of n coded bits mapped to each constellation point, for a signal to be transmitted over a channel the transmitter having a forward error corrector (FEC), and comprising:
a mapper unit arranged to receive words of n coded bits, and encode these onto the one or more carriers wherein the mapper unit comprises
constellation positions of the mapping scheme that have been determined by:
selecting a signal to noise ratio (SNR) appropriate for the channel and the forward error corrector; and
determining the positions of the constellation points that maximize a measure of channel capacity at the selected SNR.

19. A transmitter according to claim 18, wherein the constellation positions are determined by at least one of:
calculating the measure of channel capacity for the channel for a range of positions of the points in the constellation for the selected SNR and selecting from the range of positions the positions that maximise the measure of channel capacity at the selected SNR;
constraining the position of at least one of the constellation points to equal the position of another constellation point prior to determining the positions of the constellation points that maximise the measure of channel capacity; or
constraining the position of each of multiple constellation points to equal the positions of respective other constellation points prior to determining the positions of the constellation points that maximise the measure of channel capacity.

20. (canceled)

21. (canceled)

22. A transmitter according to claim 19, wherein the positions of one or more adjacent constellation points are constrained to equal one another.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A receiver for receiving a non-uniform QAM signal of the type having a QAM scheme with words of n coded bits mapped to each constellation point, 10 for a signal transmitted over a channel in a system using a forward error corrector (FEC), comprising:
a de-mapper unit arranged to receive one or more carriers and to decode these to words of n coded bits from each constellation point wherein the demapper unit comprises constellation positions of the mapping scheme that have been determined by:
selecting a signal to noise ratio (SNR) appropriate for the channel and the forward error corrector; and
determining the positions of the constellation points that maximise a measure of channel capacity at the selected SNR.

35. A receiver according to claim 34, wherein the constellation positions are determined by at least one of:
calculating the measure of channel capacity for the channel for a range of positions of the points in the constellation for the selected SNR and selecting from the range of positions the positions that maximise the measure of channel capacity at the selected SNR;
constraining the position of at least one of the constellation points to equal the position of another constellation point prior to determining the positions of the constellation points that maximise the measure of channel capacity; or
constraining the position of each of multiple constellation points to equal the positions of respective other constellation points prior to determining the positions of the constellation points that maximise the measure of channel capacity.

36. (canceled)

37. (canceled)

38. A receiver according to claim 35, wherein the positions of one or more adjacent constellation points are constrained to equal one another.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)
